(19) United States
(12) Patent Application Publication
(10) Pub. No.: US 2023/0416418 A1
(43) Pub. Date: Dec. 28, 2023

(54) METALLOCENE POLYPROPYLENE PREPARED USING AROMATIC SOLVENT-FREE SUPPORTS

(71) Applicant: EXXONMOBIL CHEMICAL PATENTS INC., Baytown, TX (US)

(72) Inventors: Nikola S. LAMBIC, Houston, TX (US); Francis C. RIX, Houston, TX (US); Lubin LUO, Houston, TX (US); Charles J. HARLAN, Houston, TX (US); An Ngoc-Michael NGUYEN, Pearland, TX (US)

(73) Assignee: EXXONMOBIL CHEMICAL PATENTS INC., Baytown, TX (US)

(21) Appl. No.: 18/250,438

(22) PCT Filed: Nov. 17, 2021
(86) PCT No.: PCT/US2021/059631

§ 371 Date: Apr. 25, 2023

Related U.S. Application Data
(60) Provisional application No. 63/117,333, filed on Nov. 23, 2020.

(51) Int. Cl. C08F 4/6592; C08F 4/659; C08F 10/06; C07F 7/08

(52) U.S. Cl. CPC C08F 4/65927; C08F 4/65916; C08F 2420/10; C08F 10/06; C07F 7/081; C08F 4/65912

(57) ABSTRACT

The present disclosure provides aromatic-solvent-free supported catalyst compounds and catalyst systems comprising asymmetric bridged metallocenes containing a ligand having at least one saturated ring, catalyst systems including such compounds, and uses thereof. These supported catalyst compounds and catalyst systems can be used to prepare polymer comprising no aromatic solvent.

### CROSS-REFERENCE TO RELATED APPLICATIONS

This application claims the benefit of and priority to U.S. Provisional Application No. 63/117,333 filed Nov. 23, 2020, the disclosure of which is incorporated herein by reference.

This invention relates to PCT/US2020/043758, filed Jul. 27, 2020 and entitled “Isotactic Propylene Homopolymers and Copolymers Produced with CI Symmetric Metallocene Catalysts” which claims priority to US Patent Application U.S. Ser. No. 62/890,410, filed Aug. 22, 2019, both of which are incorporated by reference herein.

This Application also relates to concurrently filed U.S. Ser. No. 63/117,312, entitled Toluene Free Supported Methylalumoxane Precursor.

This Application also relates to concurrently filed U.S. Ser. No. 63/117,328, entitled Improved Process to Prepare Catalyst from In-Situ Formed Alumoxane.

### FIELD

The present disclosure generally relates to supported catalyst compounds comprising asymmetric bridged metallocenes containing indacenyl ligands, catalyst systems including such, and uses thereof.

### BACKGROUND

Isotactic polypropylene having high melting temperature (Tₘ) and high melt strength is useful for a variety of applications, e.g., for the production of polypropylene foams and blown films, and for thermoforming. Common catalysts for high crystallinity polypropylene (PP) are racemic isomers of bis-indenyl zirconocenes. Although these catalysts are attractive due to their high activity and molecular weight capability, the catalysts generally suffer from deactivation in the presence of higher alpha olefins and higher dienes, particularly at high concentrations thereof. Furthermore, the preparation of such catalysts often requires a separation of the racemic isomer from the mixture, thereby increasing their production costs.

In addition, conventional catalyst systems and uses thereof in polymerization processes typically produce highly linear polypropylene with insufficient melt strength for applications such as foams, blown films, and thermoforming. In order to increase the melt strength of the polypropylene, post-reactor modifications to increase branching in the polymer are often performed. Post-reactor processes, e.g., reacting the polypropylene with a peroxydicarbonate, further increase the production costs of high melt strength polypropylene.

Therefore, there is still a need for new and improved catalyst systems for the polymerization of olefins in order to achieve specific polymer properties such as high melting point, high melt strength, and high molecular weight, and to increase conversion and/or comonomer incorporation without catalyst deactivation at high comonomer (such as diene) concentrations. Achieving these catalyst system and polymer properties at reduced costs relative to conventional systems remains a need.

Methylaluminoxane (MAO), sometimes referred to as polymethylaluminoxane (PMAO), has broad utility as an activator for metallocene and non-metallocenes in olefin polymerization catalysis. It is particularly useful in the preparation of catalysts supported on porous metal oxide supports for use in synthesis of polyethylene or polypropylene and their copolymers in gas-phase or slurry processes (Hlatky, G. (2000) “Heterogeneous Single-Site Catalysts for Olefin Polymerization,” Chem. Rev., v. 100, pp. 1347-1376; Fink, G. et. al. (2000) “Propene Polymerization with Silica-Supported Metallocene/MAO Catalysts,” Chem. Rev., v. 100(4), pp. 1377-1390; Severn, J. R. et. al. (2005) “Bound but Not Gagged”-Immobilizing Single-Site α-Olefin Polymerization Catalysts,” Chem. Rev., v. 105, pp. 4073-4147). However, MAO is challenging to prepare. MAO is typically formed from the low temperature reaction of trimethylaluminum (TMA) and water in toluene. This reaction is very exothermic and requires special care to control. This solution must be stored cold as it forms an insoluble gel over time at ambient temperature. (Zjilstra, H. S. et. al. (2015) “Methylalumoxane—History, Production, Properties, and Applications,” Eur. J. Inorg. Chem., v. 2015(1), 19-43). For these reasons, there are only a limited number of commercial manufacturers with the specialized skills and equipment to prepare MAO.

MAO has also been prepared by reaction of TMA and organic oxygen sources such as carbon dioxide (AkzoNobel U.S. Pat. No. 5,777,143; AkzoNobel U.S. Pat. No. 5,831,109), benzoic acid (Albemarle U.S. Pat. No. 6,013,820; Tosoh U.S. Pat. No. 7,910,764 B2; Tosoh U.S. Pat. No. 8,404,880 B2; Dalet, T. et. al. (2004) “Non-Hydrolytic Route to Aluminoxane-Type Derivative for Metallocene Activation towards Olefin Polymerisation,” Macromol. Chem. and Phys., v. 205(10), pp. 1394-1401; Kilpatrick, A. F. R. et. al. (2016) “Synthesis and Characterization of Solid Polymethylaluminoxane: A Bifunctional Activator and Support for Slurry-Phase Ethylene Polymerization,” Chem. Mater., v. 28(20), pp. 7444-7450), methacrylic acid AkzoNobel WO 2016/170017 A1, ExxonMobil (US 2019/0127499 A1), and prenol (AkzoNobel U.S. Pat. No. 9,505,788 B2). This non-hydrolytic MAO (NH-MAO) is formed with mild heating in hydrocarbon solvents.

Tosoh has reported the synthesis of solid MAO from benzoic acid and TMA and its utility as an activator support (U.S. Pat. No. 7,910,764 B2; U.S. Pat. No. 8,404,880 B2) for olefin polymerization. O'Hare has followed up on this work in the academic literature (Kilpatrick, et. al. (2016) “Synthesis and Characterization of Solid Polymethylaluminoxane: A Bifunctional Activator and Support for Slurry-Phase Ethylene Polymerization,” Chem. Materials, v. 28(20), pp. 7444-7450).

Supportation of NH-MAO on silica derived from prenol and TMA (AkzoNobel U.S. Pat. No. 9,505,788 B2) has been reported. In this preparation, prenol and 1 equivalent of TMA were reacted in toluene then added to a suspension of calcined silica (type and amount undisclosed) followed by addition of more TMA (0.4 equivalent) then heated to reflux and filtered. No MAO was found in the filtrate. No polymerization data was reported.

Favored methods of supporting NH-MAO derived from methacrylic acid or other unsaturated carboxylic acids and TMA in an inert organic solvent were reported in WO 2016/170017 where MAO was prepared in toluene and identified by NMR analysis. No reports of solid MAO formation nor examples of supported catalysts were given. No polymerization behavior was reported.

US 2019/0127499 discloses preparation of precursors from MAA and TMA then used in-situ to make supported catalysts. The precursors were not isolated. The catalysts were also prepared with TMA/MAA ratios of 3 at 0° C. then allowed to warm to room temperature briefly then treated with silica. The reaction between TMA and MAA did not go to completion before treatment with support. The solvent was also removed under vacuum, reducing TMA levels further. A supported catalyst prepared as a comparative example in concurrently filed U.S. Ser. No. 63/117,312 entitled Toluene Free Supported Methylalumoxane Precursor gave productivity of 2,532 g PE/g cat h in an ethylene polymerization.

A process is desired for a simple preparation of a supported catalyst that utilizes an in-situ preparation of MAO within a metal oxide support that avoids complications from a low temperature process, MAO storage instability, and limited MAO commercial availability.

References of interest include: U.S. Pat. Nos. 5,504,171; 6,780,936; 6,977,287; 7,005,491; 9,266,910; 9,309,340; 9,458,254; 9,803,037; 10,280,240; US 2001/0007896; US 2002/0013440; US 2004/0087750; US 2015/0322184; US 2016/0244535; US 2018/0162964; US 2019/0119418; US 2019/0119427; US 2019/0292282; EP 2402353; EP 3441407; WO 2002/02575; WO 2005/058916; WO 2006/097497; WO 2011/012245; WO 2015/009471; WO 2015/158790; WO 2017/204830; WO 2019/093630, Nifant'ev, I. E. et al. (2011) “Asymmetric ansa-Zirconocenes Containing a 2-Methyl-4-aryltetrahydroindacene Fragment: Synthesis, Structure, and Catalytic Activity in Propylene Polymerization and Copolymerization” Organometallics, v. 30, pp. 5744-5752; Rieger, B. et al. (2000) “Dual-Side ansa-Zirconocene Dichlorides for High Molecular Weight Isotactic Polypropene Elastomers,” Organometallics, v. 19(19), pp. 3767-3775; Rieger, B. et al. (2013) “Polymerization Behavior of ci-Symmetric Metallocenes (M=Zr, Hf): from Ultrahigh Molecular Weight Elastic Polypropylene to Useful Macromonomers,” Organometallics, v. 32, pp. 427-437; Peacock, A. et al. (2006) “Molecular Characterization of Polymers,” Polymer Chemistry, Chap. 5, pp. 77-87; Walter, P. et al. (2001) “Long Chain Branched Polypropene Prepared by Means of Propene Copolymerization with 1,7-Octadiene Using MAO-Activated rac-Mₑ₂Si(2-Me-4-Phenyl-Ind₎₂ZrC₁₂,” Macromol. Mater. Eng. v. 286(5), pp. 309-315; Langston, J. A. et al. (2007) “Synthesis and Characterization of Long Chain Branched Isotactic Polypropylene via Metallocene Catalyst and T-Reagent,” Macromolecules, v. 40(8), pp. 2712-2720; and Ye, Z. et al. (2004) “Synthesis and Rheological Properties of Long-Chain-Branched Isotactic Polypropylenes Prepared by Copolymerization of Propylene and Nonconjugated Dienes,” Ind. Eng. Chem. Res., v. 43(11), pp. 2860-2870.

Imhoff, D. W. et. al. (1998) “Characterization of Methylaluminoxanes and Determination of Trimethylaluminum Using Proton NMR,” Organometallics, v. 17(10), pp. 1941-1945; Ghiotto, F. et. al. (2013) “Probing the Structure of Methylalumoxane (MAO) by a Combined Chemical, Spectroscopic, Neutron Scattering, and Computational Approach,” Organometallics, v. 32(11), pp. 3354-3362; Collins, S. et al. (2017) “Activation of Cp2ZrX2 (X=Me, Cl) by Methylaluminoxane As Studied by Electrospray Ionization Mass Spectrometry: Relationship to Polymerization Catalysis,” Macromolecules, v. 50(22), pp 8871-8884); WO 2000/148034; U.S. Pat. Nos. 9,266,910; 9,309,340); Weng, W. et al. (2000) “Synthesis of Vinyl-Terminated Isotactic Poly(propylene),” Macromol. Rapid Commun., v. 21(16), pp. 1103-1107; U.S. Pat. No. 5,504,171A1; U.S. Pat. No. 6,780,936B1; U.S. Pat. Nos. 6,977,287; 7,005,491; 9,951,155; Tayano, T. et al. (2017) “Effect of Acid Treatment of Montmorillonite on “Support-Activator” Performance to Support Metallocene for Propylene Polymerization Catalyst,” Macromol. React. Eng., v. 11(2), pg. 1600017; Schobel, A. et al. (2013) “Polymerization Behavior of C₁-Symmetric Metallocenes (M=Zr,Hf): From Ultrahigh Molecular Weight Elastic Polypropylene to Useful Macromonomers,” Organometallics, v. 32(2), pp. 427-437; Calhoun, A. et al. Polymer Chemistry, Chap. 5, pp. 77-87; Walter, P. et al. (2001) “Long Chain Branched Polypropene Prepared by Means of Propene Copolymerization with 1,7-Octadiene Using MAO-Activated rac-Me₂Si(2-Me-4-Phenyl-Ind)₂ZrCl₂,” Macromol. Mater. Eng., v. 286(5), pp. 309-315; Langston, J. A. et al. (2007) “Synthesis and Characterization of Long Chain Branched Isotactic Polypropylene via Metallocene Catalyst and T-Reagent,” Macromolecules, v. 40(8), pp. 2712-2720; and Ye, Z. et al. (2004) “Synthesis and Rheological Properties of Long-Chain-Branched Isotactic Polypropylenes Prepared by Copolymerization of Propylene and Nonconjugated Dienes,” Ind. Eng. Chem. Res., v. 43(11), pp. 2860-2870.

### SUMMARY

This disclosure relates to supported catalyst compounds comprising an aromatic-solvent-free support and a catalyst compound represented by Formula (I):

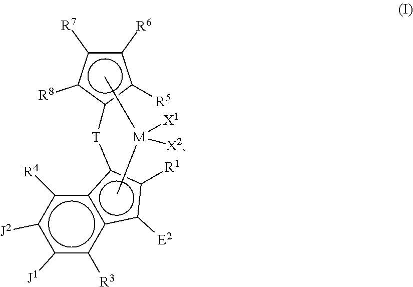

wherein:
M is a Group 4 metal;
T is a bridging group;
each of X¹ and X² is a univalent anionic ligand, or X¹ and X² are joined to form a metallocycle ring;
R¹ is hydrogen, a halogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or
—R″—SiR′₃, where R″ is C₁-C₁₀ alkyl and each R′ is hydrogen, halogen, C₁-C₁₀ alkyl, or C₆-C₁₀ aryl;
R³ is an unsubstituted C₄-C₆₂ cycloalkyl, a substituted C₄-C₆₂ cycloalkyl, an unsubstituted C₄-C₆₂ aryl, a substituted C₄-C₆₂ aryl, an unsubstituted C₄-C₆₂ heteroaryl, or a substituted C₄-C₆₂ heteroaryl;
each of R² and R⁴ is independently hydrogen, a halogen, an unsubstituted C₁-C₄₀ hydrocarbyl, a C₁-C₄₀ substituted hydrocarbyl, an unsubstituted C₄-C₆₂ aryl, a substituted
C₄-C₆₂ aryl, an unsubstituted C₄-C₆₂ heteroaryl, a substituted C₄-C₆₂ heteroaryl, —NR′₂, —SR′,
—OR, —SiR′₃, —OSiR′₃, —PR′₂, or —R″—SiR′₃, wherein R″ is C₁-C₁₀ alkyl and each R′ is hydrogen, halogen, C₁-C₁₀ alkyl, or C₆-C₁₀ aryl;
each of R⁵, R⁶, R⁷, and R⁸ is independently hydrogen, a halogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl,
—NR′₂, —SR′, —OR, —SiR′₃, —OSiR′₃, —PR′₂, or —R″—SiR′₃, wherein R″ is C₁-C₁₀ alkyl and each R′ is hydrogen, halogen, C₁-C₁₀ alkyl, or C₆-C₁₀ aryl, or one or more of R⁵ and R⁶, R⁶ and R⁷, or R⁷ and R⁸ can be joined to form a substituted or unsubstituted C₄-C₆₂ saturated or unsaturated cyclic or polycyclic ring structure, or a combination thereof, optionally R⁶ and R⁷ do not combine to form a six membered aromatic ring; and
J¹ and J² are joined to form a substituted or unsubstituted C₄-C₆₂ saturated or unsaturated cyclic or polycyclic ring structure, or a combination thereof, provided that J¹ and J² together with the two carbons they are bound to on the indenyl group form at least one saturated ring.

In another embodiment, the present disclosure provides a supported catalyst system comprising aromatic-solvent-free support, activator and a catalyst of the present disclosure, such as those represented by Formula (I) wherein the catalyst system optionally comprises less than 1 wt % of aromatic compounds (such as toluene), based upon the weight of the support.

In another embodiment, the present disclosure provides a process to prepare an olefin polymer. The process includes introducing olefin monomers to a supported catalyst system, as described herein, in a reactor, typically at a reactor pressure of from 0.7 bar to 70 bar and a reactor temperature of from 20° C. to 150° C.; and obtaining an olefin polymer.

In another embodiment, the present disclosure provides a process to prepare polymers, such as propylene homopolymers or copolymers. The process includes introducing olefin monomers (such as propylene and, optionally, one or more of a C₂ or C₄ to C₄₀ olefin comonomer) to a supported catalyst system, as described herein, in a reactor, typically at a reactor pressure of from 0.7 bar to 70 bar and a reactor temperature of from 20° C. to 150° C.; and obtaining a polymer (such as propylene homopolymer or copolymer), preferably comprising less than 1 wt % of aromatic compounds (such as toluene), based upon the weight of the polymer.

### BRIEF DESCRIPTION OF THE DRAWINGS

FIG. 1 (FIG. 1) is the catalyst activity comparison chart between comparative support AF-SMAO-1 and toluene free support AF-SMAO-2 showing up to about 35% activity increase across all conditions.

FIG. 2 (FIG. 2) is the GPC-4D trace (with g′_{vis.} branching index) between linear (dashed line) and long chain branched (solid line) polypropylene samples prepared with toluene free support AF-SMAO-2.

FIG. 3 (FIG. 3) is the GPC-4D trace (with g′_{vis.} branching index) between linear (dashed line) and long chain branched (solid line) polypropylene samples prepared with comparative support AF-SMAO-1.

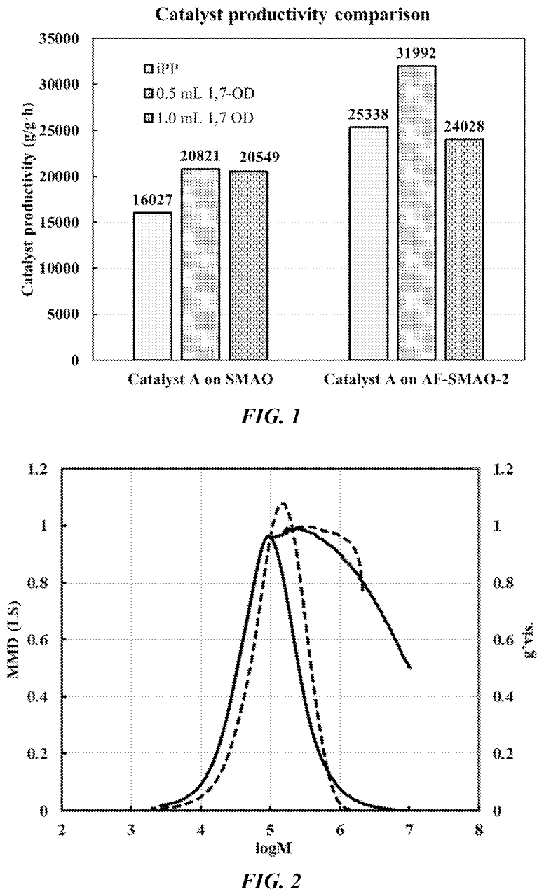

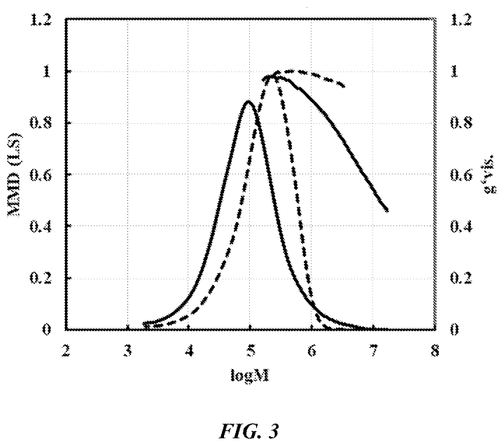

### DETAILED DESCRIPTION

The present disclosure provides aromatic-solvent-free supported catalyst compounds comprising asymmetric bridged metallocenes. In some examples, these asymmetric bridged metallocenes contain indacenyl-type ligands. Catalyst systems comprising such aromatic-solvent-free supported catalyst compounds can be used for olefin polymerization processes. The aromatic-solvent-free supported catalyst systems described herein can achieve increased activity, can produce polymers having enhanced properties, and can increase conversion and/or comonomer incorporation. Aromatic-solvent-free supported catalyst systems and processes described herein can provide polymers useful for, e.g., foams, blown films, thermoforming, fibers (such as spun-bound and melt-blown fibers), and non-wovens, among other things.

The aromatic-solvent-free supported catalyst systems and processes described herein rival and/or surpass other catalyst systems in producing polymers having, e.g., high molecular weight capability and high crystallinity, while displaying high catalyst activities and high comonomer (e.g., alpha-olefin and diene) incorporation. These high activities can be retained even when the comonomer is a higher alpha olefin or a higher diene (e.g., carbon numbers from about 4 to about 25), and even at high comonomer concentration.

The inventors have found that the instant aromatic-solvent-free supported catalyst systems incorporating the asymmetric bridged metallocenes of the present disclosure produce propylene homopolymers with improved Tₘ (higher crystallinity, e.g., the Tₘ of from about 155° C. to about 160° C. or more) and at activities comparable to or higher than activities of known asymmetric catalysts and C₂ symmetric catalysts.

The inventors have also found that the supported catalyst systems of the present disclosure can produce long chain branched (LCB) propylene copolymers by in-reactor diene incorporation. The supported catalyst systems described herein can retain high activity even at high reactor diene concentrations, while C₂ symmetric catalysts have very low activity.

The inventors have also found that the supported catalyst systems of the present disclosure can produce isotactic polypropylene having excellent physical properties, such as elongation at break, preferably in combination with excellent activity and high polymer crystallinity and molecular weight.

The inventors have found an approach to eliminate the need for post-polymerization processing (such as reactive extrusion to obtain LCB-PP). This approach includes polymerizing propylene with comonomers (e.g., diene, alpha olefin) using the catalyst systems disclosed herein. The catalyst systems and polymerization processes provide for in-situ production of short chain branched (SCB) or long chain branched copolymers. In some embodiments, the polymerization process can be carried out in e.g., solution, slurry, bulk, or gas-phase polymerization processes.

New supported catalyst compositions are provided as well as supported catalyst systems and their use in producing polymers, such as isotactic propylene homopolymers. The catalysts described herein are asymmetric, having Ci symmetry. That is, the catalysts have no planes of symmetry about any axis. This asymmetry is advantageous as no isomers (rac/meso) are formed, providing yield of catalyst compositions much higher than those catalysts that are symmetric. Additionally, the catalysts provide isotactic propylene homopolymers which is surprising since the catalyst is asymmetric. An additional advantage is that the catalyst and catalyst systems described herein can be used to produce in-reactor long chain branched copolymers. Generally, metallocene catalysts have very low activity for in-reactor diene incorporation.

The catalyst compositions herein comprise an aromatic-solvent-free support. By aromatic-solvent-free support (“ASF-support”) is meant a support material, such as silica, contains less than 1 wt % (preferably less than 0.5 wt %, preferably less than 0.1 wt %, preferably less than 0.01 wt %, preferably less than 1 ppm, preferably 0 wt %) of aromatic compounds, based upon the weight of the support. Alternately the ASF-support has less than 10 ppm, alternately less than 1 ppm, alternately 0 ppm of aromatic compounds present on the support.

For the purposes of defining the ASF-supports, the term “aromatic compound(s)” is defined to be benzene and derivatives of benzene, such as toluene, mesitylene, xylene, naphthylene, cumene, ethylbenzene, styrene, and anthracene, and the term “aromatic compound(s)” specifically excludes any catalyst compounds containing an aromatic moiety, such as a metallocene catalyst compound.

An “aromatic-solvent-free supported catalyst compound” is a combination of catalyst compound and an ASF-support, where the combination preferably contains less than 1 wt % (preferably less than 0.5 wt %, preferably less than 0.1 wt %, preferably less than 0.01 wt %, preferably less than 1 ppm, preferably 0 wt %) of aromatic compounds.

An “aromatic-solvent-free supported catalyst system” is a catalyst system comprising an ASF-support, a catalyst compound, an activator, optional scavenger, where the system preferably contains less than 1 wt % (preferably less than 0.5 wt %, preferably less than 0.1 wt %, preferably less than 0.01 wt %, preferably less than 1 ppm, preferably 0 wt %) of aromatic compounds.

Processes described herein preferably use non-aromatic-hydrocarbon solvents to prepare the supported activator, supported catalyst, supported activator catalyst combinations, and catalyst systems. Non-aromatic-hydrocarbon solvents include aliphatic solvents (such as isobutane, butane, pentane, isopentane, hexanes, isohexane, heptane, octane, dodecane, and mixtures thereof); and/or cyclic and alicyclic hydrocarbons (such as cyclohexane, cycloheptane, methylcyclohexane, methylcycloheptane, and mixtures thereof). By non-aromatic-hydrocarbon solvent is meant any aromatics are present in the solvent at less than 1 wt %, preferably less than 0.5 wt %, preferably less than 0.1 wt %, preferably at 0 wt % based upon the weight of the solvents.

For the purposes of this present disclosure and the claims thereto, and unless otherwise specified, a “catalyst system” is a combination of at least one catalyst compound, at least one activator, an ASF-support material, and an optional co-activator. When “catalyst system” is used to describe a catalyst/activator pair before activation, it refers to the unactivated catalyst complex (precatalyst) together with an activator and, optionally, a co-activator. When it is used to describe such a pair after activation, it refers to the activated complex and the activator or other charge-balancing moiety. The transition metal compound may be neutral as in a precatalyst, or a charged species with a counter ion as in an activated catalyst system. For the purposes of this present disclosure and the claims thereto, and unless otherwise specified, when catalyst systems are described as comprising neutral stable forms of the components, it is well understood by one of ordinary skill in the art, that the ionic form of the component is the form that reacts with the monomers to produce polymers. A polymerization catalyst system is a catalyst system that can polymerize monomers to polymer. Furthermore, catalyst compounds and activators represented by formulae herein embrace both neutral and ionic forms of the catalyst compounds and activators.

For the purposes of this present disclosure and the claims thereto, the new numbering scheme for the Periodic Table Groups is used as described in Chemical and Engineering News, v. 63(5), pg. 27 (1985). Therefore, a “group 4 metal” is an element from group 4 of the Periodic Table, e.g. Hf, Ti, or Zr.

For the purposes of this present disclosure and the claims thereto, and unless otherwise specified, an “olefin,” alternatively referred to as “alkene,” is a linear, branched, or cyclic compound of carbon and hydrogen having at least one double bond. For purposes of this specification and the claims appended thereto, when a polymer or copolymer is referred to as comprising an olefin, the olefin present in such polymer or copolymer is the polymerized form of the olefin. For example, when a copolymer is said to have a “propylene” content of 35 wt % to 55 wt %, it is understood that the mer unit in the copolymer is derived from propylene in the polymerization reaction and said derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. Accordingly, the definition of copolymer, as used herein, includes terpolymers. “Different” as used to refer to mer units indicates that the mer units differ from each other by at least one atom or are different isomerically. A “propylene polymer” or “propylene copolymer” is a polymer or copolymer comprising at least 50 mole % propylene derived units, and so on.

For the purposes of this present disclosure and the claims thereto, and unless otherwise specified, the term “Co” refers to hydrocarbon(s) having n carbon atom(s) per molecule, wherein n is a positive integer. The term “hydrocarbon” refers to a class of compounds containing hydrogen bound to carbon, and encompasses (i) saturated hydrocarbon compounds, (ii) unsaturated hydrocarbon compounds, and (iii) mixtures of hydrocarbon compounds (saturated and/or unsaturated), including mixtures of hydrocarbon compounds having different values of n. Likewise, a “Cₘ-C_{y}” group or compound refers to a group or compound comprising carbon atoms at a total number thereof in the range from m to y. Thus, a C₁-C₅₀ alkyl group refers to an alkyl group comprising carbon atoms at a total number thereof in the range from 1 to 50.

For the purposes of this present disclosure and the claims thereto, and unless otherwise specified, the terms “group,” “radical,” and “substituent” may be used interchangeably.

For the purposes of this present disclosure and the claims thereto, and unless otherwise specified, the terms “hydrocarbyl radical,” “hydrocarbyl group,” or “hydrocarbyl” may be used interchangeably and are defined to mean a group consisting of hydrogen and carbon atoms only. Suitable hydrocarbyls are C₁-C₁₀₀ radicals that may be linear, branched, or cyclic, and when cyclic, aromatic or non-aromatic. Examples of such radicals include, but are not limited to, alkyl groups such as methyl, ethyl, n-propyl, isopropyl, n-butyl, isobutyl,

sec-butyl, tert-butyl, pentyl, iso-amyl, hexyl, octyl, cyclopropyl, cyclobutyl, cyclopentyl, cyclohexyl, cyclooctyl, aryl groups, such as phenyl, benzyl, naphthyl.

For the purposes of this present disclosure and the claims thereto, and unless otherwise specified, the terms “alkyl radical,” and “alkyl” are used interchangeably throughout this disclosure. For purposes of this disclosure, “alkyl radical” is defined to be C₁-C₁₀₀ alkyls, that may be linear, branched, or cyclic. Examples of such radicals can include methyl, ethyl, n-propyl, isopropyl, n-butyl, isobutyl, sec-butyl, tert-butyl, pentyl, iso-amyl, hexyl, octyl, cyclopropyl, cyclobutyl, cyclopentyl, cyclohexyl, cyclooctyl, and the like including their substituted analogues.

The term “alpha-olefin” refers to an olefin having a terminal carbon-to-carbon double bond in the structure thereof ((R¹R²)—C═CH₂, where R¹ and R² can be independently hydrogen or any hydrocarbyl group; preferably R¹ is hydrogen and R² is an alkyl group). A “linear alpha-olefin” is an alpha-olefin defined in this paragraph wherein R¹ is hydrogen, and R² is hydrogen or a linear alkyl group.

For the purposes of this present disclosure and the claims thereto, and unless otherwise specified, ethylene shall be considered an α-olefin.

For the purposes of this present disclosure and the claims thereto, and unless otherwise specified, the terms “alkoxy” and “alkoxide” mean an alkyl or aryl group bound to an oxygen atom, such as an alkyl ether or aryl ether group/radical connected to an oxygen atom and can include those where the alkyl/aryl group is a C₁-C₁₀ hydrocarbyl. The alkyl group may be straight chain, branched, or cyclic. The alkyl group may be saturated or unsaturated. Examples of suitable alkoxy radicals can include methoxy, ethoxy, n-propoxy, iso-propoxy,

n-butoxy, iso-butoxy, sec-butoxy, tert-butoxy, phenoxyl.

For the purposes of this present disclosure and the claims thereto, and unless otherwise specified (such as for “substituted hydrocarbyl”, etc.), the term “substituted” refers to that at least one hydrogen atom has been replaced with at least one non-hydrogen group, such as a hydrocarbyl group, a heteroatom, or a heteroatom containing group, such as halogen (such as Br, Cl, F or I) or at least one functional group such as —NR*₂, —OR*, —SeR*, —TeR*,

—PR*₂, —AsR*₂, —SbR*₂, —SR*, —BR*₂, —SiR*₃, —GeR*₃, —SnR*₃, —PbR*₃, —(CH₂)q-SiR*₃, where q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted hydrocarbyl” means a hydrocarbyl radical in which at least one hydrogen atom of the hydrocarbyl radical has been substituted with at least one heteroatom (such as halogen, e.g., Br, Cl, F or I) or heteroatom-containing group (such as a functional group, e.g., —NR*₂, —OR*, —SeR*, —TeR*, —PR*₂, —AsR*₂, —SbR*₂, —SR*, —BR*₂, —SiR*₃,

—GeR*₃, —SnR*₃, —PbR*₃, —(CH₂)q-SiR*₃, and the like, where q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

For the purposes of this present disclosure and the claims thereto, and unless otherwise specified, the term “ring atom” refers to an atom that is part of a cyclic ring structure. By this definition, a benzyl group has six ring atoms and tetrahydrofuran has 5 ring atoms.

For the purposes of this present disclosure and the claims thereto, and unless otherwise specified, the term “aryl” or “aryl group” refers to an aromatic ring such as phenyl, naphthyl, xylyl, tolyl, etc. Likewise, heteroaryl refers to an aryl group where a ring carbon atom (or two or three ring carbon atoms) has been replaced with a heteroatom, such as N, O, or S. As used herein, the term “aromatic” also refers to pseudoaromatic heterocycles which are heterocyclic substituents that have similar properties and structures (nearly planar) to aromatic heterocyclic ligands, but are not by definition aromatic.

The term “substituted aryl,” means an aryl group having one or more hydrogen groups replaced by a hydrocarbyl, substituted hydrocarbyl, heteroatom or heteroatom containing group.

The term “substituted heteroaryl,” means a heteroaryl group having one or more hydrogen groups replaced by a hydrocarbyl, substituted hydrocarbyl, heteroatom or heteroatom containing group.

A “halocarbyl” is a halogen substituted hydrocarbyl group that may be bound to another substituent via a carbon atom or a halogen atom.

Where isomers of a named alkyl, alkenyl, alkoxide, or aryl group exist (e.g., n-butyl, iso-butyl, sec-butyl, and tert-butyl) reference to one member of the group (e.g., n-butyl) shall expressly disclose the remaining isomers (e.g., iso-butyl, sec-butyl, and tert-butyl) in the family. Likewise, reference to an alkyl, alkenyl, alkoxide, or aryl group without specifying a particular isomer (e.g., butyl) expressly discloses all isomers (e.g., n-butyl, iso-butyl, sec-butyl, and tert-butyl).

As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, Mz) are g/mol (g mol⁻¹).

The following abbreviations may be used herein: Me is methyl, Et is ethyl, Pr is propyl, cPR is cyclopropyl, nPr is n-propyl, iPr is isopropyl, Bu is butyl, nBu is normal butyl, iBu is isobutyl, sBu is sec-butyl, tBu is tert-butyl, Oct is octyl, Ph is phenyl, MAO is methylalumoxane, dme is 1,2-dimethoxyethane, p-tBu is para-tertiary butyl, TMS is trimethylsilyl, TIBAL is triisobutylaluminum, TNOAL is tri(n-octyl)aluminum, p-Me is para-methyl, Bz and Bn are benzyl (i.e., CH₂Ph), THF (also referred to as thf) is tetrahydrofuran, RT is room temperature (and is 23° C. unless otherwise indicated), tol is toluene, EtOAc is ethyl acetate, Cbz is Carbazole, and Cy is cyclohexyl.

In the description herein, the catalyst may be described as a catalyst, a catalyst precursor, a pre-catalyst compound, catalyst compound or a transition metal compound, and these terms are used interchangeably.

For the purposes of this present disclosure and the claims thereto, and unless otherwise specified, an “anionic ligand” is a negatively charged ligand which donates one or more pairs of electrons to a metal ion. A “neutral donor ligand” is a neutrally charged ligand which donates one or more pairs of electrons to a metal ion.

A heterocyclic ring is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom substituted ring.

A scavenger is a compound that is typically added to facilitate polymerization by scavenging impurities. Some scavengers may also act as activators and may be referred to as co-activators. A co-activator, that is not a scavenger, may also be used in conjunction with an activator in order to form an active catalyst. In at least one embodiment a co-activator can be pre-mixed with the transition metal compound to form an alkylated transition metal compound.

A “metallocene” catalyst compound is a transition metal catalyst compound having one, two or three, typically one or two, substituted or unsubstituted cyclopentadienyl ligands bound to the transition metal, typically a metallocene catalyst is an organometallic compound containing at least one π-bound cyclopentadienyl moiety (or substituted cyclopentadienyl moiety). Substituted or unsubstituted cyclopentadienyl ligands include substituted or unsubstituted indenyl, fluroenyl, indacenyl, benzindenyl, and the like.

The term “continuous” refers to a system that operates without interruption or cessation. For example a continuous process to produce a polymer would be one where the reactants are continually introduced into one or more reactors and polymer product is continually withdrawn.

### Catalyst Compounds

In some embodiments, catalyst compounds are represented by Formula (I):

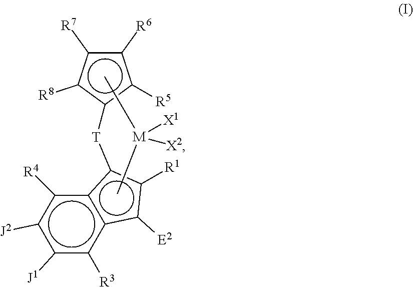

wherein:
M is a transition metal atom;
T is a bridging group;
each of X¹ and X² is a univalent anionic ligand, or X¹ and X² are joined to form a metallocycle ring;
R¹ is hydrogen, a halogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, where R″ is C₁-C₁₀ alkyl and each R′ is hydrogen, halogen, C₁-C₁₀ alkyl, or C₆-C₁₀ aryl;
R³ is an unsubstituted C₄-C₆₂ cycloalkyl, a substituted C₄-C₆₂ cycloalkyl, an unsubstituted C₄-C₆₂ aryl, a substituted C₄-C₆₂ aryl, an unsubstituted C₄-C₆₂ heteroaryl, or a substituted C₄-C₆₂ heteroaryl;
each of R² and R⁴ is independently hydrogen, a halogen, an unsubstituted C₁-C₄₀ hydrocarbyl, a C₁-C₄₀ substituted hydrocarbyl, an unsubstituted C₄-C₆₂ aryl, a substituted
C₄-C₆₂ aryl, an unsubstituted C₄-C₆₂ heteroaryl, a substituted C₄-C₆₂ heteroaryl, —NR′₂, —SR′,
—OR, —SiR′₃, —OSiR′₃, —PR′₂, or —R″—SiR′₃, wherein R″ is C₁-C₁₀ alkyl and each R′ is hydrogen, halogen, C₁-C₁₀ alkyl, or C₆-C₁₀ aryl;
each of R⁵, R⁶, R⁷, and R⁸ is independently hydrogen, a halogen, an unsubstituted
C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl,
—NR′₂, —SR′, —OR, —SiR′₃, —OSiR′₃, —PR′₂, or —R″—SiR′₃, wherein R″ is C₁-C₁₀ alkyl and each R′ is hydrogen, halogen, C₁-C₁₀ alkyl, or C₆-C₁₀ aryl, or one or more of R⁵ and R⁶, R⁶ and R⁷, or R⁷ and R⁸ can be joined to form a substituted or unsubstituted C₄-C₆₂ saturated or unsaturated cyclic or polycyclic ring structure, or a combination thereof, optionally R⁶ and R⁷ do not combine to form a six membered aromatic ring; and
each of J¹ and J² is joined to form a substituted or unsubstituted C₄-C₆₂ (alternately
C₅-C₆₂, alternately C₅-C₄₀, alternately C₆ to C₃₀, alternately C₆ to C₂₀) saturated or unsaturated cyclic or polycyclic ring structure, or a combination thereof, provided that J¹ and J² together with the two carbons they are bound to on the indenyl group form at least one saturated ring. Preferably J¹ and J² together with the two carbons they are bound to on the indenyl group form at least one 5 or 6 membered saturated ring.

As a non-limiting illustration, in Formula (I) the phrase “J¹ and J² together with the two carbons they are bound on the indenyl group” means that the J¹ and J² groups and the carbon atoms in the box in the formula below. Preferably the atoms in the box form a 5 or 6 membered saturated ring. For example an indacenyl ligand contains such a saturated 5 membered ring and a hexahydrobenz[f]indenyl ligand contains such a saturated 6 membered ring.

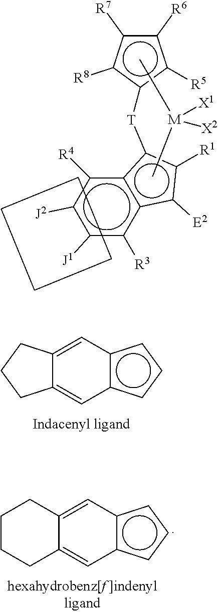

The unsaturated ring in the indacenyl ligand and the hexahydrobenz[f]indenyl ligand can be substituted or unsubstituted and can be part of multi-cyclic groups where the additional cyclic groups may be saturated or unsaturated, and substituted or unsubstituted. Typical substituents on the unsaturated ring include C₁ to C₄₀ hydrocarbyls (which may be substituted or unsubstituted), heteroatoms (such as halogens, such as Br, F, Cl), heteroatom-containing groups (such as a halocarbyl), or two or more substituents are joined together to form a cyclic or polycyclic ring structure (which may contain saturated and or unsaturated rings), or a combination thereof.

In some embodiments of the present disclosure, each of J¹ and J² is joined form an unsubstituted C₄-C₃₀ (alternately C₅-C₃₀, alternately C₆-C₂₀) cyclic or polycyclic ring, either of which may be saturated, partially saturated, or unsaturated. In some embodiments each J joins to form a substituted C₄-C₂₀ cyclic or polycyclic ring, either of which may be saturated or unsaturated. Examples include:

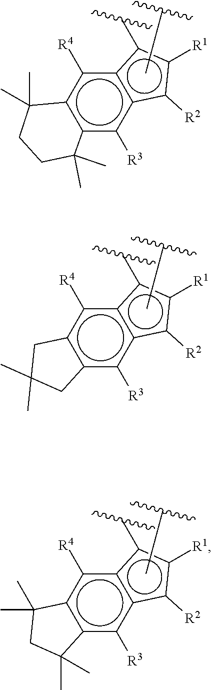

where R¹, R², R³ and R⁴ are as defined in Formula (I) above, and the wavy lines indicate connection to M (such as Hf or Zr) and T (such as Me₂Si).

In some embodiments of the present disclosure, M is a transition metal such as a transition metal of Group 3, 4, or 5 of the Periodic Table of Elements, such as a Group 4 metal, for example Zr, Hf, or Ti.

In some embodiments of the present disclosure, each of X¹ and X² is independently an unsubstituted C₁-C₄₀ hydrocarbyl (such as an unsubstituted C₂-C₂₀ hydrocarbyl), a substituted C₁-C₄₀ hydrocarbyl (such as a substituted C₂-C₂₀ hydrocarbyl), an unsubstituted

C₄-C₆₂ aryl, a substituted C₄-C₆₂ aryl, an unsubstituted C₄-C₆₂ heteroaryl, a substituted C₄-C₆₂ heteroaryl, hydride, amide, alkoxide, sulfide, phosphide, halide, diene, amine, phosphine, ether, and a combination thereof, for example each of X¹ and X² is independently a halide or a C₁-C₅ alkyl, such as methyl. In some embodiments, each of X¹ and X² is independently chloro, bromo, methyl, ethyl, propyl, butyl, pentyl, hexyl, heptyl, octyl, nonyl, decyl, undecyl, or dodecyl. In some embodiments of the present disclosure, X¹ and X² form a part of a fused ring or a ring system.

In some embodiments, T is represented by the formula, (R*₂G)_{g}, wherein each G is C, Si, or Ge, g is 1 or 2, and each R* is, independently, hydrogen, halogen, an unsubstituted C₁-C₂₀ hydrocarbyl (such as methyl, ethyl, propyl, butyl, pentyl, hexyl, heptyl, octyl, nonyl, decyl, undecyl, or dodecyl), a substituted C₁-C₂₀ hydrocarbyl, or the two or more R* may join to form a substituted or unsubstituted, saturated, partially unsaturated or aromatic, cyclic or polycyclic substituent. In some embodiments of the present disclosure, T is a bridging group and is represented by R′₂C, R′₂Si, R′₂Ge, R′₂CCR′₂, R′₂CCR′₂CR′₂, R′₂CCR′₂CR′₂CR′₂, R′C═CR′, R′C═CR′CR′₂, R′₂CCR′═CR′CR′₂, R′C═CR′CR′═CR′, R′C═CR′CR′₂CR′₂, R′₂CSiR′₂, R′₂SiSiR′₂, R₂CSiR′₂CR′₂, R′₂SiCR′₂SiR′₂, R′C═CR′SiR′₂, R′₂CGeR′₂, R′₂GeGeR′₂, R′₂CGeR′₂CR′₂, R′₂GeCR′₂GeR′₂, R′₂SiGeR′₂, R′C═CR′GeR′₂, R′B, R′₂C—BR′, R′₂C—BR′—CR′₂, R′₂C—O—CR′₂, R′₂CR′₂C—O—CR′₂CR′₂, R′₂C—O—CR′₂CR′₂, R′₂C—O—CR′═CR′, R′_{Z}C—S—CR′₂, R′₂CR′₂C—S—CR′₂CR′₂, R′₂C—S—CR′₂CR′₂, R′₂C—S—CR′═CR′, R′₂C—Se—CR′2, R′₂CR′₂C—Se—CR′₂CR′₂, R′₂C—Se—CR₂CR′₂, R′₂C—Se—CR′═CR′, R′₂C—N═CR′, R′₂C—NR′—CR′₂, R′₂C—NR′—CR′₂CR′₂, R′₂C—NR′—CR′═CR′, R′₂CR′₂C—NR′—CR′₂CR′₂, R′₂C—P═CR′, or R′₂C—PR′—CR′₂ where each R′ is independently hydrogen or an unsubstituted C₁-C₂₀ hydrocarbyl (such as methyl, ethyl, propyl, butyl, pentyl, hexyl, heptyl, octyl, nonyl, decyl, undecyl, or dodecyl), a substituted C₁-C₂₀ hydrocarbyl, a C₁-C₂₀ halocarbyl, a C₁-C₂₀ silylcarbyl, or a C₁-C₂₀ germylcarbyl substituent, or two or more adjacent R′ join to form a substituted or unsubstituted, saturated, partially unsaturated or aromatic, cyclic or polycyclic substituent. In some embodiments of the present disclosure, T is a bridging group that includes carbon or silicon, such as dialkylsilyl, for example T is a CH₂, CH₂CH₂, C(CH₃)₂, (Ph)₂C, (p-(Et)₃SiPh)₂C, SiMe₂, SiPh₂, SiMePh, Si(CH₂)₃, Si(CH₂)₄, or Si(CH₂)₄.

In some embodiments, R¹ is hydrogen, a substituted C₁-C₂₀ hydrocarbyl, or an unsubstituted C₁-C₂₀ hydrocarbyl, such as a substituted C₁-C₁₂ hydrocarbyl or an unsubstituted C₁-C₁₂ hydrocarbyl (such as methyl, ethyl, propyl, butyl, pentyl, hexyl, heptyl, octyl, nonyl, decyl, undecyl, or dodecyl), for example hydrogen, a substituted C₁-C₆ hydrocarbyl, or an unsubstituted C₁-C₆ hydrocarbyl.

In some embodiments, each of R² and R⁴ is independently hydrogen, a substituted C₁-C₂₀ hydrocarbyl, or an unsubstituted C₁-C₂₀ hydrocarbyl, such as a substituted C₁-C₁₂ hydrocarbyl or an unsubstituted C₁-C₁₂ hydrocarbyl (such as methyl, ethyl, propyl, butyl, pentyl, hexyl, heptyl, octyl, nonyl, decyl, undecyl, or dodecyl), for example hydrogen, a substituted C₁-C₆ hydrocarbyl, or an unsubstituted C₁-C₆ hydrocarbyl.

In some embodiments, each of R⁵, R⁶, R⁷, and R⁸ is independently hydrogen, a substituted C₁-C₂₀ hydrocarbyl, or an unsubstituted C₁-C₂₀ hydrocarbyl, such as a substituted C₁-C₁₂ hydrocarbyl or an unsubstituted C₁-C₁₂ hydrocarbyl (such as methyl, ethyl, propyl, butyl, pentyl, hexyl, heptyl, octyl, nonyl, decyl, undecyl, or dodecyl), such as a substituted

C₁-C₆ hydrocarbyl, or an unsubstituted C₁-C₆ hydrocarbyl (such as methyl, ethyl, propyl, butyl, pentyl, or hexyl), or one or more of R⁵ and R⁶, R⁶ and R⁷, or R⁷ and R⁸ can be joined to form a substituted or unsubstituted C₄-C₂₀ saturated or unsaturated cyclic or polycyclic ring structure, or a combination thereof.

In some embodiments, one or more of R⁵ and R⁶, R⁶ and R⁷, or R⁷ and R⁸ can be joined to form a substituted or unsubstituted C₅-C₈ saturated or unsaturated cyclic or polycyclic ring structure, or a combination thereof.

In some embodiments, one or more of R⁵ and R⁶ or R⁷ and R⁸ can be joined to form a substituted or unsubstituted C₅-C₈ saturated or unsaturated cyclic or polycyclic ring structure, or a combination thereof; and R⁶ and R⁷ can be joined to form a substituted or unsubstituted C₅, C₇, or C₈ saturated or unsaturated cyclic or polycyclic ring structure or a C₆ saturated cyclic or polycyclic ring structure, or a combination thereof.

In some embodiments, R⁶ and R⁷ do not form a substituted or unsubstituted C₆ unsaturated cyclic ring structure, optionally R⁶ and R⁷ do not combine to form a six membered aromatic ring, optionally R⁶ and R⁷ do not combine to form ring structure such that the cyclopentadienyl ligand is a substituted indenyl ligand, optionally R⁶ and R⁷ do not combine to form ring structure such that the cyclopentadienyl ligand is a substituted or unsubstituted indenyl ligand.

In some embodiments, R³ is an unsubstituted C₄-C₂₀ cycloalkyl (e.g., cyclohexane, cyclypentane, cycloocatane, adamantane), or a substituted C₄-C₂₀ cycloalkyl.

In some embodiments, R³ is a substituted or unsubstituted phenyl, benzyl, carbazolyl, naphthyl, or fluorenyl.

In some embodiments, R³ is a substituted or unsubstituted aryl group represented by the Formula (X):

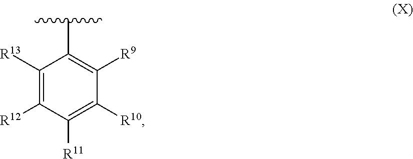

wherein each of R⁹, R¹⁰, R¹¹, R¹², and R¹³ is independently hydrogen, an unsubstituted C₁-C₄₀ hydrocarbyl, a substituted C₁-C₄₀ hydrocarbyl, a heteroatom, a heteroatom-containing group, or two or more of R⁹, R¹⁰, R¹¹, R¹², and R¹³ are joined together to form a C₄-C₆₂ cyclic or polycyclic ring structure, or a combination thereof.

In some embodiments of the present disclosure, each of R⁹, R¹⁰, R¹¹, R¹², and R¹³ is independently hydrogen, a halogen, an unsubstituted C₁-C₄₀ hydrocarbyl, a substituted C₁-C₄₀ hydrocarbyl, an unsubstituted C₄-C₆₂ aryl (such as an unsubstituted C₄-C₂₀ aryl, such as a phenyl), a substituted C₄-C₆₂ aryl (such as a substituted C₄-C₂₀ aryl), an unsubstituted C₄-C₆₂ heteroaryl (such as an unsubstituted C₄-C₂₀ heteroaryl), a substituted C₄-C₆₂ heteroaryl (such as a substituted C₄-C₂₀ heteroaryl), —NR′₂, —SR′, —OR, —SiR′₃, —OSiR′₃, —PR′₂, or —R″—SiR′₃, where R″ is C₁-C₁₀ alkyl and each R′ is hydrogen, halogen, C₁-C₁₀ alkyl, or C₆-C₁₀ aryl. For example, each of R⁹, R¹⁰, R¹¹, R¹², and R¹³ is independently hydrogen, a substituted C₁-C₂₀ hydrocarbyl, or an unsubstituted C₁-C₂₀ hydrocarbyl, such as a substituted C₁-C₁₂ hydrocarbyl or an unsubstituted C₁-C₁₂ hydrocarbyl (such as methyl, ethyl, propyl, butyl, pentyl, hexyl, heptyl, octyl, nonyl, decyl, undecyl, or dodecyl), such as a substituted C₁-C₆ hydrocarbyl, or an unsubstituted C₁-C₆ hydrocarbyl (such as methyl, ethyl, propyl, butyl, pentyl, or hexyl), or two or more of R⁹, R¹⁰, R¹¹, R¹², and R¹³ can be joined to form a substituted or unsubstituted

C₄-C₂₀ saturated or unsaturated cyclic or polycyclic ring structure, or a combination thereof.

In some embodiments of the present disclosure, at least one of R⁹, R¹⁰, R¹¹, R¹², and R¹³ is a phenyl.

In some embodiments of the present disclosure, the catalyst compounds are represented by Formula (II):

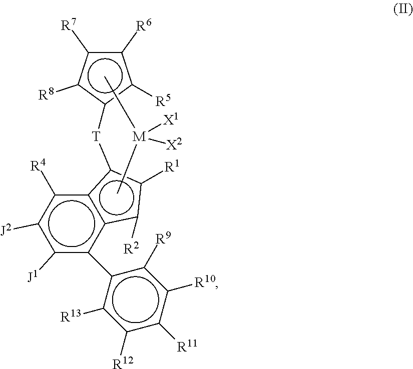

wherein M, T, J¹, J², X¹, X², R¹, R², R⁴, R⁵, R⁶, R⁷, and R⁸ are as described in Formula (I) and R⁹, R¹⁰, R¹¹, R¹², and R¹³ are as described in Formula (X).

In some embodiments of the present disclosure, the catalyst compounds are represented by Formula (III):

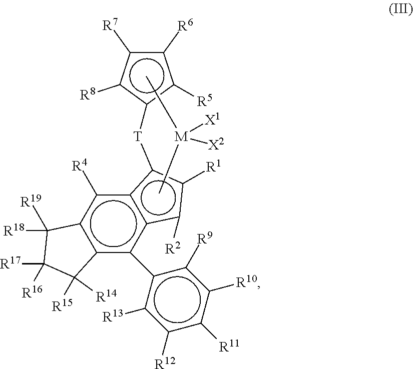

wherein:
each of R¹⁴, R¹⁵, R¹⁶, R¹⁷, R¹⁸, and R¹⁹ is independently hydrogen, an unsubstituted C₁-C₄₀ hydrocarbyl, a substituted C₁-C₄₀ hydrocarbyl, a heteroatom, a heteroatom-containing group, or two or more of R¹⁴, R¹⁵, R¹⁶, R¹⁷, R¹⁸, and R¹⁹ are joined together to form a cyclic or polycyclic ring structure, or a combination thereof; and
wherein M, T, J¹, J², X¹, X², R¹, R², R⁴, R⁵, R⁶, R⁷, and R⁸ are as described in Formula (I) and R⁹, R¹⁰, R¹¹, R¹², and R¹³ are as described in Formula (X).

In some embodiments, each of R¹⁴, R¹⁵, R¹⁶, R¹⁷, R¹⁸, and R¹⁹ is independently hydrogen, a halogen, an unsubstituted C₁-C₄₀ hydrocarbyl, a substituted C₁-C₄₀ hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, where R″ is C₁-C₁₀ alkyl and each R′ is hydrogen, halogen, C₁-C₁₀ alkyl, or C₆-C₁₀ aryl. For example, each of R⁴, R¹⁵, R¹⁶, R¹⁷, R¹⁸, and R¹⁹ is independently hydrogen, a substituted C₁-C₂₀ hydrocarbyl, or an unsubstituted C₁-C₂₀ hydrocarbyl, such as a substituted C₁-C₁₂ hydrocarbyl or an unsubstituted C₁-C₁₂ hydrocarbyl (such as methyl, ethyl, propyl, butyl, pentyl, hexyl, heptyl, octyl, nonyl, decyl, undecyl, or dodecyl), such as a substituted C₁-C₆ hydrocarbyl, or an unsubstituted C₁-C₆ hydrocarbyl (such as methyl, ethyl, propyl, butyl, pentyl, or hexyl), or two or more of R¹, R¹⁵, R¹⁶, R¹⁷, R¹⁸, and R¹⁹ can be joined to form a substituted or unsubstituted C₄-C₂₀ saturated or unsaturated cyclic or polycyclic ring structure, or a combination thereof.

In some embodiments of the present disclosure, catalyst compounds are represented by Formula (IV):

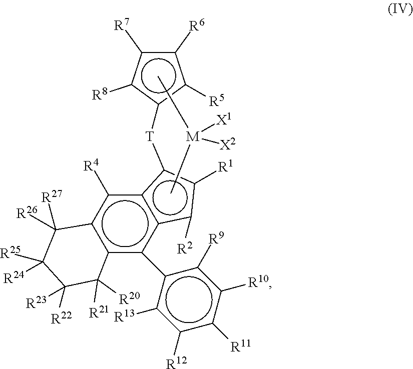

wherein:
each of R²⁰, R²¹, R²², R²³, R²⁴, R²⁵, R²⁶, R²⁷ is independently hydrogen, an unsubstituted C₁-C₄₀ hydrocarbyl, a substituted C₁-C₄₀ hydrocarbyl, a heteroatom, a heteroatom-containing group, or two or more of R²⁰, R²¹, R²², R²³, R²⁴, R²⁵, R²⁶, R²⁷ are joined together to form a cyclic or polycyclic ring structure, or a combination thereof; and
wherein M, T, J¹, J², X¹, X², R¹, R², R⁴, R⁵, R⁶, R⁷, and R⁸ are as described in Formula (I) and R⁹, R¹⁰, R¹¹, R¹², and R¹³ are as described in Formula (X).

In some embodiments, each of R²⁰, R²¹, R²², R²³, R²⁴, R²⁵, R²⁶, R²⁷ is independently hydrogen, a halogen, an unsubstituted C₁-C₄₀ hydrocarbyl, a substituted C₁-C₄₀ hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, where R″ is C₁-C₁₀ alkyl and each R′ is hydrogen, halogen, C₁-C₁₀ alkyl, or C₆-C₁₀ aryl. For example, each of R²⁰, R²¹, R²², R²³, R²⁴, R²⁵, R²⁶, R²⁷ is independently hydrogen, a substituted C₁-C₂₀ hydrocarbyl, or an unsubstituted C₁-C₂₀ hydrocarbyl, such as a substituted C₁-C₁₂ hydrocarbyl or an unsubstituted C₁-C₁₂ hydrocarbyl (such as methyl, ethyl, propyl, butyl, pentyl, hexyl, heptyl, octyl, nonyl, decyl, undecyl, or dodecyl), such as a substituted C₁-C₆ hydrocarbyl, or an unsubstituted C₁-C₆ hydrocarbyl (such as methyl, ethyl, propyl, butyl, pentyl, or hexyl), or two or more R²⁰, R²¹, R²², R²³, R²⁴, R²⁵, R²⁶, R²⁷ can be joined to form a substituted or unsubstituted C₄-C₂₀ saturated or unsaturated cyclic or polycyclic ring structure, or a combination thereof.

Catalyst compounds useful herein are represented by the formula:

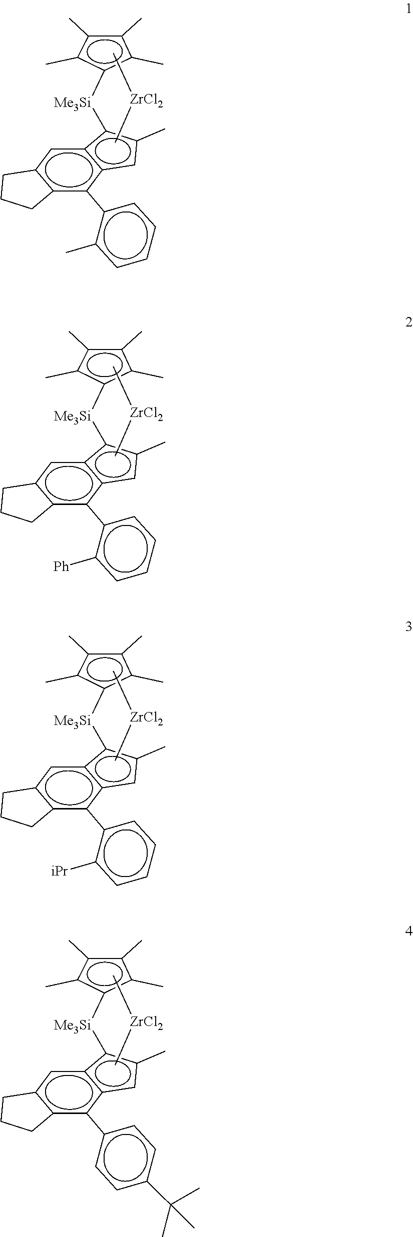

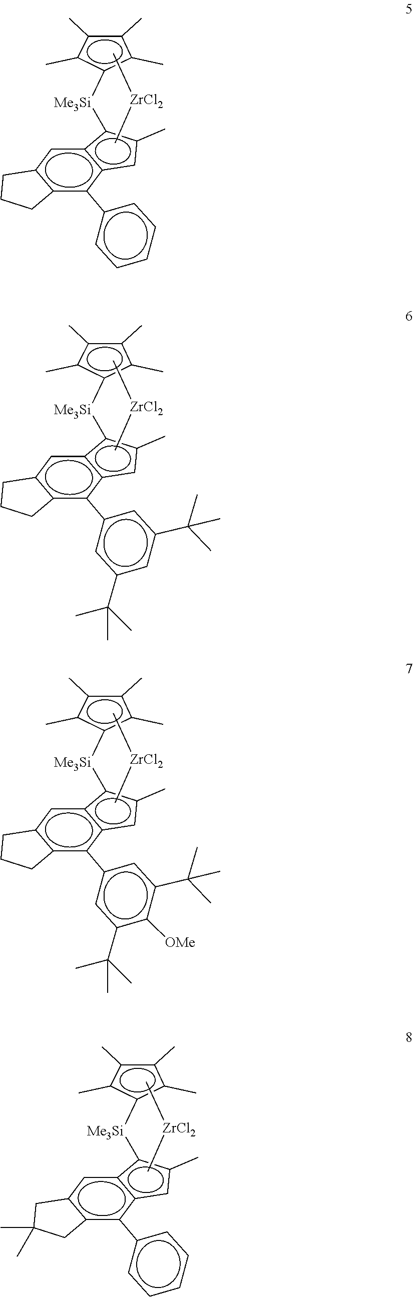

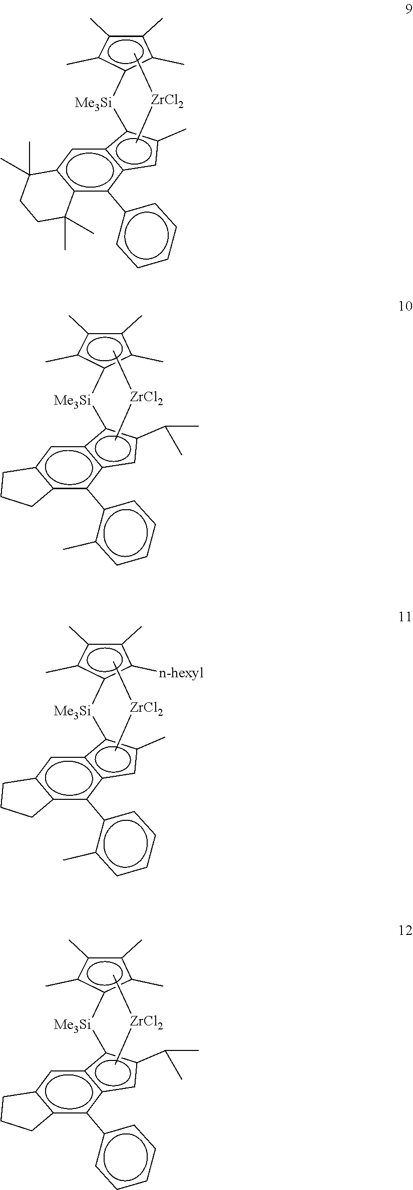

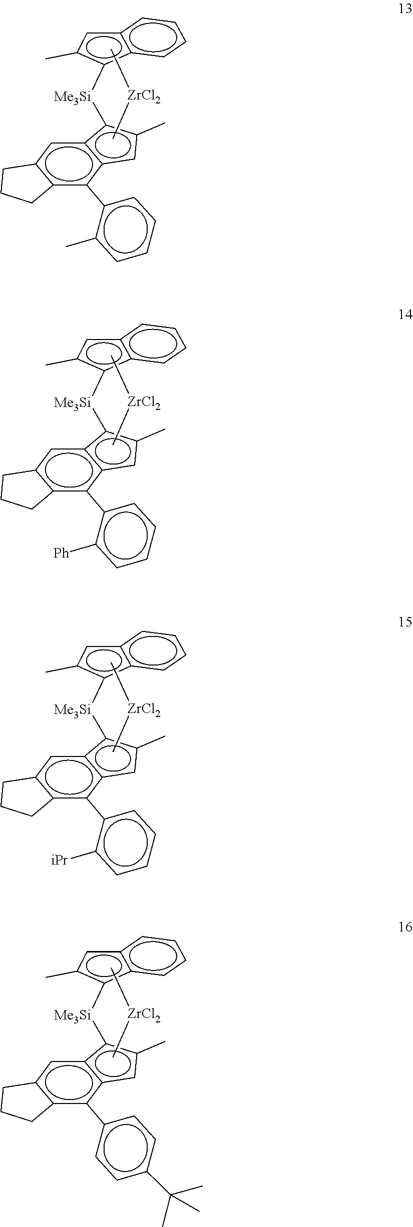

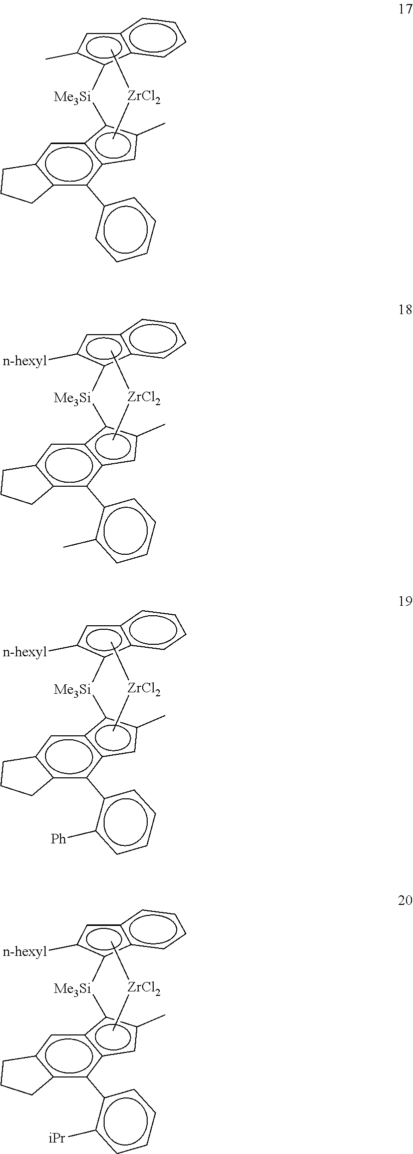

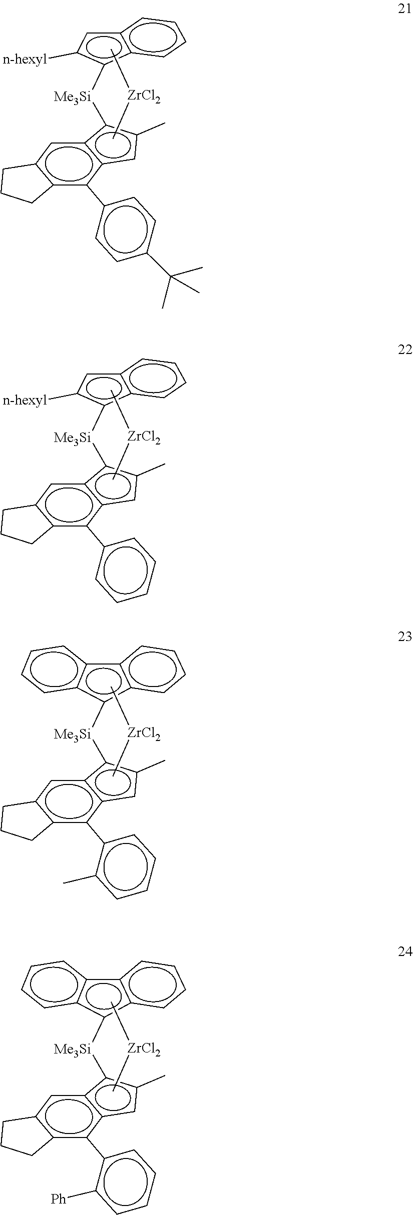

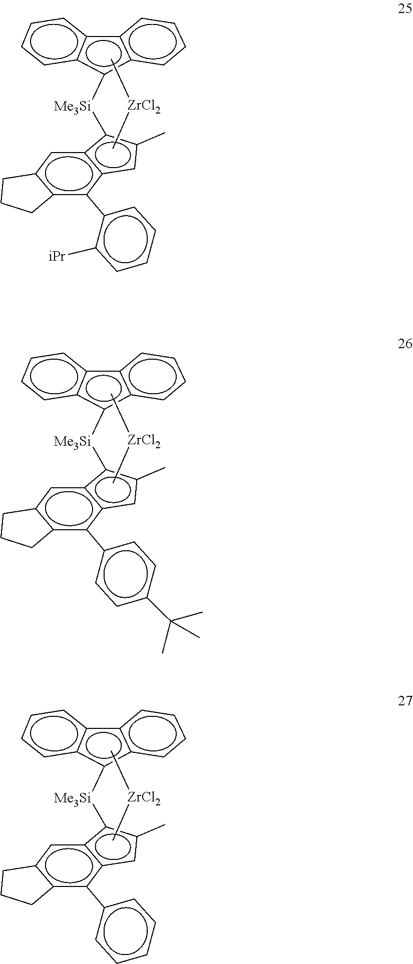

Catalyst compounds useful herein are represented by the formula:

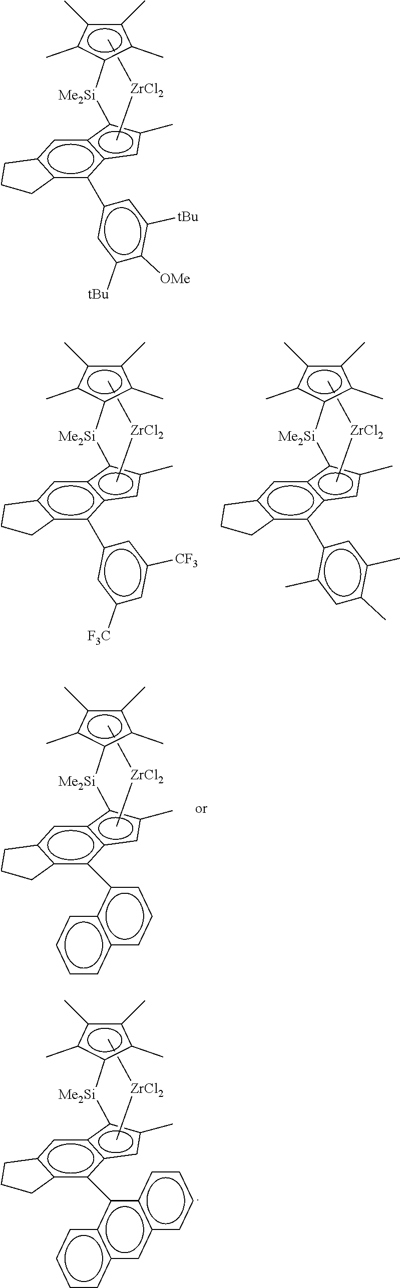

### Activators

The terms “cocatalyst” and “activator” are used herein interchangeably.

The catalyst systems described herein may comprise a catalyst as described above and an activator such as alumoxane or a non-coordinating anion and may be formed by combining the catalyst components described herein with activators in any suitable manner, including combining them with supports, such as silica. The catalyst systems may also be added to or generated in solution polymerization or bulk polymerization (in the monomer). Catalyst systems of the present disclosure may have one or more activators and one, two or more catalyst components. Activators are defined to be any compound which can activate any one of the catalyst compounds described above by converting the neutral metal compound to a catalytically active metal compound cation. Non-limiting activators, for example, may include alumoxanes, aluminum alkyls, ionizing activators, which may be neutral or ionic, and conventional-type cocatalysts. Suitable activators may include alumoxane compounds, modified alumoxane compounds, and ionizing anion precursor compounds that abstract a reactive, σ-bound, metal ligand making the metal compound cationic and providing a charge-balancing non-coordinating or weakly coordinating anion, e.g., a non-coordinating anion.

In at least one embodiment, the catalyst system can include an activator and the catalyst compound of Formula (I), Formula (II), Formula (III), or Formula (IV).

### Alumoxane Activators

Alumoxane activators are utilized as activators in the catalyst systems described herein. Alumoxanes are generally oligomeric compounds containing —Al(R^{a′″})—O— sub-units, where R^{a′″} is an alkyl group. Examples of alumoxanes include methylalumoxane (MAO), modified methylalumoxane (MMAO), ethylalumoxane and isobutylalumoxane. Alkylalumoxanes and modified alkylalumoxanes are suitable as catalyst activators, such as when the abstractable ligand is an alkyl, halide, alkoxide or amide. Mixtures of different alumoxanes and modified alumoxanes may also be used. It may be suitable to use a visually clear methylalumoxane. A cloudy or gelled alumoxane can be filtered to produce a clear solution or clear alumoxane can be decanted from the cloudy solution. A useful alumoxane is a modified methyl alumoxane (MMAO) cocatalyst type 3A (commercially available from Akzo Chemicals, Inc. under the trade name Modified Methylalumoxane type 3A, covered under patent number U.S. Pat. No. 5,041,584, which is incorporated by reference herein). Another useful alumoxane is solid polymethylaluminoxane as described in U.S. Pat. Nos. 8,404,880, 8,975,209, and 9,340,630, which are incorporated by reference herein.

When the activator is an alumoxane (modified or unmodified), at least one embodiment selects the maximum amount of activator at up to a 5,000-fold molar excess Al/M over the catalyst compound (per metal catalytic site). The minimum activator-to-catalyst-compound can be a 1:1 molar ratio. Alternative ranges may include from 1:1 to 500:1, alternatively from 1:1 to 200:1, alternatively from 1:1 to 100:1, or alternatively from 1:1 to 50:1.

### Ionizing/Non-Coordinating Anion Activators

The term “non-coordinating anion” (NCA) means an anion which either does not coordinate to a cation or which is only weakly coordinated to a cation thereby remaining sufficiently labile to be displaced by a Lewis base. “Compatible” non-coordinating anions are those which are not degraded to neutrality when the initially formed complex decomposes. Further, the anion will not transfer an anionic substituent or fragment to the cation so as to cause it to form a neutral transition metal compound and a neutral by-product from the anion. Non-coordinating anions useful in accordance with the present disclosure are those that are compatible, stabilize the transition metal cation in the sense of balancing its ionic charge at +1, and yet retain sufficient lability to permit displacement during polymerization. Suitable ionizing activators may include an NCA, such as a compatible NCA.

It is within the scope of the present disclosure to use an ionizing activator, neutral or ionic in combination with alumoxane or modified alumoxane activators.

The catalyst systems of the present disclosure can include at least one non-coordinating anion (NCA) activator. In at least one embodiment, boron containing NCA activators represented by the formula below can be used:

Z_{d}⁺(A^{d-})

where:
Z is (L-H) or a reducible Lewis acid; L is a Lewis base; H is hydrogen;
(L-H) is a Bronsted acid;
A^{d-} is a boron containing non-coordinating anion having the charge d−; and
d is 1, 2, or 3.

The cation component, Z_{d}⁺ may include Bronsted acids such as protons or protonated Lewis bases or reducible Lewis acids capable of protonating or abstracting a moiety, such as an alkyl or aryl, from the bulky ligand transition metal catalyst precursor, resulting in a cationic transition metal species.

The activating cation Z_{d}⁺ may also be a moiety such as silver, tropylium, carbeniums, ferroceniums and mixtures, such as carbeniums and ferroceniums. Z_{d}⁺ can be triphenyl carbenium. Reducible Lewis acids can be a triaryl carbenium (where the aryl can be substituted or unsubstituted, such as those represented by the formula: (Ar₃C⁺), where Ar is aryl or aryl substituted with a heteroatom, a C₁ to C₄₀ hydrocarbyl, or a substituted C₁ to C₄₀ hydrocarbyl), such as the reducible Lewis acids “Z” may include those represented by the formula: (Ph₃C), where Ph is a substituted or unsubstituted phenyl, such as substituted with C₁ to C₄₀ hydrocarbyls or substituted a C₁ to C₄₀ hydrocarbyls, such as C₁ to C₂₀ alkyls or aromatics or substituted C₁ to C₂₀ alkyls or aromatics, such as Z is a triphenylcarbenium.

When Z_{d}⁺ is the activating cation (L-H)_{d}⁺, it can be a Bronsted acid, capable of donating a proton to the transition metal catalytic precursor resulting in a transition metal cation, including ammoniums, oxoniums, phosphoniums, silyliums, and mixtures thereof, such as ammoniums of methylamine, aniline, dimethylamine, diethylamine, N-methylaniline, diphenylamine, trimethylamine, triethylamine, N,N-dimethylaniline, methyldiphenylamine, pyridine, p-bromo N,N-dimethylaniline, p-nitro-N,N-dimethylaniline, dioctadecylmethylamine, phosphoniums from triethylphosphine, triphenylphosphine, and diphenylphosphine, oxomiuns from ethers such as dimethyl ether diethyl ether, tetrahydrofuran and dioxane, sulfoniums from thioethers, such as diethyl thioethers, tetrahydrothiophene, and mixtures thereof.

When Z_{d}⁺ is the activating cation (L-H)_{d}⁺, it can be represented by the formula

[R^{1′}R^{2′}R^{3′}EH]_{d}_{⁺}

wherein: E is nitrogen or phosphorous; d is 1, 2 or 3; R^{1′}, R^{2′}, and R^{3′} are independently a C₁ to C₅₀ hydrocarbyl group optionally substituted with one or more alkoxy groups, silyl groups, a halogen atoms, or halogen containing groups, wherein R^{1′}, R^{2′}, and R^{3′} together comprise 15 or more carbon atoms.

The anion component A^{d-} includes those having the formula [M^{k+}Qₙ]^{d-} where k is 1, 2, or 3; n is 1, 2, 3, 4, 5, or 6 (such as 1, 2, 3, or 4); n−k=d; M is an element selected from Group 13 of the Periodic Table of the Elements, such as boron or aluminum, and Q is independently a hydride, bridged or unbridged dialkylamido, halide, alkoxide, aryloxide, hydrocarbyl, substituted hydrocarbyl, halocarbyl, substituted halocarbyl, and halosubstituted-hydrocarbyl radicals, said Q having up to 50 (such as up to 20) carbon atoms with the optional proviso that in not more than 1 occurrence is Q a halide. Each Q can be a fluorinated hydrocarbyl group having 1 to 50 (such as 1 to 20) carbon atoms, such as each Q is a fluorinated aryl group, and such as each Q is a pentafluoryl aryl group. Examples of suitable A^{d-} also include diboron compounds as disclosed in U.S. Pat. No. 5,447,895, which is fully incorporated herein by reference.

The ionic stoichiometric activator Zd+(Ad−) can be one or more of N,N-dimethylanilinium tetrakis(perfluorophenyl)borate, N,N-dimethylanilinium tetrakis(perfluoronaphthyl)borate, dioctadecylmethylammonium tetrakis(perfluorophenyl)borate, N,N-dimethylanilinium tetrakis(perfluorobiphenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, or triphenylcarbenium tetra(perfluorophenyl)borate.

It is also within the scope of the present disclosure that the catalyst compounds can be combined with combinations of activators, including combinations of alumoxanes and NCA's.

### Optional Chain Transfer Agents

Useful chain transfer agents can be hydrogen, alkylalumoxanes, a compound represented by the formula AlR₃, ZnR₂ (where each R is, independently, a C₁-C₈ aliphatic radical, such as methyl, ethyl, propyl, butyl, pentyl, hexyl octyl or an isomer thereof) or a combination thereof, such as diethyl zinc, methylalumoxane, trimethylaluminum, triisobutylaluminum, trioctylaluminum, or a combination thereof.

Furthermore, a catalyst system of the present disclosure may include a metal hydrocarbenyl chain transfer agent represented by the formula:

Al(R′)₃₋ᵥ(R″)ᵥ

where each R′ can be independently a C₁-C₃₀ hydrocarbyl group, and/or each R″, can be independently a C₄-C₂₀ hydrocarbenyl group having an end-vinyl group; and v can be from 1 to 3, preferably 2 to 3.

### Optional Scavengers or Coactivators

In addition to these activator compounds, scavengers or coactivators may be used. Aluminum alkyl or alumoxane compounds which may be utilized as scavengers or coactivators may include, for example, trimethylaluminum, triethylaluminum, triisobutylaluminum, tri-n-hexylaluminum, tri-n-octylaluminum, diisobutylaluminum hydride, methylalumoxane (MAO), modified methylalumoxane (MMAO), MMAO-3A, and diethyl zinc.

### Support Materials

The catalyst systems, supported catalyst compounds, supported activators, etc. prepared herein include an inert support material. The support material can be a porous support material, for example, talc, and inorganic oxides. Other support materials include zeolites, clays, organoclays, or another organic or inorganic support material, or mixtures thereof.

In at least one embodiment, the support material is an inorganic oxide, such as finely divided inorganic oxide. Suitable inorganic oxide materials for use in catalyst systems herein include Groups 2, 4, 13, and 14 metal oxides, such as silica, alumina, and mixtures thereof. Other inorganic oxides that may be employed either alone or in combination with the silica, or alumina are magnesia, titania, zirconia, and the like. Other suitable support materials, however, can be used, for example, functionalized polyolefins, such as functionalized polypropylene. Support materials may include magnesia, titania, zirconia, montmorillonite, phyllosilicate, zeolites, talc, clays, and the like. Also, combinations of these support materials may be used, for example, silica-chromium, silica-alumina, silica-titania, and the like. Support materials may include Al₂O₃, ZrO₂, SiO₂, SiO₂/Al₂O₃, SiO₂/TiO₂, silica clay, silicon oxide/clay, or mixtures thereof. Other suitable support materials, however, can be employed, for example, finely divided functionalized polyolefins, such as finely divided polyethylene, polypropylene, and polystyrene with functional groups that are able to absorb water, e.g., oxygen or nitrogen containing groups such as —OH, —RC═O, —OR, and —NR₂. Particularly useful supports include magnesia, titania, zirconia, montmorillonite, phyllosilicate, zeolites, talc, clays, silica clay, silicon oxide clay, and the like. Also, combinations of these support materials may be used, for example, silica-chromium, silica-alumina, silica-titania, and the like. In at least one embodiment, the support material is selected from Al₂O₃, ZrO₂, SiO₂, SiO₂/Al₂O₂, silica clay, silicon oxide/clay, or mixtures thereof. The support material may be fluorided.

As used herein, the phrases “fluorided support” and “fluorided support composition” mean a support, desirably particulate and porous, which has been treated with at least one inorganic fluorine containing compound. For example, the fluorided support composition can be a silicon dioxide support wherein a portion of the silica hydroxyl groups has been replaced with fluorine or fluorine containing compounds. Suitable fluorine containing compounds include, but are not limited to, inorganic fluorine containing compounds and/or organic fluorine containing compounds.

Fluorine compounds suitable for providing fluorine for the support may be organic or inorganic fluorine compounds and are desirably inorganic fluorine containing compounds. Such inorganic fluorine containing compounds may be any compound containing a fluorine atom as long as it does not contain a carbon atom. Particularly desirable are inorganic fluorine-containing compounds selected from NH₄BF₄, (NH₄)₂SiF₆, NH₄PF₆, NH₄F, (NH₄)₂TaF₇, NH₄NbF₄, (NH₄)₂GeF₆, (NH₄)₂SmF₆, (NH₄)₂TiF₆, (NH₄)₂ZrF₆, MoF₆, ReF₆, GaF₃, SO₂ClF, F₂, SiF₄, SF₆, ClF₃, ClF₅, BrF₅, IF₇, NF₃, HF, BF₃, NHF₂, NH₄HF₂, and combinations thereof. In at least one embodiment, ammonium hexafluorosilicate and ammonium tetrafluoroborate are used.

In at least one embodiment, the support material comprises a support material treated with an electron-withdrawing anion. The support material can be silica, alumina, silica-alumina, silica-zirconia, alumina-zirconia, aluminum phosphate, heteropolytungstates, titania, magnesia, boria, zinc oxide, mixed oxides thereof, or mixtures thereof; and the electron-withdrawing anion is selected from fluoride, chloride, bromide, phosphate, triflate, bisulfate, sulfate, or any combination thereof.

An electron-withdrawing component can be used to treat the support material. The electron-withdrawing component can be any component that increases the Lewis or Bronsted acidity of the support material upon treatment (as compared to the support material that is not treated with at least one electron-withdrawing anion). In at least one embodiment, the electron-withdrawing component is an electron-withdrawing anion derived from a salt, an acid, or other compound, such as a volatile organic compound, that serves as a source or precursor for that anion. Electron-withdrawing anions can be sulfate, bisulfate, fluoride, chloride, bromide, iodide, fluorosulfate, fluoroborate, phosphate, fluorophosphate, trifluoroacetate, triflate, fluorozirconate, fluorotitanate, phospho-tungstate, or mixtures thereof, or combinations thereof. An electron-withdrawing anion can be fluoride, chloride, bromide, phosphate, triflate, bisulfate, or sulfate, and the like, or any combination thereof, at least one embodiment of this disclosure. In at least one embodiment, the electron-withdrawing anion is sulfate, bisulfate, fluoride, chloride, bromide, iodide, fluorosulfate, fluoroborate, phosphate, fluorophosphate, trifluoroacetate, triflate, fluorozirconate, fluorotitanate, or combinations thereof.

Thus, for example, the support material suitable for use in the catalyst systems of the present disclosure can be one or more of fluorided alumina, chlorided alumina, bromided alumina, sulfated alumina, fluorided silica-alumina, chlorided silica-alumina, bromided silica-alumina, sulfated silica-alumina, fluorided silica-zirconia, chlorided silica-zirconia, bromided silica-zirconia, sulfated silica-zirconia, fluorided silica-titania, fluorided silica-coated alumina, sulfated silica-coated alumina, phosphated silica-coated alumina, and the like, or combinations thereof. In at least one embodiment, the activator-support can be, or can comprise, fluorided alumina, sulfated alumina, fluorided silica-alumina, sulfated silica-alumina, fluorided silica-coated alumina, sulfated silica-coated alumina, phosphated silica-coated alumina, or combinations thereof. In another embodiment, the support material includes alumina treated with hexafluorotitanic acid, silica-coated alumina treated with hexafluorotitanic acid, silica-alumina treated with hexafluorozirconic acid, silica-alumina treated with trifluoroacetic acid, fluorided boria-alumina, silica treated with tetrafluoroboric acid, alumina treated with tetrafluoroboric acid, alumina treated with hexafluorophosphoric acid, or combinations thereof. Further, any of these activator-supports optionally can be treated with a metal ion.

Nonlimiting examples of cations suitable for use in the present disclosure in the salt of the electron-withdrawing anion include ammonium, trialkyl ammonium, tetraalkyl ammonium, tetraalkyl phosphonium, H+, [H(OEt₂)₂]+, [HNR₃]+(R═C₁-C₂₀ hydrocarbyl group, which may be the same or different) or combinations thereof.

Further, combinations of one or more different electron-withdrawing anions, in varying proportions, can be used to tailor the specific acidity of the support material to a desired level. Combinations of electron-withdrawing components can be contacted with the support material simultaneously or individually, and in any order that provides a desired chemically-treated support material acidity. For example, in at least one embodiment, two or more electron-withdrawing anion source compounds in two or more separate contacting steps.

In one embodiment of the present disclosure, one example of a process by which a chemically-treated support material is prepared is as follows: a selected support material, or combination of support materials, can be contacted with a first electron-withdrawing anion source compound to form a first mixture; such first mixture can be calcined and then contacted with a second electron-withdrawing anion source compound to form a second mixture; the second mixture can then be calcined to form a treated support material. In such a process, the first and second electron-withdrawing anion source compounds can be either the same or different compounds.

The method by which the oxide is contacted with the electron-withdrawing component, typically a salt or an acid of an electron-withdrawing anion, can include, but is not limited to, gelling, co-gelling, impregnation of one compound onto another, and the like, or combinations thereof. Following a contacting method, the contacted mixture of the support material, electron-withdrawing anion, and optional metal ion, can be calcined.

According to another embodiment of the present disclosure, the support material can be treated by a process comprising: (i) contacting a support material with a first electron-withdrawing anion source compound to form a first mixture; (ii) calcining the first mixture to produce a calcined first mixture; (iii) contacting the calcined first mixture with a second electron-withdrawing anion source compound to form a second mixture; and (iv) calcining the second mixture to form the treated support material.

It is preferred that the support material, preferably an inorganic oxide, has a surface area between about 10 m²/g and about 700 m²/g, pore volume between about 0.1 cc/g and about 4.0 cc/g and average particle size between about 5 μm and about 500 μm. In at least one embodiment, the surface area of the support material is between about 50 m²/g and about 500 m²/g, pore volume between about 0.5 cc/g and about 3.5 cc/g and average particle size between about 10 μm and about 200 μm. The surface area of the support material may be between about 100 m²/g and about 400 m²/g, pore volume between about 0.8 cc/g and about 3.0 cc/g and average particle size between about 5 μm and about 100 μm. The average pore size of the support material may be between about 10 Å and about 1000 Å, such as between about 50 Å and about 500 Å, such as between about 75 Å and about 350 Å. In at least one embodiment, the support material is an amorphous silica with surface area of 300 m²/gm or more, such as 300-400 m²/gm and or a pore volume of 0.9-1.8 cm³/gm. In at least one embodiment, the supported material may optionally be a sub-particle containing silica with average sub-particle size in the range of 0.05 to 5 micron, e.g., from the spray drying of average particle size in the range of 0.05 to 5 micron small particle to form average particle size in the range 5 to 200 micron large main particles. In at least one embodiment, the supported material may optionally have pores with pore diameter= or >100 angstrom at least 20% of the total pore volume defined by BET method. Non-limiting example silicas useful herein include Grace Davison's 952, 955, and 948; PQ Corporation's ES70 series, PD 14024, PD16042, and PD16043; Asahi Glass Chemical (AGC)'s D70-120A, DM-H302, DM-M302, DM-M402, DM-L302, and DM-L402; Fuji's P-10/20 or P-10/40; and the like.

The support material, such as an inorganic oxide, optionally has a surface area of from 50 m²/g to 800 m²/g, a pore volume in the range of from 0.5 cc/g to 5.0 cc/g and an average particle size in the range of from 1 μm to 200 μm.

The support material should be dry, that is, substantially free of absorbed water. Drying of the support material can be effected by heating or calcining at 100° C. to 1,000° C., such as at least about 600° C. When the support material is silica, it is heated to at least 200° C., such as 200° C. to 900° C.; and for a time of 1 minute to about 100 hours, from 12 hours to 72 hours, or from 24 hours to 60 hours. The calcined support material should have at least some reactive hydroxyl (OH) groups to produce supported catalyst systems of the present disclosure.

### Supported Catalyst Compositions Containing Aromatic-Solvent-Free Supports

The present disclosure relates to catalyst systems comprising aromatic-solvent-free supported methylalumoxane and catalyst compounds. The aromatic-solvent-free supported methylalumoxane is obtained by contacting an alumoxane precursor (described below) with a support, such as a silica support, and heating the combination.

When used as a part of a catalyst system, the aromatic-solvent-free supported MAO has an effect of increasing catalyst activity.

### Alumoxane Precursor

The alumoxane precursor is the reaction product of an unsaturated carboxylic acid, such as methacrylic acid (MAA), and 3 or more trimethylaluminum (TMA) in an alkane solvent, typically a warm alkane solvent, preferably between approximately 25 and 70° C. Alternatively, an aluminum carboxylate dimer or oligomer such as, Me₂Al(μ-O₂CCMe=CH₂)₂AlMe₂ (MAl) may be combined with 2 or more TMA in a warm solvent. A useful reaction medium is refluxing pentane at near 1 atm pressure. The reaction to form the precursor is judged complete, after the aluminum carboxylate resonances have decreased to 20 mol % or less, and preferably, 5 mol % or less, of the total vinyl CH resonances. At this point, the precursor mixture may be concentrated, in the presence or absence of a support, without harm by distilling the solvent away from the reaction mixture. Heating the precursor causes formation of MAO. The precursors are stable and may be used directly to prepare supported catalysts or stored for later use. Likewise, the precursor, and optionally additional TMA, may be concentrated onto the surface of a support and stored at sub-ambient or room temperature until later heating to form a supported MAO.

The alumoxane precursor may be formed by introducing an acid to an alkylaluminum in an aliphatic solvent. The molar ratio of the acid to the alkylaluminum can be from about 1:3 to about 1:9, such as from about 1:3 to about 1:5.

In at least one embodiment, the acid is represented by the formula:

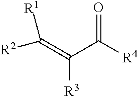

where R³ is a hydrocarbyl group, R² and R¹ independently are hydrogen or a hydrocarbyl group (preferably C₁ to C₂₀ alkyl, alkenyl or C₅ to C₂₀ aryl group (such as methyl, ethyl, propyl, butyl, pentyl, hexyl, heptyl, octyl, nonyl, decyl, undecyl, dodecyl, and phenyl), optionally R¹, R², or R³ may be joined together to form a ring, and R⁴ is hydroxide (—OH). In at least one embodiment, the acid is an alkylacrylic acid represented by the formula R*—C(═CH₂)COOH, where each R* is a C₁ to C₂₀ alkyl group (such as methyl, ethyl, propyl, butyl, pentyl, hexyl, heptyl, octyl, nonyl, decyl, undecyl, and dodecyl). In at least one embodiment, the alkylacrylic acid is methacrylic acid. In alternative embodiments, the acid is benzoic acid.

In at least one embodiment, the alkylaluminum is represented by the formula R₃Al, where each R may independently be a C₁ to C₂₀ alkyl group (such as methyl, ethyl, propyl, butyl, pentyl, hexyl, heptyl, octyl, nonyl, decyl, undecyl, and dodecyl). In at least one embodiment, the alkylaluminum is trimethylaluminum.

The addition of the acid to the alkylaluminum to from a precursor may be done conveniently at reflux temperatures, such as 70° C. or less. The reflux temperature is based on the boiling point of the aliphatic solvent. In at least one embodiment, the boiling point of the aliphatic solvent, i.e., the reflux temperature, is less than about 70° C., such as from about 20° C. to about 70° C. The boiling point of the aliphatic solvent may be lower than the boiling point of the alkylaluminum. In at least one embodiment, the boiling point of the aliphatic solvent is at least 40° C. lower than the boiling point of the alkylaluminum, such as at least 50° C. lower or at least 60° C. lower.

Alternately, the alumoxane precursor may be formed by introducing the reaction product of approximately 1 TMA and 1 unsaturated carboxylic acid (e.g., a dimer or oligomer) to an alkylaluminum in an aliphatic solvent. The molar ratio of the reaction product to the alkylaluminum can be from about 1:2 to about 1:9, such as from about 1:2 to about 1:5.

In at least one embodiment, the unsaturated carboxylic acid is an alkylacrylic acid represented by the formula R*—C(═CH₂)COOH, where each R* is a C₁ to C₂₀ alkyl group (such as methyl, ethyl, propyl, butyl, pentyl, hexyl, heptyl, octyl, nonyl, decyl, undecyl, and dodecyl). In at least one embodiment, the unsaturated carboxylic acid is methacrylic acid. In alternative embodiments, the unsaturated carboxylic acid is benzoic acid.

The addition of the 1 TMA to the 1 unsaturated carboxylic acid to form the reaction product (e.g., dimer or oligomer) may be done at reflux temperatures, preferably at temperatures 0° C. or less. The reflux temperature is based on the boiling point of the aliphatic solvent. In at least one embodiment, the boiling point of the aliphatic solvent, i.e., the reflux temperature, is less than about 70° C., such as less than 50° C., such as less than 0° C. The boiling point of the aliphatic solvent may be lower than the boiling point of the TMA. In at least one embodiment, the boiling point of the aliphatic solvent is at least 40° C. lower than the boiling point of the TMA, such as at least 50° C. lower or at least 60° C. lower.

The addition of the reaction product (of TMA and unsaturated carboxylic acid) to the alkylaluminum may be done at the reflux temperature. The reflux temperature is based on the boiling point of the aliphatic solvent. In at least one embodiment, the boiling point of the aliphatic solvent, i.e., the reflux temperature, is less than about 70° C., such as 50° C. or less, such as from about 20° C. to about 70° C. The boiling point of the aliphatic solvent may be lower than the boiling point of the alkylaluminum. In at least one embodiment, the boiling point of the aliphatic solvent is at least 40° C. lower than the boiling point of the alkylaluminum, such as at least 50° C. lower or at least 60° C. lower.

The reaction product of approximately 1 TMA and a 1 unsaturated carboxylic acid can be represented by the formula:

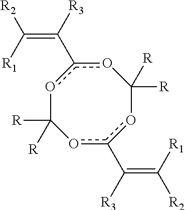

where R³ is a hydrocarbyl group, R² and R¹ independently are hydrogen or a hydrocarbyl group (preferably C₁ to C₂₀ alkyl, alkenyl or C₅ to C₂₀ aryl group (such as methyl, ethyl, propyl, butyl, pentyl, hexyl, heptyl, octyl, nonyl, decyl, undecyl, dodecyl, and phenyl), optionally R¹, R², or R³ may be joined together to form a ring.

In at least one embodiment, the reaction product of approximately 1 TMA and a 1 unsaturated carboxylic acid comprises:

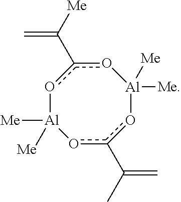

The aliphatic solvents useful in the reactions above include, but are not limited to, butanes, pentanes, hexanes, heptanes, octanes, nonanes, decanes, undecanes, dodecanes, tridecanes, tetradecanes, pentadecanes, hexadecanes, or combination(s) thereof; preferable aliphatic solvents can include normal paraffins (such as NORPAR® solvents available from ExxonMobil Chemical Company in Houston, TX), isoparaffin solvents (such as ISOPAR® solvents available from ExxonMobil Chemical Company in Houston, TX), and combinations thereof. For example, the aliphatic solvent can be selected from C₃ to C₁₂ linear, branched or cyclic alkanes. In some embodiments, the aliphatic solvent is substantially free of aromatic solvent. Preferably, the aliphatic solvent is essentially free of toluene. Useful aliphatic solvents are ethane, propane, n-butane, 2-methylpropane, n-pentane, cyclopentane, 2-methylbutane, 2-methylpentane, n-hexane, cyclohexane, methylcyclopentane, 2,4-dimethylpentane, n-heptane, 2,2,4-trimethylpentane, methylcyclohexane, octane, nonane, decane, or dodecane, and mixture(s) thereof. Preferably, the aliphatic solvent is 2-methylpentane or n-pentane. In at least one embodiment, aromatics are present in the aliphatic solvent at less than 1 wt %, such as less than 0.5 wt %, such as at 0 wt % based upon the weight of the solvents. In at least one embodiment, the aliphatic solvent is n-pentane and/or 2-methylpentane.

The acid or the reaction product of approximately 1 alkyl aluminum (such as TMA) and 1 unsaturated carboxylic acid may be in an aliphatic solvent before mixing with the alkylaluminum, which may also be in an aliphatic solvent. The aliphatic solvents of the acid and the alkylaluminum may be the same. The aliphatic solvents of the reaction product of approximately 1 alkyl aluminum (such as TMA) and 1 unsaturated carboxylic acid and the alkylaluminum may be the same.

In at least one example, an alumoxane precursor in solution can be prepared by addition of a solution of methacrylic acid in pentane to a solution of trimethylaluminum in pentane at a rate to maintain a controlled reflux, which is maintaining the reaction temperature at about 36° C. (for example 36.1° C.), which is the boiling point of pentane. The ratio of MAA to TMA may be from about 1:3 to about 1:5.

The reaction product of the addition of the acid (or reaction product of approximately 1 TMA and a 1 unsaturated carboxylic acid) to the alkylaluminum in the aliphatic solvent may include the alumoxane precursor, unreacted alkylaluminum, and the aliphatic solvent. The alumoxane precursor may be in a concentrated form by removing 50 wt % or more of the aliphatic solvent from the solution form, such as removing 60 wt %, 70 wt %, or 80 wt % of the aliphatic solvent from the solution form. However, the unreacted alkylaluminum in the reaction product might not be removed when removing the aliphatic solvent because the boiling point of the alkyaluminum can be greater than that of the aliphatic solvent. A concentrated solution can be an oil having from about 5 wt % to about 49 wt % solvent remaining in the oil. In at least one example, the majority of the aliphatic solvent in the alumoxane precursor in solution in the previous example can be removed by distillation. ¹H NMR spectrum showed the resulting alumoxane precursor in concentrated form contained approximately 21 wt % pentane. After accounting for methane loss, the concentrated form contained approximately 2.9 mmol equivalents to MAA per gram of concentrated form.

In some embodiments, the molar ratio of the acid to the alkylaluminum is about 1:3 (or less with respect to the alkylaluminum, such as about 1:1), and a dimer may be formed. In at least one embodiment, the dimer is represented by the formula [Me₂Al(μ-O₂CCMe=CH₂)]₂. The alumoxane precursor can be formed by introducing the dimer to the alkylaluminum at a molar ratio of the dimer to the alkylaluminum of about 1:2 (or greater with respect to the alkylaluminum) under reflux. In some embodiments, MAA is introduced to TMA at a molar ratio of about 1 MAA to about 3.5 TMA, and a mixture of aluminum species is formed; in this scenario, extra TMA to total at least 3 TMA/MAA is introduced with heating. In at least one embodiment, a distribution of intermediates is formed with a bridged alkoxide, represented by LₙAlₘ(μ-OCMe₂CMe=CH₂), where L may be C₁-C₁₀ alkyl (such as methyl), terminal or bridging, or a bridging oxygen, m may be >2, and n is ≥2(m).

The alumoxane precursor, both the concentrated form and the solution form, can be identified by a characteristic spectroscopic pattern in the ¹H NMR (C₆D₆). Within the range from 4.5 to 5.1 ppm there are three sets of signals corresponding to bridged alkoxide precursors. There is a sharp set of signals, A, at 4.68±0.05 and 4.88±0.05 ppm, a second set, B, at 4.73±0.05 and 4.95±0.05 and further broad minor resonances, C in this range. The ratio of the integrals for the signals from 4.5 to 5.1 ppm to that from 5.1 and 6.5 ppm is >2.8. The presence of carboxylates in the precursor is believed to be detrimental to forming MAO on supports.

The effectiveness of the alumoxane precursor is influenced by the TMA/MAA ratio. At lower TMA ratios, the alumoxane formed shows supported catalysts have lower activities. This is demonstrated by combinations of precursor with lower levels of TMA. Upon concentrating the precursor solution, by removal of solvent, it is possible to co-distill out TMA from the reaction mixture; this also reduces catalyst activity. This is demonstrated by removal of solvent with vacuum after combining a precursor solution to support.

Suitable precursors for preparing supported MAO have TMA/MAA ratios greater than or equal to:

[(3 mmol TMA/mmol MAA)*(mmol MAAₜₒₜₐₗ)+(0.5*mmol TMA_{chemisorbed}/g support)*(g support_{actual})]/[mmol MAA],

where (mmol TMA_{chemisorbed}/g support) is the amount of TMA chemisorbed to the support surface in the absence of MAA. MAAₜₒₜₐₗ should be at least approximately 1.5 mmol MAA/g of support. Likewise, for MAl, suitable precursors for preparing supported catalysts have TMA/MAl ratios greater than or equal to:

[(2 mmol TMA/mmol MAl)*(mmol MAlₜₒₜₐₗ)+(0.5*mmol TMA_{chemisorbed}/g support)*(g support_{actual})]/[mmol MAl].

MAlₜₒₜₐₗ should be at least approximately 0.75 mmol MAl/g of support. These ratios may be achieved by adding TMA to a precursor made from a TMA/MAA ratio of approximately 3 or even less than 3, or directly preparing a precursor with a higher TMA/MAA ratio. Likewise, for MAl, these ratios may be achieved by adding TMA to a precursor made from a TMA/MAl ratio of approximately 2 or even less than 2, or directly preparing a precursor with a higher TMA/MAl ratio. The former approach of adding TMA to a precursor is especially convenient when preparing catalysts from a variety of supports. The latter is convenient when repeatedly preparing a particular catalyst. Absorbing these higher TMA/MAA or TMA/MAl based precursors to the surface of a support material, such as amorphous silica, allows supported MAO to be formed that is suitable to prepare catalysts for particle form polymerization processes, e.g., slurry phase polymerization processes.

### Catalyst System

In another embodiment, a first composition includes a catalyst compound described herein (such as a catalyst compound of Formula (I), Formula (II), Formula (III), or Formula (IV)), and a support material comprising a plurality of particles coated with a second composition. The second composition includes the reaction product of methacrylic acid and ≥3 alkylaluminum, R₃Al, in an aliphatic solvent wherein the product as characterized by ¹H NMR in C₆D₆ has initially from 4.5 to 5.1 ppm a set of signals, A, at 4.68±0.05 and 4.88±0.05 ppm, a second set, B, at 4.73±0.05 and 4.95±0.05 and further minor resonances, C wherein, the ratio of the signals from 4.5 to 5.1 ppm to that from 5.1 and 6.5 ppm is >2.8; and furthermore is concentrated by distillation of solvent, wherein R is a C₁-C₂₀ hydrocarbyl group, preferably methyl.

In another embodiment, a composition includes a catalyst compound described herein (such as a catalyst compound of Formula (I), Formula (II), Formula (III), or Formula (IV)), a support and the reaction product of the dimer:

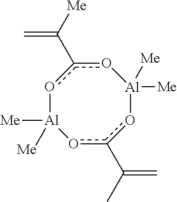

and ≥2 alkylaluminum, R₃Al, in an aliphatic solvent wherein the product as characterized by ¹H NMR in C₆D₆ has initially from 4.5 to 5.1 ppm a set of signals, A, at 4.68±0.05 and 4.88±0.05 ppm, a second set, B, at 4.73±0.05 and 4.95±0.05 and further minor resonances, C wherein, the ratio of the signals from 4.5 to 5.1 ppm to that from 5.1 and 6.5 ppm is >2.8; wherein R is a C₁-C₂₀ hydrocarbyl group, preferably methyl.

In another embodiment, a first composition includes a catalyst compound described herein (such as a catalyst compound of Formula (I), Formula (II), Formula (III), or Formula (IV)), and a support material comprising a plurality of particles coated with a second composition. The second composition includes the reaction product of the dimer:

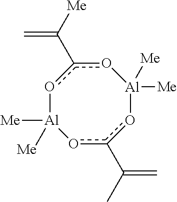

and ≥2 alkylaluminum, R₃Al, in an aliphatic solvent wherein the product as characterized by ¹H NMR in C₆D₆ has initially from 4.5 to 5.1 ppm a set of signals, A, at 4.68±0.05 and 4.88±0.05 ppm, a second set, B, at 4.73±0.05 and 4.95±0.05 and further minor resonances, C wherein, the ratio of the signals from 4.5 to 5.1 ppm to that from 5.1 and 6.5 ppm is >2.8; and furthermore is concentrated to <20 wt % solvent by distillation, wherein R is a C₁-C₂₀ hydrocarbyl group, preferably methyl.

An aromatic-free catalyst composition can be prepared by contacting a catalyst precursor (such as a catalyst compound of Formula (I), Formula (II), Formula (III), or Formula (IV)) with the alkyl aluminum treated support material described above in non-aromatic hydrocarbon solvents such as n-pentane, isohexane, n-hexane, n-heptane, n-octane. Contact times can be form 1 minute to several hours, such as 1 to 6 hours, such as 2-4 hours, after which finished catalyst is filtered, and washed with additional amounts of dried and degassed non-aromatic hydrocarbon solvent, typically a dried non-aromatic hydrocarbon solvent.

Useful combinations include one or more C₁ symmetric catalysts (such as catalyst compounds of Formula (I), Formula (II), Formula (III), or Formula (IV)) combined with alumoxane and ASF-Support, preferably comprising high surface area silica (SA 300 m²/g or more), such as PQ Corporation's PD14024 and AGC's DM-L403. Alternatively any dual catalyst combination that includes two C₁ symmetric, a C₁ symmetric and C₂ symmetric or two C₂ symmetric catalysts could be used.

Useful combinations include T(Me₄Cp)(2-Me-4-Aryl-tetrahydroindacenyl)MX₂ where M is a group 4 metal, such as Hf, Zr or Ti, T is a bridging group such as SiR₂, where R is a C₁ to C₂₀ alkyl, and each X is independently a leaving group, such as halogen or C₁ to C₂₀ alkyl, combined with alumoxane and ASF-Support, preferably comprising high surface area silica (SA of 300 m²/g or more), such as PQ Corporation's PD14024 and AGC's DM-L403).

Particularly useful combinations include one or more of catalyst compounds 1, 2, 3, 4, 5, 6, 7, 8, 9, 10, 11, and 12 combined with alumoxane and ASF-Support, preferably comprising high surface area silica (SA of 300 m²/g or more), such as PQ Corporation's PD14024 and AGC's DM-L403).

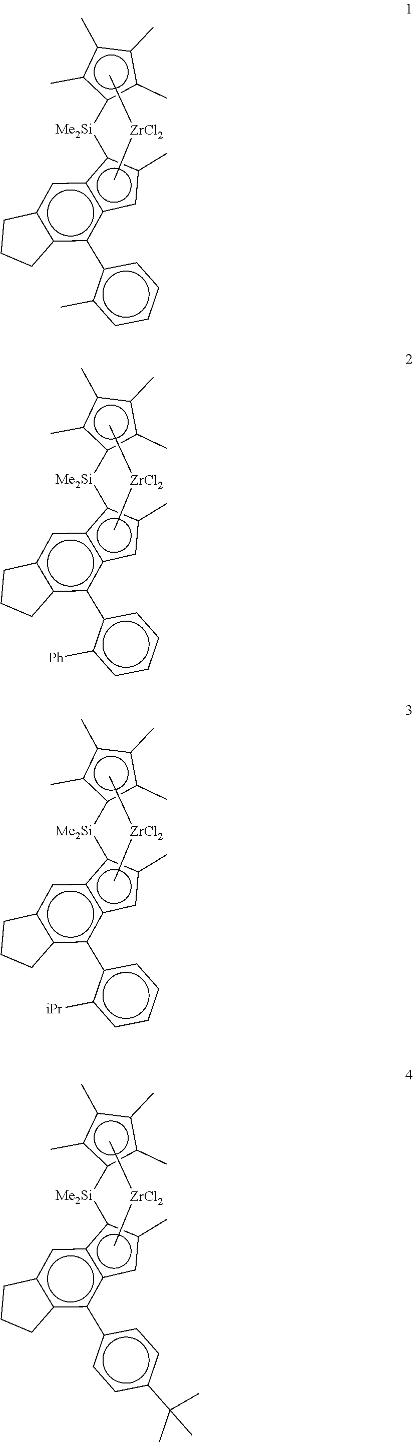

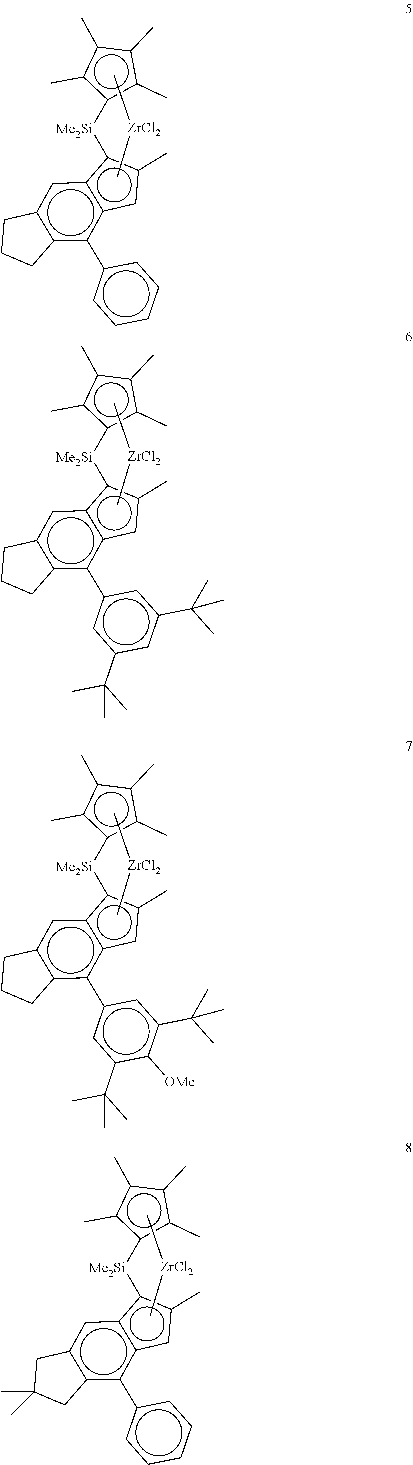

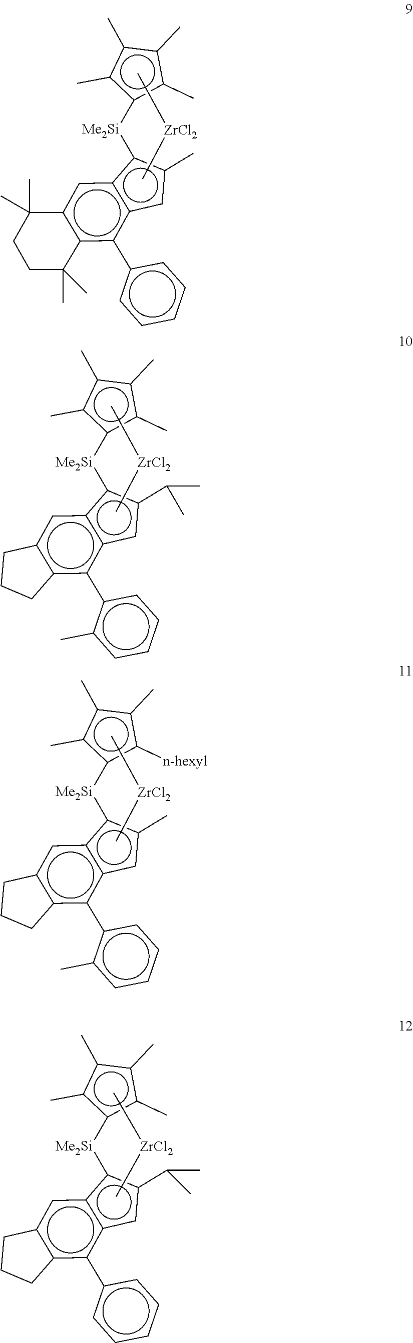

The catalyst systems described herein can be delivered to the reactor as a mineral oil slurry.

### Polymerization Processes

In some embodiments herein, the present disclosure relates to polymerization processes where a monomer (such as propylene), and, optionally, a comonomer (such as 1-octene, or 1,7-octadiene), are introduced to (or contacted with) a catalyst system described herein. The supported catalyst compound and activator may be combined prior to contacting with the monomer. Alternatively the catalyst compound and supported activator may be introduced into the polymerization reactor separately, wherein they subsequently react to form the active catalyst.

Monomers useful herein include substituted or unsubstituted C₂-C₄₀ alpha olefins, such as C₂-C₂₀ alpha olefins, such as C₂-C₁₂ alpha olefins, such as ethylene, propylene, butene, pentene, hexene, heptene, octene, nonene, decene, undecene, dodecene and isomers thereof. In at least one embodiment, the monomer includes ethylene and an optional comonomer including one or more C₃-C₄₀ olefins, such as C₄-C₂₀ olefins, such as C₆-C₁₂ olefins. The C₃-C₄₀ olefin monomers may be linear, branched, or cyclic. The C₃-C₄₀ cyclic olefins may be strained or unstrained, monocyclic or polycyclic, and may optionally include heteroatoms and/or one or more functional groups. In another embodiment, the monomer includes propylene and an optional comonomer including one or more ethylene or C₄-C₄₀ olefins, such as C₄-C₂₀ olefins, such as C₆-C₁₂ olefins. The C₄-C₄₀ olefins may be linear, branched, or cyclic. The C₄-C₄₀ cyclic olefins may be strained or unstrained, monocyclic or polycyclic, and may optionally include heteroatoms and/or one or more functional groups.

Exemplary C₂-C₄₀ olefin monomers and optional comonomers may include ethylene, propylene, butene, pentene, hexene, heptene, octene, nonene, decene, undecene, dodecene, norbornene, ethylidenenorbornene, vinylnorbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, such as hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, norbornadiene, butadiene, hexadiene, heptadiene, octadiene, nonadiene, decadiene, undecadiene, dodecadiene, and their respective homologs and derivatives, such as norbornene, norbornadiene, and dicyclopentadiene.

In at least one embodiment, one or more dienes are present in the polymer produced herein at up to 10 weight %, such as at 0.00001 to 1.0 weight %, such as 0.002 to 0.5 weight %, such as 0.003 to 0.2 weight %, based upon the total weight of the composition. In at least one embodiment 500 ppm or less of diene is added to the polymerization, such as 400 ppm or less, such as 300 ppm or less. In other embodiments at least 50 ppm of diene is added to the polymerization, or 100 ppm or more, or 150 ppm or more. Alternately, one or more dienes are present at 0.1 to 1 mol %, such as 0.5 mol %.

Suitable diolefin monomers useful in this present disclosure include any hydrocarbon structure, such as C₄-C₃₀, having at least two unsaturated bonds, wherein at least two of the unsaturated bonds are readily incorporated into a polymer by either a stereospecific or a non-stereospecific catalyst(s). The diolefin monomers can be an alpha, omega-diene monomer (e.g., a di-vinyl monomer). The diolefin monomers can be linear di-vinyl monomers, such as those containing from 4 to 30 carbon atoms. Examples of suitable dienes include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, and low molecular weight polybutadienes (Mw less than 1,000 g/mol). Suitable cyclic dienes include cyclopentadiene, vinylnorbornene, norbornadiene, ethylidene norbornene, divinylbenzene, dicyclopentadiene or higher ring containing diolefins with or without substituents at various ring positions.

Specific examples of alpha, omega-dienes (α,ω-dienes) include 1,4-heptadiene, 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, 2-methyl-1,6-heptadiene, 2-methyl-1,7-octadiene, 2-methyl-1,8-nonadiene, 2-methyl-1,9-decadiene, 2-methyl-1,10-undecadiene, 2-methyl-1,11-dodecadiene, 2-methyl-1,12-tridecadiene, and 2-methyl-1,13-tetradecadiene.

Preferred monomer combinations include: propylene and one or more of ethylene, 1-butene, 1-hexene, 1-octene, 1,7-octadiene, and vinylnorbornene; and propylene and diene (such as 1,7-octadiene, and vinylnorbornene.

Polymerization processes of this present disclosure can be carried out in any manner known in the art. Any suspension, bulk, slurry, or gas phase polymerization process known in the art can be used. Such processes can be run in a batch, semi-batch, or continuous mode. Homogeneous polymerization processes and slurry processes can be employed. (A homogeneous polymerization process refers to a process where at least 90 wt % of the product is soluble in the reaction media.) A homogeneous polymerization process can be a bulk homogeneous process. (A bulk process refers to a process where monomer concentration in all feeds to the reactor is 70 volume % or more.) Alternatively, no solvent or diluent is present or added in the reaction medium, (except for the small amounts used as the carrier for the catalyst system or other additives, or amounts typically found with the monomer; e.g., propane in propylene).

Any suspension, slurry, high pressure tubular or autoclave process, or gas phase polymerization process known in the art can be used under polymerizable conditions. Such processes can be run in a batch, semi-batch, or continuous mode. Heterogeneous polymerization processes (such as gas phase and slurry phase processes) are useful. A heterogeneous process is defined to be a process where the catalyst system is not soluble in the reaction media. Alternatively, in other embodiments, the polymerization process is not homogeneous.

In a class of embodiments, the polymerization is performed in the gas phase, preferably, in a fluidized bed gas phase process. Generally, in a fluidized bed gas phase process used for producing polymers, a gaseous stream containing one or more monomers is continuously cycled through a fluidized bed in the presence of a catalyst under reactive conditions. The gaseous stream is withdrawn from the fluidized bed and recycled back into the reactor. Simultaneously, polymer product is withdrawn from the reactor and fresh monomer is added to replace the polymerized monomer. (See, for example, U.S. Pat. Nos. 4,543,399; 4,588,790; 5,028,670; 5,317,036; 5,352,749; 5,405,922; 5,436,304; 5,453,471; 5,462,999; 5,616,661; and 5,668,228; all of which are fully incorporated herein by reference.

In another embodiment of the invention, the polymerization is performed in the slurry phase. As used herein a “slurry polymerization process” refers to a polymerization process where a supported catalyst is employed and monomers are polymerized on the supported catalyst particles. At least 95 wt % of polymer products derived from the supported catalyst are in granular form as solid particles (not dissolved in the diluent). A slurry polymerization process generally operates between 1 to about 50 atmosphere pressure range (15 psi to 735 psi, 103 kPa to 5,068 kPa) or even greater and temperatures as described above. In a slurry polymerization, a suspension of solid, particulate polymer is formed in a liquid polymerization diluent medium to which monomer and comonomers, along with catalysts, are added. The suspension including diluent is intermittently or continuously removed from the reactor where the volatile components are separated from the polymer and recycled, optionally after a distillation, to the reactor. The liquid diluent employed in the polymerization medium is typically an alkane having from 3 to 7 carbon atoms, preferably a branched alkane. The medium employed should be liquid under the conditions of polymerization and relatively inert. When a propane medium is used, the process is typically operated above the reaction diluent critical temperature and pressure. Often, a hexane or an isobutane medium is employed.

In an embodiment, a preferred polymerization technique useful in the invention is referred to as a particle form polymerization, or a slurry process where the temperature is kept below the temperature at which the polymer goes into solution. Such technique is known in the art, and described in for instance U.S. Pat. No. 3,248,179. A preferred temperature in the particle form process is within the range of about 85° C. to about 110° C. Two preferred polymerization methods for the slurry process are those employing a loop reactor and those utilizing a plurality of stirred reactors in series, parallel, or combinations thereof. Non-limiting examples of slurry processes include continuous loop or stirred tank processes. Also, other examples of slurry processes are described in U.S. Pat. No. 4,613,484, which is herein fully incorporated by reference.

In another embodiment, the slurry process is carried out continuously in a loop reactor. The catalyst, as a slurry in isobutane or as a dry free flowing powder, is injected regularly to the reactor loop, which is itself filled with circulating slurry of growing polymer particles in a diluent of isobutane containing monomer and comonomer. Hydrogen, optionally, may be added as a molecular weight control. In one embodiment 500 ppm or less of hydrogen is added, or 400 ppm or less or 300 ppm or less. In other embodiments at least 50 ppm of hydrogen is added, or 100 ppm or more, or 150 ppm or more.

Reaction heat is removed through the loop wall since much of the reactor is in the form of a double-jacketed pipe. The slurry is allowed to exit the reactor at regular intervals or continuously to a heated low pressure flash vessel, rotary dryer and a nitrogen purge column in sequence for removal of the isobutane diluent and all unreacted monomer and comonomers. The resulting hydrocarbon free powder is then compounded for use in various applications.

In a preferred embodiment, the catalyst system used in the polymerization comprises no more than two catalyst compounds. A “reaction zone” also referred to as a “polymerization zone” is a vessel where polymerization takes place, for example a batch reactor. When multiple reactors are used in either series or parallel configuration, each reactor is considered as a separate polymerization zone. For a multi-stage polymerization in both a batch reactor and a continuous reactor, each polymerization stage is considered as a separate polymerization zone. In a preferred embodiment, the polymerization occurs in one reaction zone.

Useful reactor types and/or processes for the production of polyolefin polymers include, but are not limited to, UNIPOL™ Gas Phase Reactors (available from Univation Technologies); INEOS™ Gas Phase Reactors and Processes; Continuous Flow Stirred-Tank (CSTR) reactors (solution and slurry); Plug Flow Tubular reactors (solution and slurry); Slurry: (e.g., Slurry Loop (single or double loops)) (available from Chevron Phillips Chemical Company) and (Series Reactors) (available from Mitsui Chemicals)); BORSTAR™ Process and Reactors (slurry combined with gas phase); Multi-Zone Circulating Reactors (MZCR) such as SPHERIZONE™ Reactors and Process available from Lyondell Basell; and SPHERIPOL™ process available from Lyondell Basell.

Suitable diluents/solvents for polymerization useful herein include non-coordinating, inert liquids. Examples include straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (Isopar™ fluids); perhalogenated hydrocarbons, such as perfluorinated C₄-C₁₀ alkanes, chlorobenzene, and aromatic and alkylsubstituted aromatic compounds, such as benzene, toluene, mesitylene, and xylene. Suitable solvents also include liquid olefins which may act as monomers or comonomers including ethylene, propylene, 1-butene, 1-hexene, 1-pentene, 3-methyl-1-pentene, 4-methyl-1-pentene, 1-octene, 1-decene, and mixtures thereof. In at least one embodiment, aliphatic hydrocarbon solvents are used as the solvent, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof. In another embodiment, the solvent is not aromatic, such as aromatics are present in the solvent at less than 1 wt %, such as less than 0.5 wt %, such as less than 0 wt % based upon the weight of the solvents.

In at least one embodiment, the feed concentration of the monomers and comonomers for the polymerization is 60 vol % solvent or less, such as 40 vol % or less, such as 20 vol % or less, based on the total volume of the feedstream. In at least one embodiment, the polymerization is run in a bulk process.

Suitable polymerizations can be run at any temperature and/or pressure suitable to obtain the desired ethylene polymers. Suitable temperatures and/or pressures may include a temperature in the range of from about 0° C. to about 300° C., such as about 20° C. to about 200° C., such as about 35° C. to about 150° C., such as from about 40° C. to about 120° C., such as from about 45° C. to about 80° C.; and at a pressure in the range of from about 0.35 MPa to about 10 MPa, such as from about 0.45 MPa to about 6 MPa, such as from about 0.5 MPa to about 4 MPa.

In a suitable polymerization, the run time of the reaction can be up to 300 minutes, such as in the range of from about 5 to 250 minutes, such as from about 10 to 120 minutes. In a continuous process the run time may be the average residence time of the reactor.

In at least one embodiment hydrogen is present in the polymerization reactor at a partial pressure of 0.001 to 50 psig (0.007 to 345 kPa), such as from 0.01 to 25 psig (0.07 to 172 kPa), such as 0.1 to 10 psig (0.7 to 70 kPa).

In some embodiments, the activity of the catalyst is at least 1,000 g/g/hour, such as 1,000 or more g/g/hour, such as 5,000 or more g/g/hour, such as 10,000 or more g/mmol/hr, such as 20,000 or more g/mmol/hr, such as 40,000 or more g/g/hr. In an alternative embodiment, the conversion of olefin monomer is at least 10%, based upon polymer yield and the weight of the monomer entering the reaction zone, such as 20% or more, such as 30% or more, such as 50% or more, such as 80% or more.

In at least one embodiment, little or no scavenger is used in the process to produce polymer. For example, scavenger (such as trialkyl aluminum) can be present at zero mol %, alternatively the scavenger can be present at a molar ratio of scavenger metal to transition metal of less than 100:1, such as less than 50:1, such as less than 15:1, such as less than 10:1.

In at least one embodiment, the polymerization medium preferably comprise less than 1 wt % (preferably less than 0.5 wt %, preferably less than 0.1 wt %, preferably less than 0.01 wt %, preferably less than 1 ppm, preferably 0 wt %) of aromatic compounds (such as toluene), based upon the weight of the polymerization medium.

In at least one embodiment, each feedstream to the polymerization reactor (e.g., monomer feedstream, supported catalyst feed stream, solvent feedstream, etc.) preferably comprise less than 1 wt % (preferably less than 0.5 wt %, preferably less than 0.1 wt %, preferably less than 0.01 wt %, preferably less than 1 ppm, preferably 0 wt %) of aromatic compounds (such as toluene), based upon the weight of the feedstream.

In at least one embodiment, the polymerization: 1) is conducted at temperatures of 0 to 300° C. (such as 25 to 150° C., such as 40 to 120° C., such as 60 to 70° C.); 2) is conducted at a pressure of atmospheric pressure to 10 MPa (such as 0.35 to 10 MPa, such as from 0.45 to 6 MPa, such as from 0.5 to 4 MPa); 3) is conducted in an aliphatic hydrocarbon solvent (such as propane, isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof; such as where aromatics can be present in the solvent at less than 1 wt %, such as less than 0.5 wt %, such as at 0 wt % based upon the weight of the solvents); 4) wherein the catalyst system used in the polymerization comprises less than 0.5 mol %, such as 0 mol % aromatic compound (such as aromatic solvent, such as toluene), 5) alternatively the alumoxane is present at a molar ratio of aluminum to transition metal less than 500:1, such as less than 300:1, such as less than 100:1, such as less than 1:1; 6) the polymerization occurs in one reaction zone; 7) the productivity of the catalyst compound is at least 1,000 g/g/hr (such as at least 5,000 g/g/hr, such as at least 10,000 g/g/hr, such as at least 20,000 g/g/hr, such as at least 40,000 g/g/hr); 8) optionally scavengers (such as trialkyl aluminum compounds) are absent (e.g. present at zero mol %, alternatively the scavenger is present at a molar ratio of scavenger metal to transition metal of less than 2000:1, such as less than 1000:1, such as less than 500:1, such as less than 250:1); and/or 9) optionally hydrogen is present in the polymerization reactor at a partial pressure of 0.001 to 50 psig (0.007 to 345 kPa) (such as from 0.01 to 25 psig (0.07 to 172 kPa), such as 0.1 to 10 psig (0.7 to 70 kPa)). In at least one embodiment, the catalyst system used in the polymerization comprises no more than one catalyst compound.

Other additives may also be used in the polymerization, as desired, such as one or more scavengers, promoters, modifiers, reducing agents, oxidizing agents, hydrogen, aluminum alkyls, silanes, or chain transfer agents (such as alkylalumoxanes, a compound represented by the formula AlR₃ or ZnR₂ (where each R is, independently, a C₁-C₈ aliphatic radical, such as methyl, ethyl, propyl, butyl, pentyl, hexyl octyl or an isomer thereof) or a combination thereof, such as diethyl zinc, methylalumoxane, trimethylaluminum, triisobutylaluminum, trioctylaluminum, or a combination thereof).

### Polyolefin Products

This present disclosure also relates to compositions of matter produced by the methods described herein. The process described herein can produce olefin homopolymers or olefin copolymers.

The process described herein can produce propylene homopolymers or propylene copolymers.

In at least one embodiment, the process described herein can produce propylene copolymers, such as propylene-diene copolymers.

Likewise, the process of this present disclosure can produce olefin polymers, such as polypropylene, such as propylene homopolymers and copolymers. In some embodiments, the polymers produced herein can be homopolymers of propylene or are copolymers of propylene having from about 0 wt % to about 50 wt % based on the total amount of polymer (such as from 1 wt % to 20 wt %) of one or more of C₂ or C₄ to C₂₀ olefin comonomer, based on a total amount of propylene copolymer, such as from about 0.5 wt % to about 18 wt %, such as from about 1 wt % to about 15 wt %, such as from about 3 wt % to about 10 wt %) of one or more of C₂ or C₄ to C₂₀ olefin comonomer (such as ethylene or C₄ to C₁₂ alpha-olefin, such as ethylene, butene, hexene, octene, decene, dodecene, such as ethylene, butene, hexene, octene, or C₄-C₁₄ α,ω-dienes such as butadiene, 1,5-hexadiene, 1,4-heptadiene, 1,6-heptadiene, 1,7-octadiene, 1,8-nonadiene, 1,9-decadiene, 1,10-undecadiene, 1,11-dodecadiene, 1,12-tridecadiene, 1,13-tetradecadiene).

In some embodiments, the polymer can have from about 50 wt % to about 100 wt % of propylene, such as from about 90 wt % to about 99.9 wt % of propylene, such as from about 90 wt % to about 99 wt % of propylene, such as from about 98 wt % to about 99 wt % of propylene.

In some embodiments, the polymer can have from about 90 wt % to about 99.9 wt % of propylene and 0.1 to 10 wt % diene, such as from about 95 wt % to about 99.5 wt % of propylene and 0.5 to 5 wt % diene, such as from about 99 wt % to about 99.5 wt % of propylene and 0.5 to 1 wt % diene.

The homopolymers produced herein preferably comprise less than 1 wt % (preferably less than 0.5 wt %, preferably less than 0.1 wt %, preferably less than 0.01 wt %, preferably less than 1 ppm, preferably 0 wt %) of aromatic compounds (such as toluene), based upon the weight of the homopolymer.

The copolymers produced herein preferably comprise less than 1 wt % (preferably less than 0.5 wt %, preferably less than 0.1 wt %, preferably less than 0.01 wt %, preferably less than 1 ppm, preferably 0 wt %) of aromatic compounds (such as toluene), based upon the weight of the copolymer.

In some embodiments, the polymers produced herein can have an Mw of from about 5,000 to about 1,000,000 g/mol (such as from about 25,000 to about 750,000 g/mol, such as from about 50,000 to about 500,000 g/mol, such as from about 80,000 to about 300,000 g/mol, such as from about 80,000 to about 200,000 g/mol) as determined by GPC-4D.

In some embodiments, the polymer can have a molecular weight distribution, MWD, (Mw/Mn) of greater than about 1, such as from about 1 to about 40, such as from about 1.5 to about 20, such as from about 2 to about 10 as determined by GPC-4D.

In some embodiments, the polymer can have a g′ᵥᵢₛ of 5.0 or more, such as greater than about 0.5, such as from about 0.5 to about 1, such as from 0.5 to 0.97, such as from about 0.51 to about 0.98, such as from about 0.6 to about 0.95, such as from about 0.7 to about 0.8 as determined by GPC-4D.

In some embodiments, the polymer can have a melt flow rate (MFR) of from about 0.1 dg/min to about 1,000 dg/min, such as from about 1 dg/min to about 100 dg/min, such as from about 5 to about 10 dg/min as determined by ASTM D1238 (230° C., 2.16 kg).

In some embodiments, the polymer can have a Tₘ of greater than about 145° C., such as from about 150° C. to about 165° C., such as from about 155° C. to about 162° C., such as from about 158° C. to about 160° C. as determined by the differential scanning calorimetry procedure described below. In some embodiments, the polymer can have a Tₘ of from 148° C. to 159° C. For purposes of the claims, Tₘ is measured by the differential scanning calorimetry procedure described below.

In at least one embodiment, the polymer produced herein can have a unimodal or multimodal molecular weight distribution as determined by Gel Permeation Chromotography (GPC). By “unimodal” is meant that the GPC trace has one peak or inflection point. By “multimodal” is meant that the GPC trace has at least two peaks or inflection points. An inflection point is that point where the second derivative of the curve changes in sign (e.g., from negative to positive or vice versa).

In some embodiments, the polymers produced herein can have:
a) an Mw of from about 5,000 to about 1,000,000 g/mol (such as from about 25,000 to about 750,000 g/mol, such as from about 50,000 to about 500,000 g/mol, such as from about 80,000 to about 300,000 g/mol, such as from about 80,000 to about 200,000 g/mol) as determined by GPC-4D;
b) a molecular weight distribution, MWD, (Mw/Mn) of greater than about 1, such as from about 1 to about 40, such as from about 1.5 to about 20, such as from about 2 to about 10 as determined by GPC-4D;
c) a g′ᵥᵢₛ of 5.0 or more, such as greater than about 0.5, such as from about 0.5 to about 1, such as from 0.5 to 0.97, such as from about 0.51 to about 0.98, such as from about 0.6 to about 0.95, such as from about 0.7 to about 0.8 as determined by GPC-4D;
d) a melt flow rate (MFR) of from about 0.1 dg/min to about 1,000 dg/min, such as from about 1 dg/min to about 100 dg/min, such as from about 5 to about 10 dg/min as determined by ASTM D1238 (230° C., 2.16 kg); and/or
e) a Tₘ of greater than about 145° C., such as from about 150° C. to about 165° C., such as from about 155° C. to about 162° C., such as from about 158° C. to about 160° C. as determined by the differential scanning calorimetry procedure described below. In some embodiments, the polymer can have a Tₘ of from 148° C. to 159° C.

In some embodiments, the polymers produced can be isotactic polypropylene, atactic polypropylene and random, block or impact copolymers.

The propylene homopolymer or propylene copolymer produced herein may have some level of isotacticity, and can be isotactic or highly isotactic. As used herein, “isotactic” is defined as having at least 10% isotactic pentads according to analysis by ¹³C NMR as described in US 2008/0045638 at paragraph [0613] et seq. As used herein, “highly isotactic” is defined as having at least 60% isotactic pentads according to analysis by ¹³C NMR. In at least one embodiment, a propylene homopolymer having at least about 85% isotacticity, such as at least about 90% isotacticity can be produced herein. In another embodiment, the propylene polymer produced can be atactic. Atactic polypropylene is defined to be less than 10% isotactic or syndiotactic pentads according to analysis by ¹³C NMR.

### GPC 4-D

Unless otherwise indicated, the distribution and the moments of molecular weight (Mw, Mn, Mz, Mw/Mn, etc.), the comonomer content, and the branching index (g′) are determined by using a high temperature Gel Permeation Chromatography (Polymer Char GPC-IR) equipped with a multiple-channel band-filter based Infrared detector IR5 with a multiple-channel band filter based infrared detector ensemble IR5 with band region covering from about 2,700 cm⁻¹ to about 3,000 cm⁻¹ (representing saturated C—H stretching vibration), an 18-angle light scattering detector and a viscometer. Three Agilent PLgel 10-μm Mixed-B LS columns are used to provide polymer separation. Reagent grade 1,2,4-trichlorobenzene (TCB) (from Sigma-Aldrich) comprising ˜300 ppm antioxidant BHT can be used as the mobile phase at a nominal flow rate of ˜1.0 mL/min and a nominal injection volume of ˜200 μL. The whole system including transfer lines, columns, and detectors can be contained in an oven maintained at ˜145° C. A given amount of sample can be weighed and sealed in a standard vial with ˜10 μL flow marker (heptane) added thereto. After loading the vial in the auto-sampler, the oligomer or polymer may automatically be dissolved in the instrument with ˜8 mL added TCB solvent at ˜160° C. with continuous shaking. The sample solution concentration can be from ˜0.2 to ˜2.0 mg/ml, with lower concentrations used for higher molecular weight samples. The concentration, c, at each point in the chromatogram can be calculated from the baseline-subtracted IR5 broadband signal, I, using the equation: c=αI, where α is the mass constant determined with polyethylene or polypropylene standards. The mass recovery can be calculated from the ratio of the integrated area of the concentration chromatography over elution volume and the injection mass which is equal to the pre-determined concentration multiplied by injection loop volume. The conventional molecular weight (IR MW) is determined by combining universal calibration relationship with the column calibration which is performed with a series of monodispersed polystyrene (PS) standards ranging from 700 to 10 M gm/mole. The MW at each elution volume is calculated with following equation:

$$log M = \frac{log ( {K}_{PS} / K )}{α + 1} + \frac{{α}_{PS + 1}}{α + 1} log {M}_{P S}$$

where the variables with subscript “PS” stand for polystyrene while those without a subscript are for the test samples. In this method, α_{PS}=0.67 and K_{PS}=0.000175, α and K for other materials are as calculated as described in the published in literature (e.g., Sun, T. et al. (2001) Macromolecules, v. 34, pg. 6812), except that for purposes of this present disclosure and claims thereto, α=0.705 and K=0.0000229 for ethylene-propylene copolymers and ethylene-propylene-diene terpolymers, α=0.695 and K=0.000579 for linear ethylene polymers, α=0.705 and K=0.0002288 for linear propylene polymers, and α=0.695 and K=0.000181 for linear butene polymers. Concentrations are expressed in g/cm³, molecular weight is expressed in g/mole, and intrinsic viscosity (hence K in the Mark-Houwink equation) is expressed in dL/g unless otherwise noted.

The comonomer composition is determined by the ratio of the IR5 detector intensity corresponding to CH₂ and CH₃ channel calibrated with a series of PE and PP homo/copolymer standards whose nominal value are predetermined by NMR or FTIR. In particular, this provides the methyls per 1,000 total carbons (CH₃/1000TC) as a function of molecular weight. The short-chain branch (SCB) content per 1,000TC (SCB/1000TC) is then computed as a function of molecular weight by applying a chain-end correction to the CH₃/1000TC function, assuming each chain to be linear and terminated by a methyl group at each end. The weight % comonomer is then obtained from the following expression in which f is 0.3, 0.4, 0.6, 0.8, and so on for C₃, C₄, C₆, C₈, and so on co-monomers, respectively:

w2=f*SCB/1000TC.

The bulk composition of the polymer from the GPC-IR and GPC-4D analyses is obtained by considering the entire signals of the CH₃ and CH₂ channels between the integration limits of the concentration chromatogram. First, the following ratio is obtained

$$Bulk IR ratio = \frac{Area of {CH}_{3} signal within integration limits}{Area of {CH}_{2} signal within integration limits} .$$

Then the same calibration of the CH₃ and CH₂ signal ratio, as mentioned previously in obtaining the CH3/1000TC as a function of molecular weight, is applied to obtain the bulk CH3/1000TC. A bulk methyl chain ends per 1,000TC (bulk CH3end/1000TC) is obtained by weight-averaging the chain-end correction over the molecular-weight range. Then

w2b=f*bulk CH3/1000TC

bulk SCB/1000TC=bulk CH3/1000TC−bulk CH3end/1000TC

and bulk SCB/1000TC is converted to bulk w2 in the same manner as described above.

The LS detector is the 18-angle Wyatt Technology High Temperature DAWN HELEOSII. The LS molecular weight (M) at each point in the chromatogram is determined by analyzing the LS output using the Zimm model for static light scattering (Light Scattering from Polymer Solutions; Huglin, M. B., Ed.; Academic Press, 1972):

$$\frac{{K}_{o} c}{Δ R ( θ )} = \frac{1}{MP ( θ )} + 2 {A}_{2} c .$$

Here, ΔR(θ) is the measured excess Rayleigh scattering intensity at scattering angle θ, c is the polymer concentration determined from the IR5 analysis, A₂ is the second virial coefficient, P(θ) is the form factor for a monodisperse random coil, and K_{O} is the optical constant for the system:

$${K}_{o} = \frac{4 {π}^{2} {{n}^{2} ( dn / dc )}^{2}}{{λ}^{4} {N}_{A}}$$

where N_{A} is Avogadro's number, and (dn/dc) is the refractive index increment for the system. The refractive index, n=1.500 for TCB at 145° C. and λ=665 nm. For analyzing polyethylene homopolymers, ethylene-hexene copolymers, and ethylene-octene copolymers, dn/dc=0.1048 ml/mg and A₂=0.0015; for analyzing ethylene-butene copolymers, dn/dc=0.1048*(1−0.00126*w2) ml/mg and A₂=0.0015 where w2 is weight percent butene comonomer.

A high temperature Agilent (or Viscotek Corporation) viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, η_{S}, for the solution flowing through the viscometer is calculated from their outputs. The intrinsic viscosity, [η], at each point in the chromatogram is calculated from the equation [η]=η_{S}/c, where c is concentration and is determined from the IR5 broadband channel output. The viscosity MW at each point is calculated as M=K_{PS}M^{α}^{_{PS}}⁺¹/[η], where αₚₛ is 0.67 and Kₚₛ is 0.000175.

The branching index (g′ᵥᵢₛ) is calculated using the output of the GPC-IR5-LS-VIS method as follows. The average intrinsic viscosity, [η]_{avg}, of the sample is calculated by:

$${[ η ]}_{a v g} = \frac{\sum {{c}_{i} [ η ]}_{i}}{\sum {c}_{i}}$$

where the summations are over the chromatographic slices, i, between the integration limits. The branching index g′ᵥᵢₛ is defined as:

$${g}_{vis}^{′} = \frac{{[ η ]}_{avg}}{K {M}_{v}^{α}} ,$$

where M_{V} is the viscosity-average molecular weight based on molecular weights determined by LS analysis and the K and α are for the reference linear polymer, which are, for purposes of this present disclosure and claims thereto, α=0.705 and K=0.0000229 for ethylene-propylene copolymers and ethylene-propylene-diene terpolymers, α=0.695 and K=0.000579 for linear ethylene polymers, α=0.705 and K=0.0002288 for linear propylene polymers, α=0.695 and K=0.000181 for linear butene polymers. Concentrations are expressed in g/cm³, molecular weight is expressed in g/mole, and intrinsic viscosity (hence K in the Mark-Houwink equation) is expressed in dL/g unless otherwise noted. Calculation of the w2b values is as discussed above.

Any of the foregoing polymers and compositions may be used in a variety of end-use applications such as fibers, non-wovens, films, film-based products, diaper backsheets, housewrap, wire and cable coating compositions, articles formed by molding techniques, e.g., injection or blow molding, extrusion coating, foaming, casting, and combinations thereof. End uses also include products made from films, e.g., bags, packaging, and personal care films, pouches, medical products, such as for example, medical films and intravenous (IV) bags.

Specifically, any of the foregoing polymers, such as the foregoing polypropylenes or blends thereof, may be used in mono- or multi-layer blown, cast, extruded, and/or shrink films. These films may be formed by any number of well-known extrusion or coextrusion techniques, such as a blown bubble film processing technique, wherein the composition can be extruded in a molten state through an annular die and then expanded to form a uni-axial or biaxial orientation melt prior to being cooled to form a tubular, blown film, which can then be axially slit and unfolded to form a flat film. Films may be subsequently unoriented, uniaxially oriented, or biaxially oriented to the same or different extents. One or more of the layers of the film may be oriented in the transverse and/or longitudinal directions to the same or different extents. The uniaxially orientation can be accomplished using typical cold drawing or hot drawing methods. Biaxial orientation can be accomplished using tenter frame equipment or a double bubble processes and may occur before or after the individual layers are brought together. For example, a polyethylene layer can be extrusion coated or laminated onto an oriented polypropylene layer or the polyethylene and polypropylene can be coextruded together into a film then oriented. Likewise, oriented polypropylene could be laminated to oriented polyethylene or oriented polyethylene could be coated onto polypropylene then optionally the combination could be oriented even further. Typically the films are oriented in the Machine Direction (MD) at a ratio of up to 15, such as between 5 and 7, and in the Transverse Direction (TD) at a ratio of up to 15, such as 7 to 9. However, in another embodiment the film is oriented to the same extent in both the MD and TD directions.

The films may vary in thickness depending on the intended application; however, films of a thickness from 1 to 50 μm are usually suitable. Films intended for packaging are usually from 10 to 50 μm thick. The thickness of the sealing layer is typically 0.2 to 50 μm. There may be a sealing layer on both the inner and outer surfaces of the film or the sealing layer may be present on only the inner or the outer surface.

In another embodiment, one or more layers may be modified by corona treatment, electron beam irradiation, gamma irradiation, flame treatment, or microwave. In at least one embodiment, one or both of the surface layers is modified by corona treatment.

The polymers produced herein may be used in the formation of fibers and nonwoven fabrics (such as spun-bond or melt blown). Typically non-woven fabrics require the manufacture of fibers by extrusion followed by consolidation or bonding. The extrusion process is typically accompanied by mechanical or aerodynamic drawing of the fibers. The polymers of the present invention may be used to manufacture fibers or non-woven fabrics by any technique known in the art. Such methods and equipment are well known. For example, spunbond nonwoven fabrics may be produced by spunbond nonwoven production lines produced by Reifenhauser GmbH & Co., of Troisdorf, Germany. This utilizes a slot drawing technique as described in U.S. Pat. No. 4,820,142, EP 1340843 A1 or U.S. Pat. No. 6,918,750. Additional useful methods include those disclosed in US 2012/0116338 A1 and US 2010/0233928 A1.

The polymers produced herein may be used in foam applications. The polypropylene compositions produced herein may be combined with a foaming agent as is known in the art to effect the formation of air containing pockets or cells within the composition. In any embodiment is disclosed the reaction product of the foaming agent and polypropylene composition produced herein. This reaction product may be formed into any number of suitable foamed articles such as cups, plates, other food containing items, and food storage boxes, toys, handle grips, and other articles of manufacture.

### Embodiments Listing

The present disclosure provides, among others, the following embodiments, each of which may be considered as optionally including any alternate embodiments.

This invention further relates to:

1. A supported catalyst composition comprising aromatic-solvent-free support and catalyst compound represented by the Formula (I):

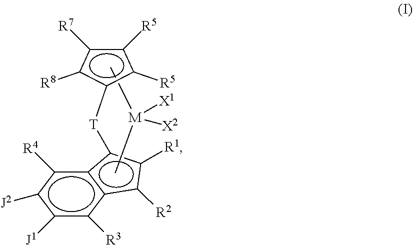

wherein:
M is a Group 4 metal, preferably Zr or Hf;
T is a bridging group;
each of X¹ and X² is a univalent anionic ligand, or X¹ and X² are joined to form a metallocycle ring;
R¹ is hydrogen, a halogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or
—R″—SiR′₃, where R″ is C₁-C₁₀ alkyl and each R′ is hydrogen, halogen, C₁-C₁₀ alkyl, or C₆-C₁₀ aryl;
R³ is an unsubstituted C₄-C₆₂ cycloalkyl, a substituted C₄-C₆₂ cycloalkyl, an unsubstituted C₄-C₆₂ aryl, a substituted C₄-C₆₂ aryl, an unsubstituted C₄-C₆₂ heteroaryl, or a substituted C₄-C₆₂ heteroaryl;
each of R² and R⁴ is independently hydrogen, a halogen, an unsubstituted C₁-C₄₀ hydrocarbyl, a C₁-C₄₀ substituted hydrocarbyl, an unsubstituted C₄-C₆₂ aryl, a substituted
C₄-C₆₂ aryl, an unsubstituted C₄-C₆₂ heteroaryl, a substituted C₄-C₆₂ heteroaryl, —NR′₂, —SR′,
—OR, —SiR′₃, —OSiR′₃, —PR′₂, or —R″—SiR′₃, wherein R″ is C₁-C₁₀ alkyl and each R′ is hydrogen, halogen, C₁-C₁₀ alkyl, or C₆-C₁₀ aryl;
each of R⁵, R⁶, R⁷, and R⁸ is independently hydrogen, a halogen, an unsubstituted
C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl,
—NR′₂, —SR′, —OR, —SiR′₃, —OSiR′₃, —PR′₂, or —R″—SiR′₃, wherein R″ is C₁-C₁₀ alkyl and each R′ is hydrogen, halogen, C₁-C₁₀ alkyl, or C₆-C₁₀ aryl, or one or more of R⁵ and R⁶, R⁶ and R⁷, or R⁷ and R⁸ can be joined to form a substituted or unsubstituted C₄-C₆₂ saturated or unsaturated cyclic or polycyclic ring structure, or a combination thereof, where optionally R⁶ and R⁷ do not combine to form a six membered aromatic ring; and
J¹ and J² are joined to form a substituted or unsubstituted C₄-C₆₂ saturated or unsaturated cyclic or polycyclic ring structure, or a combination thereof, provided that J¹ and J² together with the two carbons they are bound to on the indenyl group form at least one saturated ring; wherein the supported catalyst composition preferably comprises less than 1 wt % (preferably less than 0.5 wt %, preferably less than 0.1 wt %, preferably less than 0.01 wt %, preferably less than 1 ppm, preferably 0 wt %) of aromatic compounds, based upon the weight of the support.
   2. The supported catalyst composition of paragraph 1, wherein the supported catalyst composition preferably comprises less than 1 wt % (preferably less than 0.5 wt %, preferably less than 0.1 wt %, preferably less than 0.01 wt %, preferably less than 1 ppm, preferably 0 wt %) of toluene, based upon the weight of the support.
   3. The supported catalyst composition of paragraph 1 or 2, wherein T is represented by the formula:

(R*₂G)_{g},

wherein each G is C, Si, or Ge, g is 1 or 2, and each R* is, independently, hydrogen, halogen, C₁-C₂₀ unsubstituted hydrocarbyl, a C₁-C₂₀ substituted hydrocarbyl, or the two or more R* may join to form a substituted or unsubstituted, saturated, partially unsaturated or aromatic, cyclic or polycyclic substituent.
4. The supported catalyst composition of any one of paragraphs 1 to 3, wherein T is selected from the group consisting of CH₂, CH₂CH₂, C(CH₃)₂, (Ph)₂C, (p-(Et)₃SiPh)₂C, SiMe₂, SiPh₂, SiMePh, Si(CH₂)₃, Si(CH₂)₄, and Si(CH₂)₄.
5. The supported catalyst composition of any one of paragraphs 1 to 4, wherein each of X¹ and X² is independently a halide or a C₁-C₅ hydrocarbyl.
6. The supported catalyst composition of any one of paragraphs 1 to 5, wherein each of R⁵, R⁶, R⁷, and R⁸ is independently an unsubstituted C₁-C₂₀ hydrocarbyl or a C₁-C₂₀ substituted hydrocarbyl.
7. The supported catalyst composition of any one of paragraphs 1 to 6, wherein each of R⁵, R⁶, R⁷, and R⁸ is independently an unsubstituted C₁-C₆ hydrocarbyl or a substituted C₁-C₆ hydrocarbyl.
8. The supported catalyst composition of any one of paragraphs 1 to 7, wherein R¹ is hydrogen, a substituted C₁-C₂₀ hydrocarbyl, or an unsubstituted C₁-C₂₀ hydrocarbyl.
9. The supported catalyst composition of any one of paragraphs 1 to 8, wherein R¹ is hydrogen, a substituted C₁-C₆ hydrocarbyl, or an unsubstituted C₁-C₆ hydrocarbyl.
10. The supported catalyst composition of any one of paragraphs 1 to 9, wherein each of R² and R⁴ is independently hydrogen, a substituted C₁-C₂₀ (alternately C₁ to C₆) hydrocarbyl, or an unsubstituted C₁-C₂₀ (alternately C₁ to C₆) hydrocarbyl.
11. The supported catalyst composition of any one of paragraphs 1 to 10, wherein R³ is represented by the formula:

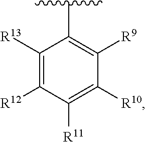

wherein each of R⁹, R¹⁰, R¹¹, R¹², and R¹³ is independently hydrogen, C₁-C₄₀ hydrocarbyl or C₁-C₄₀ substituted hydrocarbyl, a heteroatom or a heteroatom-containing group, or two or more of R⁹, R¹⁰, R¹¹, R¹², and R¹³ are joined together to form a C₄-C₂₀ cyclic or polycyclic ring structure.
12. The supported catalyst composition of paragraph 11, wherein each of R⁹, R¹⁰, R¹¹, R¹², and R¹³ is independently hydrogen, halogen, —NR′₂, —SR′, —OR, —SiR′₃, —OSiR′₃, —PR′₂, or —R″—SiR′₃, where R″ is C₁-C₁₀ alkyl and each R′ is hydrogen, halogen, C₁-C₁₀ alkyl, or C₆-C₁₀ aryl.
13. The supported catalyst composition of paragraph 11, wherein each of R⁹, R¹⁰, R¹¹, R¹², and R¹³ is independently hydrogen, a substituted C₁-C₆ hydrocarbyl, an unsubstituted C₁-C₆ hydrocarbyl, or a phenyl.
14. The supported catalyst composition of any one of paragraphs 1 to 13, wherein J¹ and J² are joined to form an unsubstituted C₄-C₂₀ cyclic or polycyclic ring or a substituted C₄-C₂₀ cyclic or polycyclic ring, provided that J¹ and J² together with the two carbons they are bound to on the indenyl group form at least one 5 membered saturated ring.
15. The supported catalyst composition of any one of paragraphs 1 to 13, wherein J¹ and J² are joined to form an unsubstituted C₄-C₂₀ cyclic or polycyclic ring or a substituted C₄-C₂₀ cyclic or polycyclic ring, provided that J¹ and J² together with the two carbons they are bound to on the indenyl group form at least one 6 membered saturated ring.
16. The supported catalyst composition of paragraph 1, wherein the catalyst compound is selected from the group consisting of:

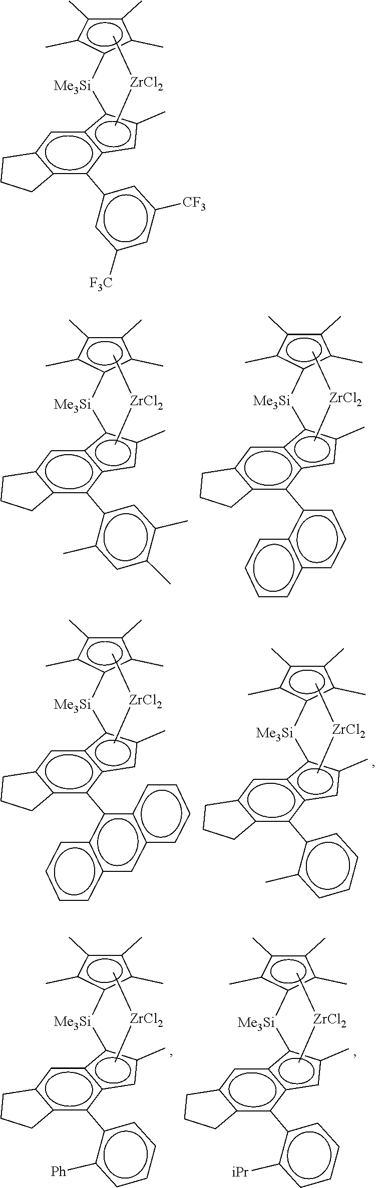

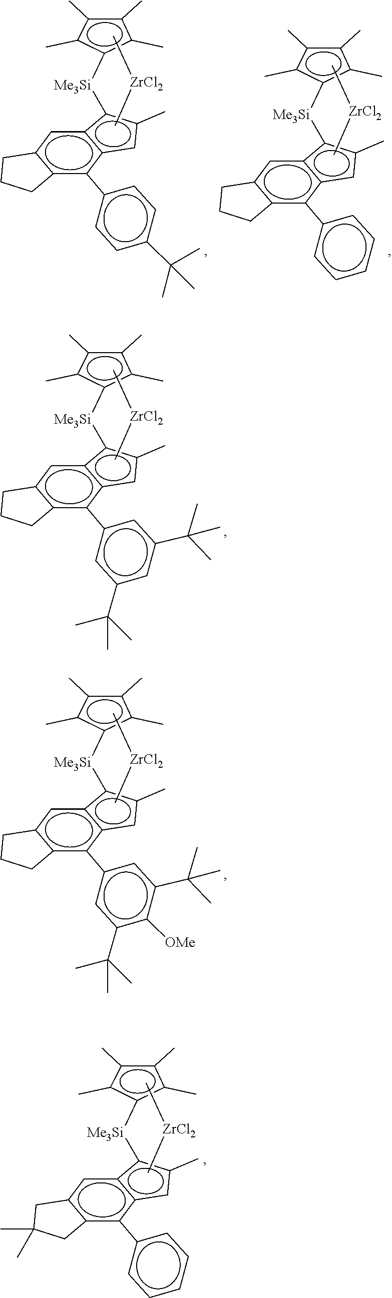

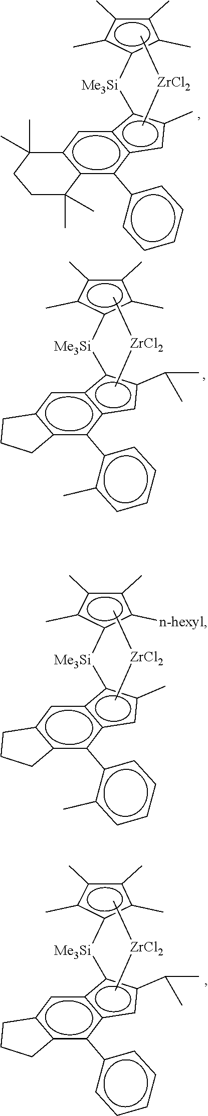

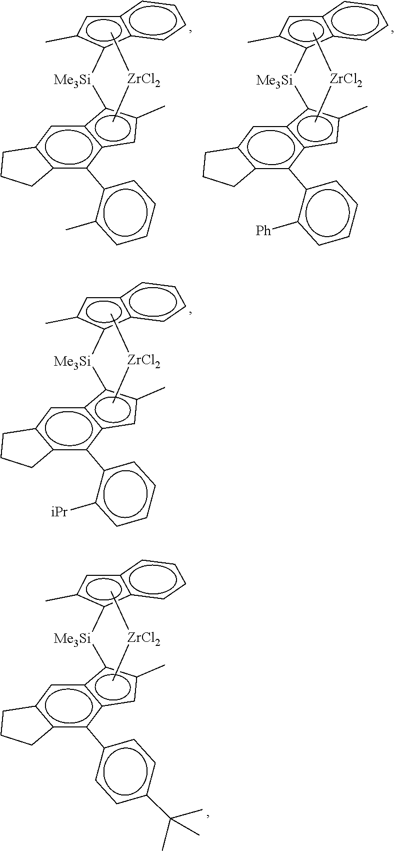

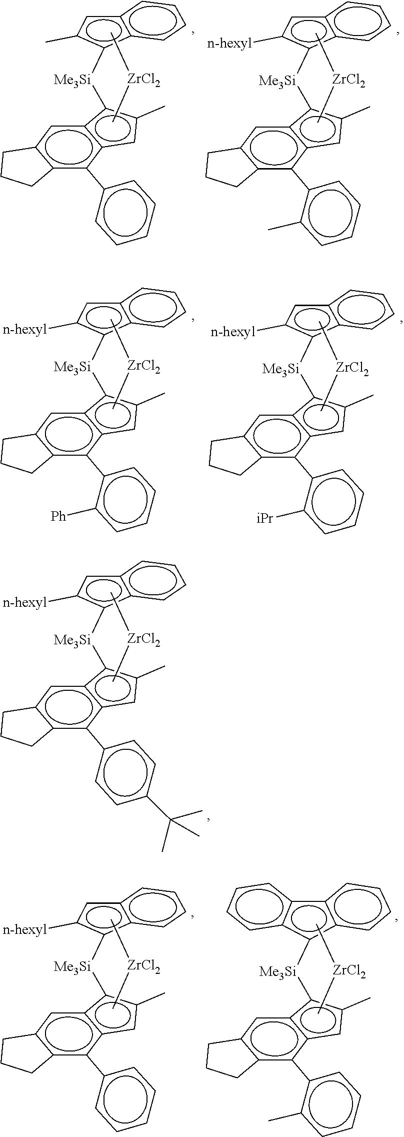

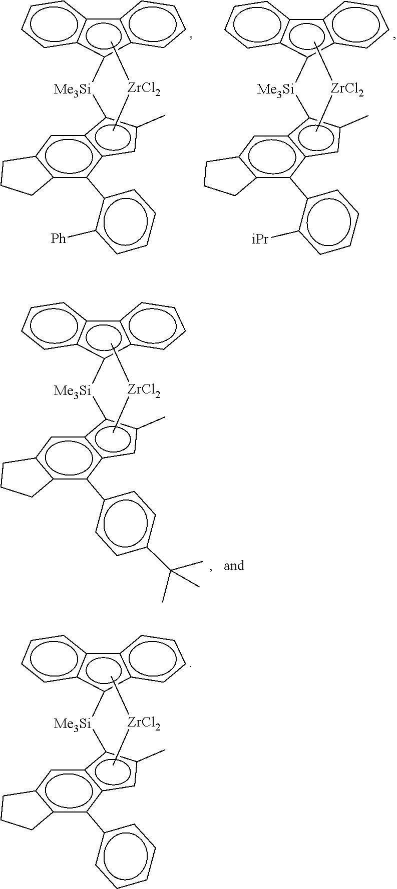

17. The supported catalyst composition of paragraph 1, wherein the catalyst compound is represented by Formula (III):

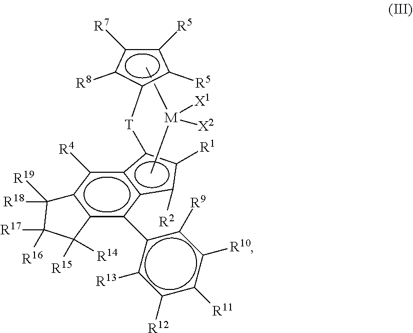

wherein:
M is a Group 4 metal;
T is a bridging group;
each of X¹ and X² is a univalent anionic ligand, or X¹ and X² are joined to form a metallocycle ring;
R¹ is hydrogen, a halogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or
—R″—SiR′₃, where R″ is C₁-C₁₀ alkyl and each R′ is hydrogen, halogen, C₁-C₁₀ alkyl, or C₆-C₁₀ aryl;
each of R² and R⁴ is independently hydrogen, a halogen, an unsubstituted C₁-C₄₀ hydrocarbyl, a C₁-C₄₀ substituted hydrocarbyl, an unsubstituted C₄-C₆₂ aryl, a substituted
C₄-C₆₂ aryl, an unsubstituted C₄-C₆₂ heteroaryl, a substituted C₄-C₆₂ heteroaryl, —NR′₂, —SR′,
—OR, —SiR′₃, —OSiR′₃, —PR′₂, or —R″—SiR′₃, wherein R″ is C₁-C₁₀ alkyl and each R′ is hydrogen, halogen, C₁-C₁₀ alkyl, or C₆-C₁₀ aryl;
each of R⁵, R⁶, R⁷, and R⁸ is independently hydrogen, a halogen, an unsubstituted
C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl,
—NR′₂, —SR′, —OR, —SiR′₃, —OSiR′₃, —PR′₂, or —R″—SiR′₃, wherein R″ is C₁-C₁₀ alkyl and each R′ is hydrogen, halogen, C₁-C₁₀ alkyl, or C₆-C₁₀ aryl, or one or more of R⁵ and R⁶, R⁶ and R⁷, or R⁷ and R⁸ are joined to form a substituted or unsubstituted C₄-C₆₂ saturated or unsaturated cyclic or polycyclic ring structure, or a combination thereof, where optionally R⁶ and R⁷ do not combine to form a six membered aromatic ring;
each of R⁹, R¹⁰, R¹¹, R¹², and R¹³ is independently hydrogen, C₁-C₄₀ hydrocarbyl or
C₁-C₄₀ substituted hydrocarbyl, a heteroatom or a heteroatom-containing group, or two or more of R⁹, R¹⁰, R¹¹, R¹², and R¹³ are joined together to form a C₄-C₂₀ cyclic or polycyclic ring structure; and
each of R¹⁴, R¹⁵, R¹⁶, R¹⁷, R¹⁸, and R¹⁹ is independently hydrogen, a halogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, wherein R″ is C₁-C₁₀ alkyl and each R′ is hydrogen, halogen, C₁-C₁₀ alkyl, or C₆-C₁₀ aryl, or two or more of R¹⁴, R¹⁵, R¹⁶, R¹⁷, R¹⁸, and R¹⁹ are joined together to form cyclic or polycyclic ring structure, or a combination thereof.
   18. The supported catalyst composition of paragraph 1, wherein the catalyst compound is represented by Formula (IV):

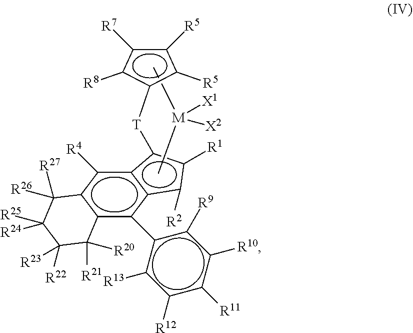

wherein:
M is a Group 4 metal;
T is a bridging group;
each of X¹ and X² is a univalent anionic ligand, or X¹ and X² are joined to form a metallocycle ring;
R¹ is hydrogen, a halogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or
—R″—SiR′₃, where R″ is C₁-C₁₀ alkyl and each R′ is hydrogen, halogen, C₁-C₁₀ alkyl, or C₆-C₁₀ aryl;
each of R² and R⁴ is independently hydrogen, a halogen, an unsubstituted C₁-C₄₀ hydrocarbyl, a C₁-C₄₀ substituted hydrocarbyl, an unsubstituted C₄-C₆₂ aryl, a substituted
C₄-C₆₂ aryl, an unsubstituted C₄-C₆₂ heteroaryl, a substituted C₄-C₆₂ heteroaryl, —NR′₂, —SR′,
—OR, —SiR′₃, —OSiR′₃, —PR′₂, or —R″—SiR′₃, wherein R″ is C₁-C₁₀ alkyl and each R′ is hydrogen, halogen, C₁-C₁₀ alkyl, or C₆-C₁₀ aryl;
each of R⁵, R⁶, R⁷, and R⁸ is independently hydrogen, a halogen, an unsubstituted
C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl,
—NR′₂, —SR′, —OR, —SiR′₃, —OSiR′₃, —PR′₂, or —R″—SiR′₃, wherein R″ is C₁-C₁₀ alkyl and each R′ is hydrogen, halogen, C₁-C₁₀ alkyl, or C₆-C₁₀ aryl, or one or more of R⁵ and R⁶, R⁶ and R⁷, or R⁷ and R⁸ can be joined to form a substituted or unsubstituted C₄-C₆₂ saturated or unsaturated cyclic or polycyclic ring structure, or a combination thereof, where optionally R⁶ and R⁷ do not combine to form a six membered aromatic ring;
each of R⁹, R¹⁰, R¹¹, R¹², and R¹³ is independently hydrogen, C₁-C₄₀ hydrocarbyl or
C₁-C₄₀ substituted hydrocarbyl, a heteroatom or a heteroatom-containing group, or two or more of R⁹, R¹⁰, R¹¹, R¹², and R¹³ are joined together to form a C₄-C₂₀ cyclic or polycyclic ring structure; and
each of R², R²¹, R²², R²³, R²⁴, R⁵, R⁶, R²⁷ is independently hydrogen, a halogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, wherein R″ is C₁-C₁₀ alkyl and each R′ is hydrogen, halogen, C₁-C₁₀ alkyl, or C₆-C₁₀ aryl, or two or more of R²⁰, R²¹, R²², R²³, R²⁴, R²⁵, R²⁶, R²⁷ are joined together to form cyclic or polycyclic ring structure, or a combination thereof.
   19. The supported catalyst composition of paragraphs 17 or 18, wherein T is represented by the formula:

(R*₂G)_{g},

wherein each G is C, Si, or Ge, g is 1 or 2, and each R* is, independently, hydrogen, halogen, C₁-C₂₀ unsubstituted hydrocarbyl, a C₁-C₂₀ substituted hydrocarbyl, or the two or more R* may join to form a substituted or unsubstituted, saturated, partially unsaturated or aromatic, cyclic or polycyclic substituent.
20. The supported catalyst composition of any one of paragraphs 17 to 19, wherein T is selected from the group consisting of CH₂, CH₂CH₂, C(CH₃)₂, (Ph)₂C, (p-(Et)₃SiPh)₂C, SiMe₂, SiPh₂, SiMePh, Si(CH₂)₃, Si(CH₂)₄, and Si(CH₂)₄.
21. The supported catalyst composition of any one of paragraphs 17 to 20, wherein each of X¹ and X² is independently a halide or a C₁-C₅ hydrocarbyl.
22. The supported catalyst composition of any one of paragraphs 17 to 21, wherein each of R⁵, R⁶, R⁷, and R⁸ is independently an unsubstituted C₁-C₂₀ hydrocarbyl or a C₁-C₂₀ substituted hydrocarbyl.
23. The supported catalyst composition of any one of paragraphs 17 to 22, wherein each of R⁵, R⁶, R⁷, and R⁸ is independently an unsubstituted C₁-C₆ hydrocarbyl or a substituted C₁-C₆ hydrocarbyl.
24. The supported catalyst composition of any one of paragraphs 17 to 23, wherein R′ is hydrogen, a substituted C₁-C₂₀ hydrocarbyl, or an unsubstituted C₁-C₂₀ hydrocarbyl.
25. The supported catalyst composition of any one of paragraphs 17 to 24, wherein R¹ is hydrogen, a substituted C₁-C₆ hydrocarbyl, or an unsubstituted C₁-C₆ hydrocarbyl.
26. The supported catalyst composition of any one of paragraphs 17 to 25, wherein each of R² and R⁴ is independently hydrogen, a substituted C₁-C₂₀ hydrocarbyl, or an unsubstituted C₁-C₂₀ hydrocarbyl.
27. The supported catalyst composition of any one of paragraphs 17 to 26, wherein each of R² and R⁴ is independently hydrogen, a substituted C₁-C₆ hydrocarbyl, or an unsubstituted C₁-C₆ hydrocarbyl.
28. The supported catalyst composition of any one of paragraphs 17 to 27, wherein R³ is represented by the formula:

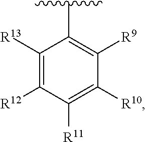

wherein each of R⁹, R¹⁰, R¹¹, R¹², and R¹³ is independently hydrogen, C₁-C₄₀ hydrocarbyl or C₁-C₄₀ substituted hydrocarbyl, a heteroatom or a heteroatom-containing group, or two or more of R⁹, R¹⁰, R¹¹, R¹², and R¹³ are joined together to form a C₄-C₂₀ cyclic or polycyclic ring structure.
29. The supported catalyst composition of paragraph 28, wherein each of R⁹, R¹⁰, R¹¹, R¹², and R¹³ is independently hydrogen, halogen, —NR′₂, —SR′, —OR, —SiR′₃, —OSiR′₃, —PR′₂, or —R″—SiR′₃, where R″ is C₁-C₁₀ alkyl and each R′ is hydrogen, halogen, C₁-C₁₀ alkyl, or C₆-C₁₀ aryl.
30. The supported catalyst composition of paragraph 28, wherein each of R⁹, R¹⁰, R¹¹, R¹², and R¹³ is independently hydrogen, a substituted C₁-C₆ hydrocarbyl, an unsubstituted C₁-C₆ hydrocarbyl, or a phenyl.
31. The supported catalyst composition of any one of paragraph 17 or paragraphs 19 to 30, wherein each of R¹⁴, R¹⁵, R¹⁶, R¹⁷, R¹⁸, and R¹⁹ is independently hydrogen, C₁-C₄₀ hydrocarbyl, C₁-C₄₀ substituted hydrocarbyl, or two or more of R¹⁴, R¹⁵, R¹⁶, R¹⁷, R¹⁸, and R¹⁹ are joined together to form cyclic or polycyclic ring structure, or a combination thereof.
32. The supported catalyst composition of paragraph 31, wherein each of R¹⁴, R¹⁵, R¹⁶, R¹⁷, R¹⁸, and R¹⁹ is independently hydrogen, a substituted C₁-C₂₀ hydrocarbyl, or an unsubstituted C₁-C₂₀ hydrocarbyl, such as hydrogen, methyl, ethyl, propyl, butyl, pentyl, or hexyl.
33. The supported catalyst composition of any of paragraphs 1 to 32, wherein the catalyst composition comprises 1.0 wt % or less aromatic compound, alternately 0.5 wt % or less, alternately 0.1 wt % or less, alternately 0.10 wt % or less, alternately 0 wt % of aromatic compound (such as toluene), based upon the weight of the support.
34. The supported catalyst composition of any one of paragraphs 18 to 30, wherein each of R²⁰, R²¹, R²², R²³, R²⁴, R²⁵, R²⁶, R²⁷ is independently hydrogen, C₁-C₄₀ hydrocarbyl, C₁-C₄₀ substituted hydrocarbyl, or two or more of R²⁰, R²¹, R²², R²³, R²⁴, R²⁵, R²⁶, R²⁷ are joined together to form cyclic or polycyclic ring structure, or a combination thereof.
35. The supported catalyst composition of paragraph 34, wherein each of R²⁰, R²¹, R²², R²³, R²⁴, R²⁵, R²⁶, R²⁷ is independently hydrogen, a substituted C₁-C₂₀ hydrocarbyl, or an unsubstituted C₁-C₂₀ hydrocarbyl, preferably hydrogen, methyl, ethyl, propyl, butyl, pentyl, or hexyl.
36. The supported catalyst composition of paragraph 1, wherein the catalyst compound represented by Formula (I) is dispersed in the aromatic-solvent-free support.
37. A catalyst system comprising an activator and the supported catalyst composition of any one of paragraphs 1 to 36, wherein the catalyst system preferably comprises less than 1 wt % (preferably less than 0.5 wt %, preferably less than 0.1 wt %, preferably less than 0.01 wt %, preferably less than 1 ppm, preferably 0 wt %) of aromatic compounds (such as toluene), based upon the weight of the support.
38. The catalyst system of paragraph 37, wherein the aromatic-solvent-free support comprises a support having a surface area of 300 m²/g or more, preferably wherein the aromatic-solvent-free support preferably comprises less than 0.5 wt % (preferably less than 0.1 wt %, preferably less than 0.01 wt %, preferably less than 1 ppm, preferably 0 wt %) of aromatic compounds, based upon the weight of the support.
39. The catalyst system of paragraph 38, wherein the support material is selected from Al₂O₃, ZrO₂, SiO₂, SiO₂/Al₂O₃, SiO₂/TiO₂, silica clay, silicon oxide/clay, or mixtures thereof.
40. The catalyst system of any one of paragraphs 37 to 39, wherein the activator further comprises a non-coordinating anion activator.
41. The catalyst system of any one of paragraphs 37 to 39, wherein the activator is methylalumoxane dispersed in an aromatic-solvent-free support.
42. The catalyst system of paragraph 41, wherein the methylalumoxane supported on an aromatic-solvent-free support is obtained by contacting:
1) a support; and
2) either i) the reaction product of an unsaturated carboxylic acid and 3 or more equivalents of trimethylaluminum in a non-aromatic solvent at a temperature of about 25 to about 70° C.; or ii) the reaction product of an aluminum carboxylate dimer or oligomer combined with 2 or more equivalents of trimethylaluminum in a non-aromatic solvent at a temperature of about 25 to about 70° C.; or 3) both the reaction produces of i) and ii).
   43. The supported catalyst composition of paragraph 1 obtained by contacting catalyst compound represented by the Formula (I) with an aromatic-solvent-free support obtained by contacting:
1) a support; and
2) either i) the reaction product of an unsaturated carboxylic acid and 3 or more equivalents of trimethylaluminum in a non-aromatic solvent at a temperature of about 25 to about 70° C.; or ii) the reaction product of an aluminum carboxylate dimer or oligomer combined with 2 or more equivalents of trimethylaluminum in a non-aromatic solvent at a temperature of about 25 to about 70° C.; or 3) both the reaction produces of i) and ii) wherein the supported catalyst composition preferably comprises less than 1 wt % (preferably less than 0.5 wt %, preferably less than 0.1 wt %, preferably less than 0.01 wt %, preferably less than 1 ppm, preferably 0 wt %) of aromatic compounds (such as toluene), based upon the weight of the support.
   44. A method to make the supported catalyst composition of paragraph 1, comprising:
A) contacting 1) a support; and 2) either i) the reaction product of an unsaturated carboxylic acid and 3 or more equivalents of trimethylaluminum in a non-aromatic solvent at a temperature of about 25 to about 70° C.; or ii) the reaction product of an aluminum carboxylate dimer or oligomer combined with 2 or more equivalents of trimethylaluminum in a non-aromatic solvent at a temperature of about 25 to about 70° C.; or 3) both the reaction produces of i) and ii) to obtain an aromatic-solvent-free support;
B) contacting catalyst compound represented by the Formula (I) with the aromatic-solvent-free support;
C) obtaining a support having catalyst compound represented by the Formula (I) dispersed therein, where the support contains less than 1 wt % aromatic compound, based upon the weight of the support.
   45. A method to make the catalyst system of paragraph 37, comprising:
A) contacting 1) a support; and 2) either i) the reaction product of an unsaturated carboxylic acid and 3 or more equivalents of trimethylaluminum in a non-aromatic solvent at a temperature of about 25 to about 70° C.; or ii) the reaction product of an aluminum carboxylate dimer or oligomer combined with 2 or more equivalents of trimethylaluminum in a non-aromatic solvent at a temperature of about 25 to about 70° C.; or 3) both the reaction produces of i) and ii) to obtain an aromatic-solvent-free support having methylalumoxane dispersed therein;
B) contacting catalyst compound represented by the Formula (I) with the aromatic-solvent-free support;
C) obtaining a support having methylalumoxane and catalyst compound represented by the Formula (I) dispersed therein, where the support contains less than 1 wt % aromatic compound, based upon the weight of the support.
   46. A method to make the catalyst system of paragraph 37, comprising:
A) contacting 1) a support; and 2) either i) the reaction product of an unsaturated carboxylic acid and 3 or more equivalents of trimethylaluminum in a alkane solvent at a temperature of about 25 to about 70° C.; or ii) the reaction product of an aluminum carboxylate dimer or oligomer combined with 2 or more equivalents of trimethylaluminum in alkane solvent at a temperature of about 25 to about 70° C.; or 3) both the reaction produces of i) and ii) to obtain an aromatic-solvent-free support having methylalumoxane dispersed therein;
B) contacting catalyst compound represented by the Formula (I) with the aromatic-solvent-free support;
C) obtaining a support having methylalumoxane and catalyst compound represented by the Formula (I) dispersed therein, where the support contains less than 0.1 wt % aromatic compound, based upon the weight of the support.
   47. A process to prepare a propylene homopolymer comprising:
introducing propylene and a catalyst system of any one of paragraphs 38-42 into a reactor at a reactor pressure of from 0.7 bar to 70 bar and a reactor temperature of from 20° C. to 150° C.; and obtaining a propylene homopolymer,
wherein the hompolymer preferably comprises less than 1 wt % (preferably less than 0.5 wt %, preferably less than 0.1 wt %, preferably less than 0.01 wt %, preferably less than 1 ppm, preferably 0 wt %) of aromatic compounds (such as toluene), based upon the weight of the homopolymer.
   48. The process of paragraph 47, wherein the propylene homopolymer has a Mw of 50,000 to 500,000 g/mol, and Tₘ of greater than 150° C. and an Mw/Mn of 10 or less.
   49. A process to prepare a propylene copolymer comprising:
introducing propylene, one or more of a C₂ or C₄ to C₄₀ olefin monomer, and a catalyst system of any one of paragraphs 38-42 into a reactor at a reactor pressure of from 0.7 bar to 70 bar and a reactor temperature of from 20° C. to 150° C.; and obtaining a propylene copolymer,
wherein the copolymer preferably comprises less than 1 wt % (preferably less than 0.5 wt %, preferably less than 0.1 wt %, preferably less than 0.01 wt %, preferably less than 1 ppm, preferably 0 wt %) of aromatic compounds (such as toluene), based upon the weight of the copolymer.
   50. The process of paragraph 49, wherein the olefin monomer is one or more of a C₄ to C₂₀ alpha olefin or a C₄ to C₁₄ α,ω-olefin.
   51. The process of paragraph 49 or paragraph 50, wherein the olefin monomer is a C₄ to C₈ alpha olefin.
   52. The process of paragraph 49 or paragraph 50, wherein the olefin monomer is 1,4-heptadiene, 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, 2-methyl-1,6-heptadiene, 2-methyl-1,7-octadiene, 2-methyl-1,8-nonadiene, 2-methyl-1,9-decadiene, 2-methyl-1,10-undecadiene, 2-methyl-1,11-dodecadiene, 2-methyl-1,12-tridecadiene, or 2-methyl-1,13-tetradecadiene.
   53. The process of any one of paragraphs 49 to 52, wherein the propylene copolymer has a Mw value of 50,000 to 500,000 g/mol, and a Tₘ of greater than 148° C.
   54. The process of any one of paragraphs 49 to 52, wherein the propylene copolymer comprises less than 0.1 wt % aromatic compound, based upon the weight of the polymer.
   55. The process of any one of paragraphs 49 to 52, wherein the propylene copolymer comprises 0 wt % toluene.
   56. A process to prepare a olefin polymer comprising: introducing one or more C₂ to C₄₀ olefin monomers, and a catalyst system of any one of paragraphs 38-42 into a reactor at a reactor pressure of from 0.7 bar to 70 bar and a reactor temperature of from 20° C. to 150° C.; and obtaining a polymer comprises less than 0.1 wt % aromatic compound, alternately 0 wt % aromatic compound based upon the weight of the polymer.

### Examples

### A. Example Catalysts

Table 1 shows Catalysts A, B and C.

TABLE 1

| | |
|---|---|
| 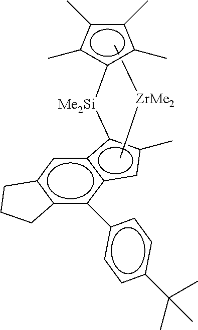 | Catalyst A |
| 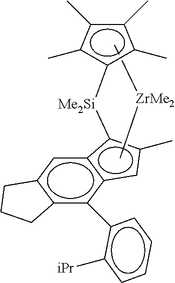 | Catalyst B |
| 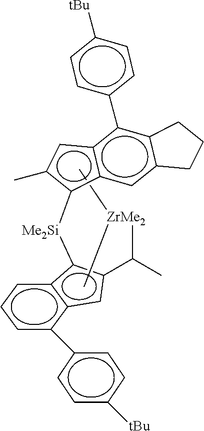 | Catalyst C |

Catalysts A, B were prepared as described in PCT application Number PCT/US20/43758, filed Jul. 27, 2020 and entitled “Isotactic Propylene Homopolymers and Copolymers Produced with Ci Symmetric Metallocene Catalysts”. Catalyst C was obtained from commercial sources.

DM-L403™ silica was obtained from Asahi Glass Chemical (AGC) and is reported to have a surface area of 325 m²/g, an average particle size of 40 microns, a pore volume of 2.16 ml/g, and a pore diameter of 266 angstroms.

PD 14024™ silica was obtained from PQ Corporation (Malvern, Pa., USA) and is reported to have a surface area of 611 m²/g, an average particle size of 85 microns, a pore volume of 1.40 ml/g, and a pore diameter of 92 angstroms.

MAO is methyl alumoxane (obtained from Grace Chemical Company, formerly Albemarle, 30% in solution).

TMA is trimethyl aluminum.

MAA is methacrylic acid.

TIBAL is tri-isobutyl aluminum.

### Support Preparation.

### Preparation of Silica Supported MAO (“SMAO”)

20.0 g of silica (DM-L403™ silica, 200° C. calcination for 3 days under N₂ flow) was suspended in ca. 100 mL of toluene in a Celstir™ bottle and cooled in the freezer. While stirring, a solution of MAO (31.8 g, 30% in toluene) was added via pipette. The slurry was allowed to stir for 1 hour and was then heated to 100° C. for 2.5 hours. Upon cooling for 30 minutes, the mixture was filtered, washed with toluene (2×20 mL) and pentane (2×20 mL) and dried in vacuo overnight to afford the final product as a free flowing white solid (28.5 g isolated).

### Preparation of Aromatic Free MAO Precursor (“MAA/TMA Precursor”)

A 3 L. 3 neck flask, equipped mechanical stirrer and very efficient condenser cooled with a cold finger, was charged with TMA (75.7128 g, 1.05 mol) and pentane (500 mL) and stirred for 15 minutes. A solution of methacrylic acid (degassed immediately prior to use) (30.1647 g, 0.35 mol) and pentane (300 mL) was added dropwise to the TMA solution, using an addition funnel, over the course of 60 minutes. The reaction was exothermic and afterwards was heated to reflux for 1 hour. Then pentane was distilled off to afford the MAA/TMA precursor as an oil. Yield 123 g. of colorless oil. The product was stored in −40° C. freezer. ¹H NMR showed concentration of (2.81 mmol MAA equivalents/g oil).

### Preparation of Aromatic Free Supported Methylalumoxane-1 (“AF-SMAO-1”)

A 3 neck flask (250 mL), equipped with mechanical stirrer and heating mantle, was charged with pentane (100 mL), TMA (1.9250 g, 26.6 mmol) and MAA/TMA precursor (7.1233 g, 20 mmol. equiv. of MAA/10 g SiO₂). The mixture was stirred for 5 minutes, then silica (DML-403™ silica, 200° C. calcination for 3 days under N₂ flow) (10.1090 g) was added to the stirred solution. The slurry was kept stirring at room temperature for 30 minutes. Pentane was removed via distillation. The remaining solid was heated at 120° C. (temperature of internal glass wall) for 3 hours with stirring. After 3 hours, the flask was put under vacuum for further 2 hours at the same temperature with stirring. Volatiles were collected in a cooled trap within the drybox. Yield 14.5102 g white solid. The solids were placed in a Soxhlet apparatus and extracted with pentane for 6 hours. Final yield 13.0 g extracted product.

### Preparation of Aromatic Free Supported Methylalumoxane-2 (“AF-SMAO-2”)

A 3 neck flask (1000 mL), equipped with mechanical stirrer and heating mantle, was charged with pentane (200 mL), TMA (5.7684 g, 80 mmol) and MAA/TMA precursor (28.5135 g, 80 mmol. equiv. of MAA). The mixture was stirred for 5 minutes, then silica (PD14024™ silica, 200° C. calcination for 3 days under N₂ flow) (20.1710 g.) was added to the stirred solution. The slurry was kept stirring at room temperature for 30 minutes. Pentane was removed via distillation. The remaining solid was heated at 120° C. (temperature of internal glass wall) for 3 hours with stirring. After 3 hours, the flask was put under vacuum for further 2 hours at the same temperature with stirring. Volatiles were collected in a cooled trap within the drybox. Yield 37.15 g white solid. A portion of the product (15 g) was placed in a Soxhlet apparatus and extracted with hexane for 6 hours to yield 12.5 g. extracted product.

### Preparation of Supported Catalysts on SMAO Support (Comparative Examples)

Catalyst A (Me₂Si(Me₄Cp)(2-Me,4-tBuPh-Indacenyl)ZrMe₂): 1.0 g of SMAO was suspended in 5 mL of toluene and placed on a shaker. TIBAL (0.35 mL of 1M solution) was then added, and the resulting mixture was allowed to react for 15 minutes. After 15 minutes, Catalyst A (20.7 mg, corresponding to 0.3 wt % Zr), was added as a toluene solution (2 mL) to the silica mixture. This resulted in rapid color change to dark red. The mixture was allowed to react for 3 hours. After 3 hours, the mixture was filtered and the solid was washed with toluene (5 mL) and hexane (2×5 mL) and dried in vacuo to give a supported catalyst as orange solids in quantitative yield. The isolated powder was suspended in degassed mineral oil to make 5 wt % slurry, which was used in the polymerization runs.

Catalyst B (Me₂Si(Me₄Cp)(2-Me,4-iPrPh-Indacenyl)ZrMe₂): 1.0 g of SMAO was suspended in 5 mL of toluene and placed on a shaker. TIBAL (0.35 mL of 1M solution) was then added, and the resulting mixture was allowed to react for 15 minutes. After 15 minutes, Catalyst B (20.6 mg corresponding to 0.3 wt % Zr), was added as a toluene solution (2 mL) to the silica mixture. This resulted in rapid color change to dark red. The mixture was allowed to react for 3 hours. After 3 hours, the mixture was filtered and the solid was washed with toluene (5 mL) and hexane (2×5 mL) and dried in vacuo to give a supported catalyst as orange solids in quantitative yield. The isolated powder was suspended in degassed mineral oil to make 5 wt % slurry, which was used in the polymerization runs.

Catalyst C (Me₂Si(2-iPr,4-tBuPh-Indenyl)(2-Me,4-tBuPh-Indacenyl)ZrMe₂): 1.0 g of SMAO was suspended in 5 mL of toluene and placed on a shaker. TIBAL (0.35 mL of 1M solution) was then added, and the resulting mixture was allowed to react for 15 minutes. After 15 minutes, Catalyst C (15.6 mg corresponding to 0.2 wt % Zr), was added as a toluene solution (2 mL) to the silica mixture. This resulted in rapid color change to dark red. The mixture was allowed to react for 3 hours. After 3 hours, the mixture was filtered and the solid was washed with toluene (5 mL) and hexane (2×5 mL) and dried in vacuo to give a supported catalyst as orange solids in quantitative yield. The isolated powder was suspended in degassed mineral oil to make 5 wt % slurry, which was used in the polymerization runs.

### Preparation of Supported Catalysts Using a Toluene Free Method on AF-SMAO-1 Support (Inventive Example)

Catalyst A (Me₂Si(Me₄Cp)(2-Me,4-tBuPh-Indacenyl)ZrMe₂): 0.61 g of AF-SMAO-1 was suspended in ca 10 mL of heptane. While stirring, TIBAL (0.215 mL of 1M solution) was added to the slurry. The mixture was vortexed for 15 minutes. Catalyst A (12.0 mg, based on 33 μmol/g of silica), was then added (as heptane solution, ca 3 mL). The catalyst was completely dissolved in heptane. The slurry was vortexed for the total of 3 hours. The mixture was filtered, washed with additional hexane (2×10 mL) and dried in vacuo to give a supported Catalyst A as a red free flowing solid. The isolated powder was suspended in degassed mineral oil to make 5 wt % slurry, which was used in the polymerization runs.

### Preparation of Supported Catalysts Using a Toluene Free Method on AF-SMAO-2 Support (Inventive Examples)

Catalyst A (Me₂Si(Me₄Cp)(2-Me,4-tBuPh-Indacenyl)ZrMe₂): 0.56 g of AF-SMAO-2 was suspended in ca 5 mL of hexane. While stirring, TIBAL (0.19 mL of 1M solution) was added to the slurry. The mixture was vortexed for 15 minutes. Catalyst A (11.5 mg, based on 33 μmol/g of silica) was then added (as heptane solution, ca 3 mL). The catalyst was completely dissolved in heptane. The slurry was vortexed for the total of 3 hours. The mixture was filtered, washed with additional hexane (2×10 mL) and dried in vacuo to give a supported Catalyst A as a beige free flowing solid. The isolated powder was suspended in degassed mineral oil to make 5 wt % slurry, which was used in the polymerization runs.

Catalyst B (Me₂Si(Me₄Cp)(2-Me,4-iPrPh-Indacenyl)ZrMe₂): 0.53 g of AF-SMAO-2 was suspended in ca 5 mL of hexane. While stirring, TIBAL (0.18 mL of 1M solution) was added to the slurry. The mixture was vortexed for 15 minutes. Catalyst B (11.1 mg, based on 33 umol/g of silica) was then added (as heptane solution, ca 3 mL). The heptane solution of metallocene had to be heated for the catalyst to dissolve. The slurry was vortexed for a total of 3 hours. The mixture was filtered, washed with additional hexane (2×10 mL) and dried in vacuo. The isolated powder was suspended in degassed mineral oil to make 5 wt % slurry, which was used in the polymerization runs.

### Propylene Polymerizations

### Autoclave Reactor Conditions:

A 1 liter autoclave reactor equipped with a mechanical stirrer was used for polymer preparation. Prior to the run, the reactor was placed under nitrogen purge while maintaining 90° C. temperature for 30 minutes. Upon cooling back to ambient temperature, propylene feed (500 mL), scavenger (0.2 mL of 1M TIBAL), optionally hydrogen (charged from a 25 mL bomb at a desired pressure) and optionally 1,7-octadiene were introduced to the reactor and were allowed to mix for 5 minutes. Desired amount of supported catalyst (typically 12.5-25.0 mg) was then introduced to the reactor by flushing the pre-determined amount of catalyst slurry (5 wt % in mineral oil) from a catalyst tube with 100 mL of liquid propylene. The reactor was kept for 5 minutes at room temperature (pre-poly stage), before raising the temperature to 70° C. The reaction was allowed to proceed at that temperature for a desired time period (typically 15-30 minutes). After the given time, the temperature was reduced to 25° C., the excess propylene was vented off and the polymer granules were collected, and dried under vacuum at 60° C. overnight.

### EXAMPLES AND DATA

Table 1 shows GPC data for propylene homopolymerization runs with two catalysts (Catalyst A and Catalyst B) on two toluene free supports (AF-SMAO-1 and AF-SMAO-2). In addition SMAO was used for comparison. In general, AF-SMAO-2 provided improved activities over SMAO. These inventive resins exhibited narrower polydispersity and slightly improved polymer crystallinity, all of which is a desirable properties for non-woven fiber process. Even though catalyst productivities were extraordinarily high, no reactor fouling was observed. Furthermore, the inventive Catalyst A prepared on AF-SMAO2 had an improved activity over commercially relevant C₂ symmetric metallocene C run at high H₂ concentration supported on regular SMAO (Comp. 7).

TABLE 1
Propylene homopolymers prepared with SMAO and AF-SMAO-2 supported metallocenes

| | | Catalyst | H₂ | Silica | Activity | | | | |
|---|---|---|---|---|---|---|---|---|---|
| Example | Catalyst | (mg) | (mmol) | support | (g/g · h) | Mₙ | M_{w} | M_{z} | PDI |
| 1 | A | 12.5 | 2 | AF-SMAO2 | 25,338 | 62,208 | 167,988 | 320,413 | 2.70 |
| 2 | A | 12.5 | 8 | AF-SMAO2 | 24,908 | 43,710 | 129,972 | 276,590 | 2.97 |
| 3 | B | 12.5 | 2 | AF-SMAO2 | 14,865 | 59,397 | 167,789 | 324,644 | 3.14 |
| 4 | B | 12.5 | 8 | AF-SMAO2 | 11,524 | 23,730 | 78,769 | 159,576 | 3.32 |
| 5 | A | 12.5 | 1 | AF-SMAO1 | 8,705 | — | — | — | — |
| 6 | A | 25.0 | 2 | AF-SMAO1 | 11,192 | — | — | — | — |
| Comp. 1 | A | 12.5 | 2 | SMAO | 16,027 | 37,461 | 139,809 | 284,945 | 3.73 |
| Comp. 2 | A | 25.0 | 2 | SMAO | 20,831 | 67,877 | 237,638 | 483,239 | 3.50 |
| Comp. 3 | A | 25.0 | 8 | SMAO | 20,266 | 42,044 | 210,510 | 507,052 | 5.00 |
| Comp. 4 | A | 25.0 | 1 | SMAO | 13,450 | — | — | — | — |
| Comp. 5 | B | 12.5 | 2 | SMAO | 8,737 | 36,115 | 161,892 | 346,430 | 4.48 |
| Comp. 6 | B | 12.5 | 8 | SMAO | 16,708 | 29,959 | 120,668 | 267,627 | 4.02 |
| Comp. 7 | C | 25.0 | 12.5 | SMAO | 19,602 | 22,370 | 71,353 | 165,073 | 3.20 |

TABLE 2
DSC data for propylene homopolymers

| Example | Catalyst | Support | Tₘ (° C.) | T_{c} (° C.) |
|---|---|---|---|---|
| 1 | A | AF-SMAO2 | 158.39 | 109.73 |
| 2 | A | AF-SMAO2 | 157.77 | 114.54 |
| 3 | B | AF-SMAO2 | 158.75 | 112.98 |
| 4 | B | AF-SMAO2 | 157.77 | 113.25 |
| Comp. 1 | A | SMAO | 156.00 | — |
| Comp. 2 | A | SMAO | 157.93 | 112.73 |
| Comp. 3 | A | SMAO | 157.80 | 112.36 |
| Comp. 5 | B | SMAO | 158.38 | 112.50 |
| Comp. 6 | B | SMAO | 158.80 | 114.68 |
| Comp. 7 | C | SMAO | 153.30 | 111.1 |

Table 3 shows activity data for propylene/1,7-octadiene runs with two catalysts (Catalyst A and Catalyst B) on two supports (AF-SMAO2 and regular SMAO). In general, aromatic free support AF-SMAO2 provided improved activities over conventional SMAO. In some cases, productivities exceeding 30,000 g/g (Example 7) were observed even in the presence of a known metallocene catalyst poison, such as 1,7-octadiene. For comparison, the same catalyst had lower activity on conventional SMAO support (see Comp. 8).

TABLE 3
Propylene/1,7-octadiene copolymers prepared with SMAO and toluene-
free derived AF-SMAO2 supported metallocenes. Hydrogen content
in the reactor was kept at 2 mmol in all examples.

| | | | 1,7-OD | Yield | Activity |
|---|---|---|---|---|---|
| Example | Catalyst | Support | (mL) | (g) | (g/g · h) |
| 7 | A | AF-SMAO2 | 0.5 | 100.6 | 31,997 |
| 8 | A | AF-SMAO2 | 1.0 | 75.5 | 24,028 |
| 9 | B | AF-SMAO2 | 0.5 | 51.6 | 15,833 |
| 10 | B | AF-SMAO2 | 1.0 | 50.4 | 16,048 |
| Comp. 8 | A | SMAO | 0.5 | 65.3 | 20,821 |
| Comp. 9 | A | SMAO | 1.0 | 62.7 | 20,549 |
| Comp. 10 | B | SMAO | 0.5 | 30.4 | 9,945 |
| Comp. 11 | B | SMAO | 1.0 | 35.1 | 11,401 |

Table 4 shows GPC-4D data for propylene/1,7-octadiene runs with two catalysts (Catalyst A and Catalyst B) on two supports (AF-SMAO2 and regular SMAO). The runs with no diene under same H₂ concentration were included for reference as linear samples. The resin produced with AF-SMAO2 support had narrower molecular weight distribution (PDI=3.56 vs 4.96) at very similar molecular weights (M_{w}=181 kg/mol vs 203 kg/mol) and similar GPC recoveries. The formation of long-chain branches is evident by comparison of g′ᵥᵢₛ values relative to linear samples prepared with the same catalysts (Example 1, 7 and Examples 3, 9).

TABLE 4
GPC-4D data comparison for propylene and propylene/1,7-octadiene copolymers prepared
with regular SMAO and aromatic solvent-free derived AF-SMAO2 supported metallocenes.
Hydrogen content in the reactor was kept at 2 mmol in all examples.

| | | | 1,7-OD | | | | | |
|---|---|---|---|---|---|---|---|---|
| Example | Catalyst | Support | (mL) | Mₙ | M_{w} | M_{z} | PDI | g′ᵥᵢₛ |
| 1 | A | AF-SMAO2 | — | 62,208 | 167,988 | 320,413 | 2.70 | 0.964 |
| 7 | A | AF-SMAO2 | 0.5 | 51,035 | 181,738 | 884,943 | 3.56 | 0.838 |
| 3 | B | AF-SMAO2 | — | 59,397 | 167,789 | 324,644 | 3.14 | 0.989 |
| 9 | B | AF-SMAO2 | 0.5 | 38,199 | 119,075 | 542,066 | 3.12 | 0.903 |
| Comp. 1 | A | SMAO | — | 37,461 | 139,809 | 284,945 | 3.73 | 0.947 |
| Comp. 8 | A | SMAO | 0.5 | 40,940 | 203,265 | 1,326,925 | 4.96 | 0.794 |
| Comp. 3 | B | SMAO | — | 36,115 | 161,892 | 346,430 | 4.48 | 1.007 |
| Comp. 10 | B | SMAO | 0.5 | 18,730 | 100,315 | 587,974 | 5.35 | 0.795 |

Table 5 shows thermal data (DSC) for propylene/1,7-octadiene long-chain branched polymers prepared with two different supported catalyst systems. In the case LCB-PP sample prepared with 0.5 ml, of 1,7-OD with the supported Catalyst B on toluene-free AF-SMAO2 (Example 9), an extraordinarily high melting point is observed (Tₘ=161.2° C.). Also, the crystallization temperature, T_{c}, increased by ca. 10-15° C. relative to linear samples.

TABLE 5
DSC data comparison for propylene and propylene/1,7-
octadiene copolymers prepared with SMAO and toluene-
free derived AF-SMAO2 supported metallocenes.

| | | | 1,7-OD | Tₘ | T_{c} |
|---|---|---|---|---|---|
| Example | Catalyst | Support | (mL) | (° C.) | (° C.) |
| 1 | A | AF-SMAO2 | 0 | 158.39 | 109.73 |
| 7 | A | AF-SMAO2 | 0.5 | 159.75 | 122.63 |
| 8 | A | AF-SMAO2 | 1.0 | 158.35 | 123.57 |
| 3 | B | AF-SMAO2 | 0 | 158.75 | 112.98 |
| 9 | B | AF-SMAO2 | 0.5 | 161.22 | 124.32 |
| 10 | B | AF-SMAO2 | 1.0 | 157.71 | 125.36 |
| Comp. 1 | A | SMAO | 0 | 156.00 | — |
| Comp. 8 | A | SMAO | 0.5 | 159.16 | 124.95 |
| Comp. 9 | A | SMAO | 1.0 | 157.22 | 127.64 |
| Comp. 3 | B | SMAO | 0 | 158.38 | 112.50 |
| Comp. 10 | B | SMAO | 0.5 | 159.83 | 127.92 |
| Comp. 11 | B | SMAO | 1.0 | 157.43 | 128.46 |

### Test Methods

Gel Permeation Chromatography (GPC-4D): Unless otherwise indicated, the distribution and the moments of molecular weight (Mw, Mn, Mz, Mw/Mn, etc.), the comonomer content, and the branching index (g′) were determined by using a high temperature Gel Permeation Chromatography (Polymer Char GPC-IR) equipped with a multiple-channel band-filter based Infrared detector IR5 with a multiple-channel band filter based infrared detector ensemble IR5 with band region covering from about 2,700 cm⁻¹ to about 3,000 cm⁻¹ (representing saturated C—H stretching vibration), an 18-angle light scattering detector and a viscometer. Three Agilent PLgel 10-μm Mixed-B LS columns are used to provide polymer separation. Reagent grade 1,2,4-trichlorobenzene (TCB) (from Sigma-Aldrich) comprising ˜300 ppm antioxidant BHT can be used as the mobile phase at a nominal flow rate of ˜1.0 mL/min and a nominal injection volume of ˜200 μL. The whole system including transfer lines, columns, and detectors can be contained in an oven maintained at ˜145° C. A given amount of sample can be weighed and sealed in a standard vial with ˜10 μL flow marker (heptane) added thereto. After loading the vial in the auto-sampler, the oligomer or polymer may automatically be dissolved in the instrument with ˜8 mL added TCB solvent at ˜160° C. with continuous shaking. The sample solution concentration can be from ˜0.2 to ˜2.0 mg/ml, with lower concentrations used for higher molecular weight samples. The concentration, c, at each point in the chromatogram can be calculated from the baseline-subtracted IR5 broadband signal, I, using the equation: c=αI, where α is the mass constant determined with polyethylene or polypropylene standards. The mass recovery can be calculated from the ratio of the integrated area of the concentration chromatography over elution volume and the injection mass which is equal to the pre-determined concentration multiplied by injection loop volume. The conventional molecular weight (IR MW) is determined by combining universal calibration relationship with the column calibration which is performed with a series of monodispersed polystyrene (PS) standards ranging from 700 to 10 M gm/mole. The MW at each elution volume is calculated with following equation:

$$log M = \frac{log ( {K}_{PS} / K )}{α + 1} + \frac{{α}_{PS + 1}}{α + 1} log {M}_{P S}$$

where the variables with subscript “PS” stand for polystyrene while those without a subscript are for the test samples. In this method, α_{PS}=0.67 and K_{PS}=0.000175, a and K for other materials are as calculated as described in the published in literature (e.g., Sun, T. et al. (2001) Macromolecules, v. 34, pg. 6812), except that for purposes of this present disclosure and claims thereto, α=0.705 and K=0.0000229 for ethylene-propylene copolymers and ethylene-propylene-diene terpolymers, α=0.695 and K=0.000579 for linear ethylene polymers, α=0.705 and K=0.0002288 for linear propylene polymers, and α=0.695 and K=0.000181 for linear butene polymers. Concentrations are expressed in g/cm³, molecular weight is expressed in g/mole, and intrinsic viscosity (hence K in the Mark-Houwink equation) is expressed in dL/g unless otherwise noted.

The comonomer composition is determined by the ratio of the IR5 detector intensity corresponding to CH₂ and CH₃ channel calibrated with a series of PE and PP homo/copolymer standards whose nominal value are predetermined by NMR or FTIR. In particular, this provides the methyls per 1,000 total carbons (CH₃/1000TC) as a function of molecular weight. The short-chain branch (SCB) content per 1,000TC (SCB/1000TC) is then computed as a function of molecular weight by applying a chain-end correction to the CH₃/1000TC function, assuming each chain to be linear and terminated by a methyl group at each end. The weight % comonomer is then obtained from the following expression in which f is 0.3, 0.4, 0.6, 0.8, and so on for C₃, C₄, C₆, C₈, and so on co-monomers, respectively:

w2=f*SCB/1000TC.

The bulk composition of the polymer from the GPC-IR and GPC-4D analyses is obtained by considering the entire signals of the CH₃ and CH₂ channels between the integration limits of the concentration chromatogram. First, the following ratio is obtained

$$Bulk IR ratio = \frac{Area of {CH}_{3} signal within integration limits}{Area of {CH}_{2} signal within integration limits} .$$

Then the same calibration of the CH₃ and CH₂ signal ratio, as mentioned previously in obtaining the CH3/1000TC as a function of molecular weight, is applied to obtain the bulk CH3/1000TC. A bulk methyl chain ends per 1,000TC (bulk CH3end/1000TC) is obtained by weight-averaging the chain-end correction over the molecular-weight range. Then

w2b=f*bulk CH3/1000TC

bulk SCB/1000TC=bulk CH3/1000TC−bulk CH3end/1000TC

and bulk SCB/1000TC is converted to bulk w2 in the same manner as described above.

The LS detector is the 18-angle Wyatt Technology High Temperature DAWN HELEOSII. The LS molecular weight (M) at each point in the chromatogram is determined by analyzing the LS output using the Zimm model for static light scattering (Light Scattering from Polymer Solutions; Huglin, M. B., Ed.; Academic Press, 1972):

$$\frac{{K}_{o} c}{Δ R ( θ )} = \frac{1}{MP ( θ )} + 2 {A}_{2} c .$$

Here, ΔR(θ) is the measured excess Rayleigh scattering intensity at scattering angle θ, c is the polymer concentration determined from the IR5 analysis, A₂ is the second virial coefficient, P(θ) is the form factor for a monodisperse random coil, and K_{O} is the optical constant for the system:

$${K}_{o} = \frac{4 {π}^{2} {{n}^{2} ( dn / dc )}^{2}}{{λ}^{4} {N}_{A}}$$

where N_{A} is Avogadro's number, and (dn/dc) is the refractive index increment for the system. The refractive index, n=1.500 for TCB at 145° C. and λ=665 nm.

A high temperature Agilent (or Viscotek Corporation) viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, η_{S}, for the solution flowing through the viscometer is calculated from their outputs. The intrinsic viscosity, [η], at each point in the chromatogram is calculated from the equation [η]=η_{S}/c, where c is concentration and is determined from the IR5 broadband channel output. The viscosity MW at each point is calculated as M=K_{PS}M^{α}^{_{PS}}⁺¹/[η], where αₚₛ is 0.67 and Kₚₛ is 0.000175.

The branching index (g′ᵥᵢₛ) is calculated using the output of the GPC-IR5-LS-VIS method as follows. The average intrinsic viscosity, [η]_{avg}, of the sample is calculated by:

$${[ η ]}_{a v g} = \frac{\sum {{c}_{i} [ η ]}_{i}}{\sum {c}_{i}}$$

where the summations are over the chromatographic slices, i, between the integration limits. The branching index g′ᵥᵢₛ is defined as:

$${g}_{vis}^{′} = \frac{{[ η ]}_{avg}}{K {M}_{v}^{α}} ,$$

where M_{V} is the viscosity-average molecular weight based on molecular weights determined by LS analysis and the K and α are for the reference linear polymer, which are, for purposes of this present disclosure and claims thereto, α=0.705 and K=0.0000229 for ethylene-propylene copolymers and ethylene-propylene-diene terpolymers, α=0.695 and K=0.000579 for linear ethylene polymers, α=0.705 and K=0.0002288 for linear propylene polymers, α=0.695 and K=0.000181 for linear butene polymers. Concentrations are expressed in g/cm³, molecular weight is expressed in g/mole, and intrinsic viscosity (hence K in the Mark-Houwink equation) is expressed in dL/g unless otherwise noted. Calculation of the w2b values is as discussed above.

Differential Scanning Calorimetry Peak melting point, Tₘ, described for reactor batches (also referred to as melting point) and peak crystallization temperature, T_{c}, (also referred to as crystallization temperature) are determined using the following DSC procedure. Differential scanning calorimetric data can be obtained using a TA Instruments model DSC2500 machine. Samples weighing approximately 5 to 10 mg are sealed in an aluminum hermetic sample pan and loaded into the instrument at about room temperature. The DSC data are recorded by first gradually heating the sample to 220° C. at a rate of 10° C./minute in order to erase all thermal history. The sample is kept at 220° C. for 5 minutes, then cooled to −10° C. at a rate of 10° C./minute, followed by an isothermal for 5 minutes and heating to 220° C. at 10° C./minute, holding at 220° C. for 5 minutes and then cooling down to 25° C. at a rate of 10° C./minute. Both the first and second cycle thermal events were recorded. The melting and crystallization temperatures reported here were obtained during the second heating/cooling cycle unless otherwise noted.

All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

1. A supported catalyst composition comprising aromatic-solvent-free support and catalyst compound represented by the Formula (I): 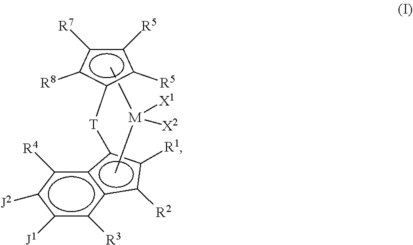
wherein:
M is a Group 4 metal;
T is a bridging group;
each of X¹ and X² is a univalent anionic ligand, or X¹ and X² are joined to form a metallocycle ring;
R¹ is hydrogen, a halogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, where R″ is C₁-C₁₀ alkyl and each R′ is hydrogen, halogen, C₁-C₁₀ alkyl, or C₆-C₁₀ aryl;
R³ is an unsubstituted C₄-C₆₂ cycloalkyl, a substituted C₄-C₆₂ cycloalkyl, an unsubstituted C₄-C₆₂ aryl, a substituted C₄-C₆₂ aryl, an unsubstituted C₄-C₆₂ heteroaryl, or a substituted C₄-C₆₂ heteroaryl;
each of R² and R⁴ is independently hydrogen, a halogen, an unsubstituted C₁-C₄₀ hydrocarbyl, a C₁-C₄₀ substituted hydrocarbyl, an unsubstituted C₄-C₆₂ aryl, a substituted
C₄-C₆₂ aryl, an unsubstituted C₄-C₆₂ heteroaryl, a substituted C₄-C₆₂ heteroaryl, —NR′₂, —SR′,
—OR, —SiR′₃, —OSiR′₃, —PR′₂, or —R″—SiR′₃, wherein R″ is C₁-C₁₀ alkyl and each R′ is hydrogen, halogen, C₁-C₁₀ alkyl, or C₆-C₁₀ aryl;
each of R⁵, R⁶, R⁷, and R⁸ is independently hydrogen, a halogen, an unsubstituted
C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl,
—NR′₂, —SR′, —OR, —SiR′₃, —OSiR′₃, —PR′₂, or —R″—SiR′₃, wherein R″ is C₁-C₁₀ alkyl and each R′ is hydrogen, halogen, C₁-C₁₀ alkyl, or C₆-C₁₀ aryl, or one or more of R⁵ and R⁶, R⁶ and R⁷, or R⁷ and R⁸ can be joined to form a substituted or unsubstituted C₄-C₆₂ saturated or unsaturated cyclic or polycyclic ring structure, or a combination thereof, where optionally R⁶ and R⁷ do not combine to form a six membered aromatic ring; and
J¹ and J² are joined to form a substituted or unsubstituted C₄-C₆₂ saturated or unsaturated cyclic or polycyclic ring structure, or a combination thereof, provided that J¹ and J² together with the two carbons they are bound to on the indenyl group form at least one saturated ring.

2. The supported catalyst composition of claim 1, wherein M is zirconium or hafnium.

3. The supported catalyst composition of claim 1, wherein T is represented by the formula:
(R*₂G)_{g},
wherein each G is C, Si, or Ge, g is 1 or 2, and each R* is, independently, hydrogen, halogen, C₁-C₂₀ unsubstituted hydrocarbyl, a C₁-C₂₀ substituted hydrocarbyl, or the two or more R* may join to form a substituted or unsubstituted, saturated, partially unsaturated or aromatic, cyclic or polycyclic substituent.

4. The supported catalyst composition of claim 1, wherein T is selected from the group consisting of CH₂, CH₂CH₂, C(CH₃)₂, (Ph)₂C, (p-(Et)₃SiPh)₂C, SiMe₂, SiPh₂, SiMePh, Si(CH₂)₃, Si(CH₂)₄, and Si(CH₂)₄.

5. The supported catalyst composition of claim 1, wherein each of X¹ and X² is independently a halide or a C₁-C₅ hydrocarbyl.

6. The supported catalyst composition of claim 1, wherein each of R⁵, R⁶, R⁷, and R⁸ is independently an unsubstituted C₁-C₂₀, preferably C₁-C₆, hydrocarbyl or a C₁-C₂₀, preferably C₁-C₆, substituted hydrocarbyl.

7. The supported catalyst composition of claim 1, wherein R¹ is hydrogen, a substituted C₁-C₂₀, preferably C₁-C₆, hydrocarbyl, or an unsubstituted C₁-C₂₀, preferably C₁-C₆, hydrocarbyl.

8. The supported catalyst composition of claim 1, wherein each of R² and R⁴ is independently hydrogen, a substituted C₁-C₂₀ (preferably C₁ to C₆) hydrocarbyl, or an unsubstituted C₁-C₂₀ (preferably C₁ to C₆) hydrocarbyl.

9. The supported catalyst composition of claim 1, wherein R³ is represented by the formula: 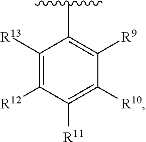
wherein each of R⁹, R¹⁰, R¹¹, R¹², and R¹³ is independently hydrogen, C₁-C₄₀ hydrocarbyl or C₁-C₄₀ substituted hydrocarbyl, a heteroatom or a heteroatom-containing group, or two or more of R⁹, R¹⁰, R¹¹, R¹², and R¹³ are joined together to form a C₄-C₂₀ cyclic or polycyclic ring structure.

10. The supported catalyst composition of claim 9, wherein
each of R⁹, R¹⁰, R¹¹, R¹², and R¹³ is independently hydrogen, halogen, —NR′₂, —SR′, —OR, —SiR′₃, —OSiR′₃, —PR′₂, or —R″—SiR′₃, where R″ is C₁-C₁₀ alkyl and each R′ is hydrogen, halogen, C₁-C₁₀ alkyl, or C₆-C₁₀ aryl, or
each of R⁹, R¹⁰, R¹¹, R¹², and R¹³ is independently hydrogen, a substituted C₁-C₆ hydrocarbyl, an unsubstituted C₁-C₆ hydrocarbyl, or a phenyl.

11. The supported catalyst composition of claim 10, wherein J¹ and J² are joined to form an unsubstituted C₄-C₂₀ cyclic or polycyclic ring or a substituted C₄-C₂₀ cyclic or polycyclic ring, provided that J¹ and J² together with the two carbons they are bound to on the indenyl group form at least one 5 or 6 membered saturated ring.

12. The supported catalyst composition of claim 1, wherein the catalyst compound is selected from the group consisting of:

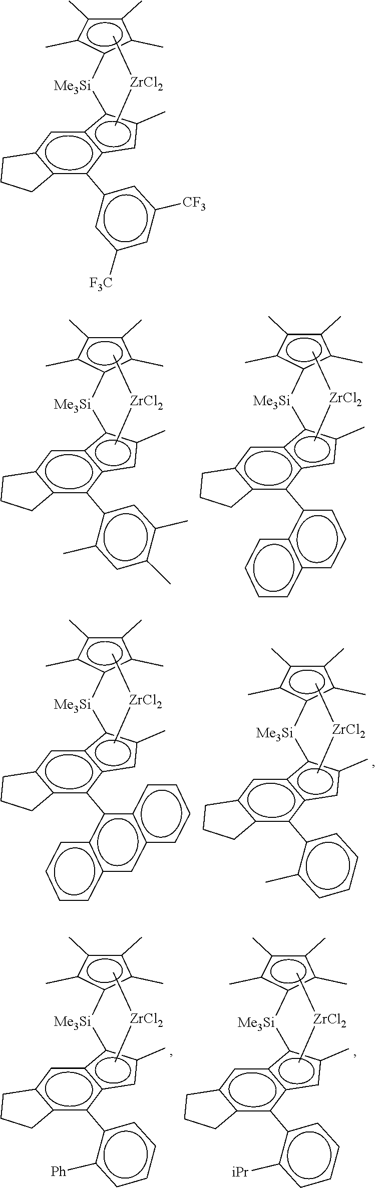

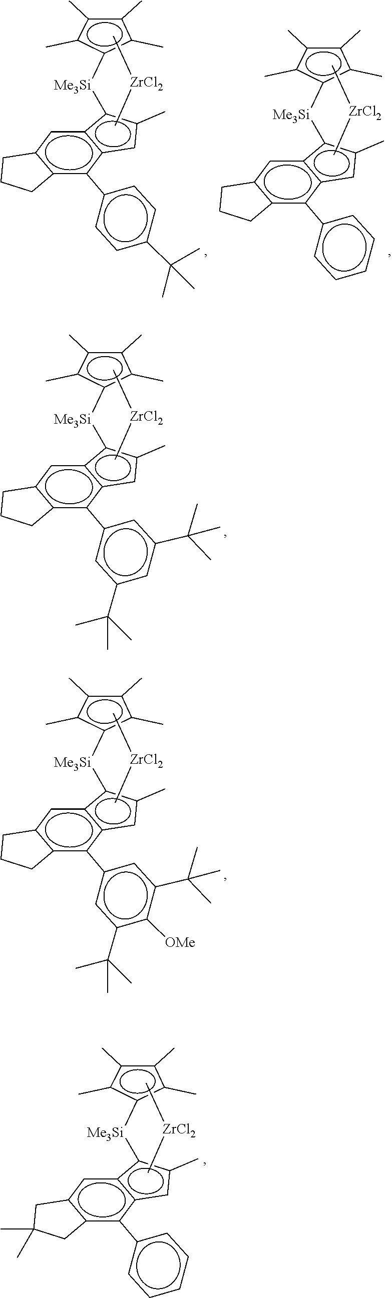

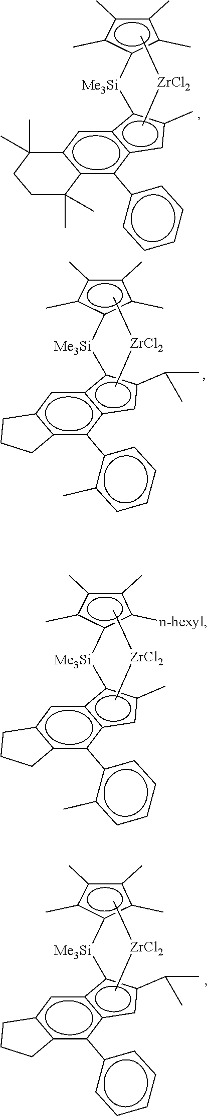

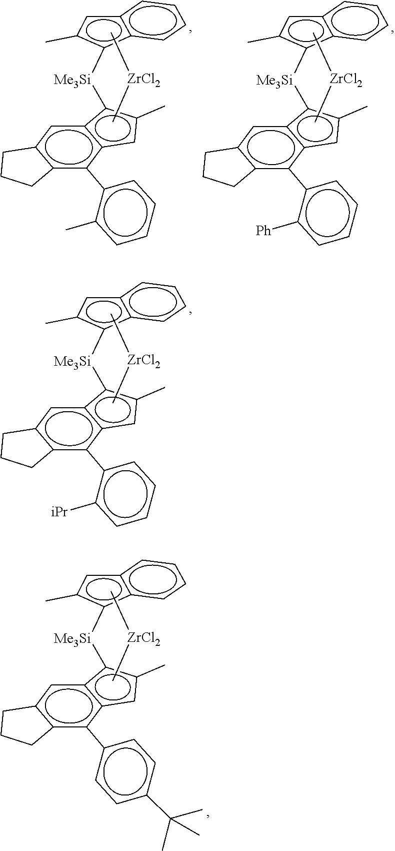

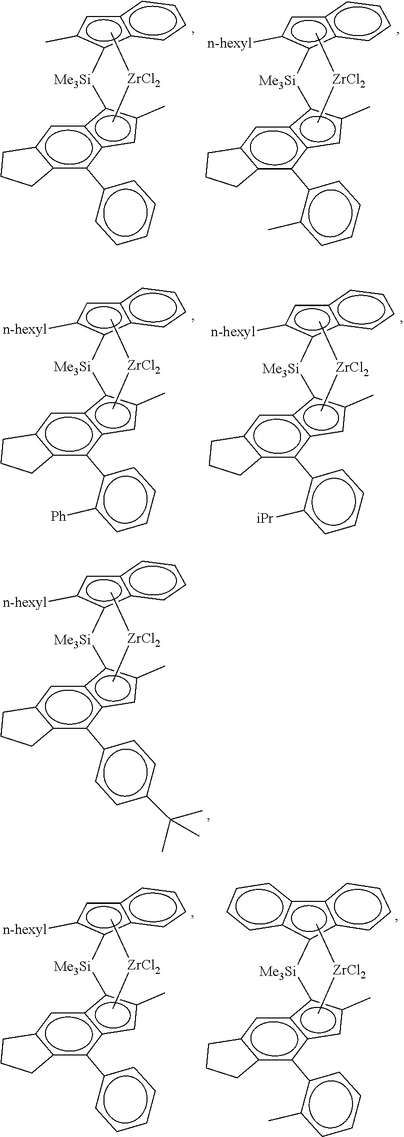

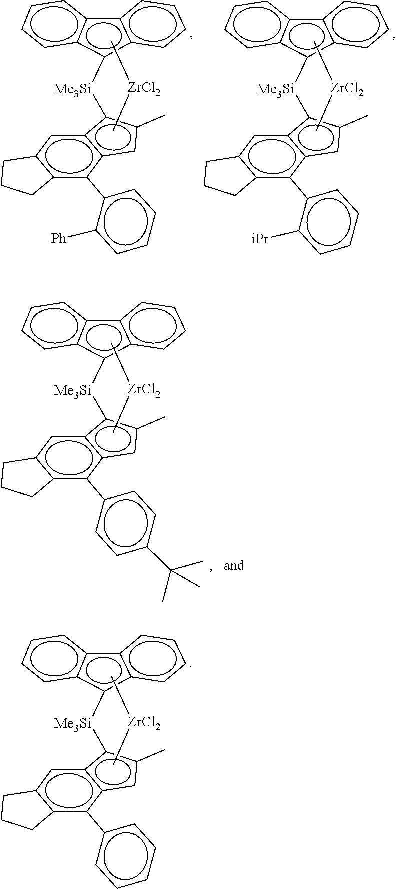

13. The supported catalyst composition of claim 1, wherein the catalyst compound is represented by Formula (III): 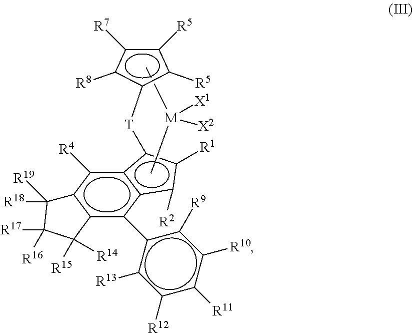
wherein:
M is a Group 4 metal;
T is a bridging group;
each of X¹ and X² is a univalent anionic ligand, or X¹ and X² are joined to form a metallocycle ring;
R¹ is hydrogen, a halogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, where R″ is C₁-C₁₀ alkyl and each R′ is hydrogen, halogen, C₁-C₁₀ alkyl, or C₆-C₁₀ aryl;
each of R² and R⁴ is independently hydrogen, a halogen, an unsubstituted C₁-C₄₀ hydrocarbyl, a C₁-C₄₀ substituted hydrocarbyl, an unsubstituted C₄-C₆₂ aryl, a substituted
C₄-C₆₂ aryl, an unsubstituted C₄-C₆₂ heteroaryl, a substituted C₄-C₆₂ heteroaryl, —NR′₂, —SR′,
—OR, —SiR′₃, —OSiR′₃, —PR′₂, or —R″—SiR′₃, wherein R″ is C₁-C₁₀ alkyl and each R′ is hydrogen, halogen, C₁-C₁₀ alkyl, or C₆-C₁₀ aryl;
each of R⁵, R⁶, R⁷, and R⁸ is independently hydrogen, a halogen, an unsubstituted
C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl,
—NR′₂, —SR′, —OR, —SiR′₃, —OSiR′₃, —PR′₂, or —R″—SiR′₃, wherein R″ is C₁-C₁₀ alkyl and each R′ is hydrogen, halogen, C₁-C₁₀ alkyl, or C₆-C₁₀ aryl, or one or more of R⁵ and R⁶, R⁶ and R⁷, or R⁷ and R⁸ are joined to form a substituted or unsubstituted C₄-C₆₂ saturated or unsaturated cyclic or polycyclic ring structure, or a combination thereof, where optionally R⁶ and R⁷ do not combine to form a six membered aromatic ring;
each of R⁹, R¹⁰, R¹¹, R¹², and R¹³ is independently hydrogen, C₁-C₄₀ hydrocarbyl or
C₁-C₄₀ substituted hydrocarbyl, a heteroatom or a heteroatom-containing group, or two or more of R⁹, R¹⁰, R¹¹, R¹², and R¹³ are joined together to form a C₄-C₂₀ cyclic or polycyclic ring structure; and
each of R¹⁴, R¹⁵, R¹⁶, R¹⁷, R¹⁸, and R¹⁹ is independently hydrogen, a halogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, wherein R″ is C₁-C₁₀ alkyl and each R′ is hydrogen, halogen, C₁-C₁₀ alkyl, or C₆-C₁₀ aryl, or two or more of R¹⁴, R¹⁵, R¹⁶, R¹⁷, R¹⁸, and R¹⁹ are joined together to form cyclic or polycyclic ring structure, or a combination thereof.

14. The supported catalyst composition of claim 1, wherein the catalyst compound is represented by Formula (IV): 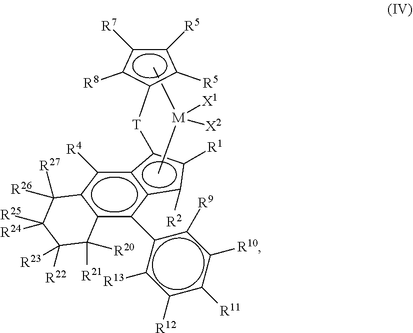
wherein:
M is a Group 4 metal;
T is a bridging group;
each of X¹ and X² is a univalent anionic ligand, or X¹ and X² are joined to form a metallocycle ring;
R¹ is hydrogen, a halogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, where R″ is C₁-C₁₀ alkyl and each R′ is hydrogen, halogen, C₁-C₁₀ alkyl, or C₆-C₁₀ aryl;
each of R² and R⁴ is independently hydrogen, a halogen, an unsubstituted C₁-C₄₀ hydrocarbyl, a C₁-C₄₀ substituted hydrocarbyl, an unsubstituted C₄-C₆₂ aryl, a substituted
C₄-C₆₂ aryl, an unsubstituted C₄-C₆₂ heteroaryl, a substituted C₄-C₆₂ heteroaryl, —NR′₂, —SR′,
—OR, —SiR′₃, —OSiR′₃, —PR′₂, or —R″—SiR′₃, wherein R″ is C₁-C₁₀ alkyl and each R′ is hydrogen, halogen, C₁-C₁₀ alkyl, or C₆-C₁₀ aryl;
each of R⁵, R⁶, R⁷, and R⁸ is independently hydrogen, a halogen, an unsubstituted
C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl,
—NR′₂, —SR′, —OR, —SiR′₃, —OSiR′₃, —PR′₂, or —R″—SiR′₃, wherein R″ is C₁-C₁₀ alkyl and each R′ is hydrogen, halogen, C₁-C₁₀ alkyl, or C₆-C₁₀ aryl, or one or more of R⁵ and R⁶, R⁶ and R⁷, or R⁷ and R⁸ can be joined to form a substituted or unsubstituted C₄-C₆₂ saturated or unsaturated cyclic or polycyclic ring structure, or a combination thereof, where optionally R⁶ and R⁷ do not combine to form a six membered aromatic ring;
each of R⁹, R¹⁰, R¹¹, R¹², and R¹³ is independently hydrogen, C₁-C₄₀ hydrocarbyl or
C₁-C₄₀ substituted hydrocarbyl, a heteroatom or a heteroatom-containing group, or two or more of R⁹, R¹⁰, R¹¹, R¹², and R¹³ are joined together to form a C₄-C₂₀ cyclic or polycyclic ring structure; and
each of R²⁰, R²¹, R²², R²³, R²⁴, R²⁵, R²⁶, R²⁷ is independently hydrogen, a halogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, wherein R″ is C₁-C₁₀ alkyl and each R′ is hydrogen, halogen, C₁-C₁₀ alkyl, or C₆-C₁₀ aryl, or two or more of R²⁰, R²¹, R²², R²³, R²⁴, R²⁵, R²⁶, R²⁷ are joined together to form cyclic or polycyclic ring structure, or a combination thereof.

15. The supported catalyst composition of claim 13, wherein T is represented by the formula:
(R*₂G)_{g},
wherein each G is C, Si, or Ge, g is 1 or 2, and each R* is, independently, hydrogen, halogen, C₁-C₂₀ unsubstituted hydrocarbyl, a C₁-C₂₀ substituted hydrocarbyl, or the two or more R* may join to form a substituted or unsubstituted, saturated, partially unsaturated or aromatic, cyclic or polycyclic substituent, more preferably T is selected from the group consisting of CH₂, CH₂CH₂, C(CH₃)₂, (Ph)₂C, (p-(Et)₃SiPh)₂C, SiMe₂, SiPh₂, SiMePh, Si(CH₂)₃, Si(CH₂)₄, and Si(CH₂)₄.

16. The supported catalyst composition of claim 13, wherein each of X¹ and X² is independently a halide or a C₁-C₅ hydrocarbyl.

17. The supported catalyst composition of claim 1, wherein the catalyst composition comprises 1.0 wt % or less aromatic compound, alternately 0.5 wt % or less, alternately 0.1 wt % or less, alternately 0.10 wt % or less, alternately 0 wt % of aromatic compound, based upon the weight of the support.

18. The supported catalyst composition of claim 14, wherein T is represented by the formula:
(R*₂G)_{g},
wherein each G is C, Si, or Ge, g is 1 or 2, and each R* is, independently, hydrogen, halogen, C₁-C₂₀ unsubstituted hydrocarbyl, a C₁-C₂₀ substituted hydrocarbyl, or the two or more R* may join to form a substituted or unsubstituted, saturated, partially unsaturated or aromatic, cyclic or polycyclic substituent, more preferably T is selected from the group consisting of CH₂, CH₂CH₂, C(CH₃)₂, (Ph)₂C, (p-(Et)₃SiPh)₂C, SiMe₂, SiPh₂, SiMePh, Si(CH₂)₃, Si(CH₂)₄, and Si(CH₂)₄.
